(19) United States
(12) Patent Application Publication
(10) Pub. No.: US 2014/0104453 A1
(43) Pub. Date: Apr. 17, 2014

(54) IMAGE CAPTURING APPARATUS

(71) Applicant: NIKON CORPORATION, Tokyo (JP)

(72) Inventors: Nobuhiro Fujinawa, Yokohama (JP); Masaki Otsuki, Yokohama (JP)

(73) Assignee: NIKON CORPORATION, Tokyo (JP)

(21) Appl. No.: 14/137,070

(22) Filed: Dec. 20, 2013

Related U.S. Application Data
(63) Continuation of application No. PCT/JP2012/003994, filed on Jun. 19, 2012.

(30) Foreign Application Priority Data
Jun. 23, 2011 (JP) 2011-139703
Dec. 8, 2011 (JP) 2011-269403
Dec. 8, 2011 (JP) 2011-269408
Jan. 31, 2012 (JP) 2012-019248

(51) Int. Cl. H04N 5/232; H04N 5/225; G02B 7/02; G06F 3/01

(52) U.S. Cl. CPC H04N 5/23222; H04N 5/23229; H04N 5/23293; G06F 3/016; H04N 5/2254; G02B 7/02
USPC 348/222.1; 348/335; 359/811

(57) ABSTRACT

An image capturing apparatus that notifies a user of completion of preparation when the image capturing preparation including strobe charging and so on is finished has been known. However, a user of such apparatus has to take an image while checking whether a specific object is within a desired region. Thus, an image capturing apparatus includes an image capturing section that captures an image of an object and generates a captured image, an object recognition section that recognizes a specific object in the captured image generated by the image capturing section, and a tactile notification section that notifies a user in a tactile manner concerning whether the specific objet is in a predetermined region of the captured image or not based on recognition by the object recognition section.

### CROSS-REFERENCE TO RELATED APPLICATIONS

This application is a continuation application under 35 U.S.C Section 111(a) of International Application PCT/JP2012/003994 filed on Jun. 19, 2012, which claims foreign priority to Japanese Patent Application No. 2011-139703 filed Jun. 23, 2011, Japanese Patent Application No. 2011-269403 filed Dec. 8, 2011, Japanese Patent Application No. 2011-269408 filed Dec. 8, 2011, and Japanese Patent Application No. 2012-019248 filed Jan. 31, 2012, the entire contents of all of which are incorporated herein by reference.

### BACKGROUND

1. Field

The present invention relates to an image capturing apparatus.

2. Description of the Related Art

An image capturing apparatus that notifies a user of completion of preparation when the image capturing preparation including strobe charging and so on is finished (see, for example, Patent Document 1) has been known. The above-mentioned Patent Document 1 is Japanese Patent Application Publication 2003-262899.

However, a user of such apparatus has to take an image while checking whether a specific object is within a desired region.

### SUMMARY

A first aspect of the innovations may provide an image capturing apparatus. The image capturing apparatus includes an image capturing section that captures an image of an object and generates a captured image, an object recognition section that recognizes a specific object in the captured image generated by the image capturing section, and a tactile notification section that notifies a user in a tactile manner concerning whether the specific objet is in a predetermined region of the captured image or not based on recognition by the object recognition section.

A second aspect of the innovations may provide an image capturing apparatus that includes a vibrator, a judging section that judges an object state based on at least a portion of an image of the object, and a vibration control section that notifies a user of an image capturing timing by changing a vibration waveform generated by the vibrator in accordance with judgment by the judging section.

A third aspect of the innovations may provide a control program for an image capturing apparatus that includes a vibrator. The control program causes a computer to judge a state of an object based on at least a portion of an image of the object, and to control the vibrator by changing a vibration waveform generated by the vibrator in accordance with judgment by the judging to notify a user of an image capturing timing.

A fourth aspect of the innovations may provide a lens unit that includes a group of lenses, and a plurality of vibrators arranged along an optical axis of the group of lenses with a predetermined space therebetween.

A fifth aspect of the innovations may provide a camera unit. The camera unit includes an image capturing element that receives a light beam from an object and converts the light beam into an electric signal, a plurality of vibrators arranged at least in an incident direction of the light beam from the object with a predetermined space therebetween, a judging section that judges a depth state of the object with reference to at least a portion of an image of the object, and a vibration control section that vibrates the plurality of vibrators in coordination with each other according to the judgment of the judging section.

A sixth aspect of the innovations may provide a camera system that includes at least a lens unit and a camera unit. The lens unit includes a first vibrator, and the camera unit includes a second vibrator. At least one of the lens unit and the camera unit includes a judging section that judges a depth state of an object with reference to at least a portion of an image of the object, and a vibration control section that vibrates the first vibrator and the second vibrator in coordination with each other according to the judgment of the judging section.

A seventh aspect of the innovations may provide an image capturing apparatus including an image capturing section that converts an incident light beam from an image capturing target space, a detecting section that detects a relative relation between the image capturing target space and a direction of the image capturing section, a generating section that generates a haptic sense with which a user perceives change of state, and a driving control section that determines a recommended direction to rotate the image capturing section based on the relative relation detected by the detecting section and a predetermined criterion, and that drives the generating section such that the user perceives the change of state that corresponds to a rotational direction identical to the recommended direction.

An eighth aspect of the innovations may provide a control program for an image capturing device. The control program causes a computer to detect a relative relation between between an image capturing target space and a direction of an image capturing section, determine a recommended direction to rotate the image capturing section based on the relative relation and a predetermined criterion, and drive and control a generating section that generates a haptic sense with which a user perceives change of state such that the user perceives a rotational direction identical to the recommended direction.

The summary clause does not necessarily describe all necessary features of the embodiments of the present invention. The present invention may also be a sub-combination of the features described above.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a front view of an image capturing apparatus.

FIG. 2 is a rear view of the image capturing apparatus.

FIG. 3 is a block diagram illustrating a control system of an image capturing apparatus 10.

FIG. 4 is a flow chart illustrating a main control processing of the image capturing apparatus 10.

FIG. 5 is a flow chart illustrating a no-look processing (S14).

FIG. 6 is a flow chart illustrating an initial processing (S20) of the no-look processing (S14).

FIG. 7 is a flow chart illustrating an object recognition processing (S22) of the no-look processing (S14).

FIG. 8 is a flow chart illustrating a tactile notification processing (S24) of the no-look processing (S14).

FIG. 9 is a flow chart illustrating a storing processing (S26) of the no-look processing (S14).

FIG. 10 is a front view of an image capturing apparatus in which a vibrating section is differently arranged.

FIG. 11 is a rear view of the image capturing apparatus in which the vibrating section is differently arranged.

FIG. 12 shows another configuration of the vibrating section.

FIG. 13 is a schematic top view of a camera system 100.

FIG. 14 is a sectional view of the main section of the camera system 100.

FIG. 15 is a configuration diagram of the camera system 100.

FIGS. 16(a)-(f) are explanatory drawings for explaining waveforms of vibrations imparted to a vibrator 331.

FIG. 17 is an image capturing operation flow of the camera system 100.

FIGS. 18(a)-(d) are explanatory drawings for explaining waveforms of vibrations imparted to the vibrator 331.

FIGS. 19(a)-(d) are explanatory drawings for explaining waveforms of vibrations imparted to the vibrator 331.

FIG. 20 is a schematic top view of a camera system 101.

FIGS. 21(a)-(f) are explanatory drawings for explaining waveforms of vibrations imparted to the vibrators 332, 333.

FIGS. 22(a)-(f) are explanatory drawings for explaining waveforms of vibrations imparted to the vibrators 332, 333.

FIGS. 23(a)-(d) are explanatory drawings for explaining waveforms of vibrations imparted to the vibrators 332, 333.

FIGS. 24(a)-(f) are explanatory drawings for explaining waveforms of vibrations imparted to the vibrator 331.

FIGS. 25(a)-(f) are explanatory drawings for explaining waveforms of vibrations imparted to the vibrator 331.

FIG. 26 is a schematic top view of a camera system 102.

FIG. 27 is a schematic perspective view of a camera system 400. FIG. 28 is a sectional view of the main section of the camera system 400.

FIG. 29 is a sectional view of the main section of the camera system 400.

FIGS. 30(a)-(f) are explanatory drawings for explaining waveforms of vibrations imparted to vibrators 531, 532.

FIG. 31 is an image capturing operation flow of the camera system 400.

FIGS. 32(a)-(f) are explanatory drawings for explaining waveforms of vibrations imparted to vibrators 531, 532.

FIGS. 33(a)-(d) are explanatory drawings for explaining waveforms of vibrations imparted to the vibrators 531, 532.

FIGS. 34(a)-(d) are explanatory drawings for explaining waveforms of vibrations imparted to the vibrators 531, 532.

FIGS. 35(a)-(f) are explanatory drawings for explaining waveforms of vibrations imparted to the vibrators 531, 532.

FIGS. 36(a)-(f) are explanatory drawings for explaining waveforms of vibrations imparted to the vibrators 531, 532.

FIG. 37 is a schematic top view of a camera system 401.

FIG. 38 is a schematic top view of a camera system 402.

FIG. 39 is a schematic side view of a camera system 403.

FIG. 40 is a system configuration diagram of a digital camera.

FIGS. 41(a)-(c) are drawings for explaining a shutter button according to a fourth embodiment.

FIGS. 42(a)-(b) are drawings for explaining another example of the shutter button according to the fourth embodiment.

FIGS. 43(a)-(b) are diagrams for explaining a first example of an image capturing operation in a no-look image capturing mode according to the fourth embodiment.

FIG. 44 is a flow chart of the image capturing operation in the no-look image capturing mode in the first example.

FIGS. 45(a)-(b) are conceptual diagrams for explaining a second example of an image capturing operation in a no-look image capturing mode according to the fourth embodiment.

FIG. 46 is a flow chart of the image capturing operation in the no-look image capturing mode in the second example.

FIGS. 47(a)-(d) are conceptual diagrams for explaining a third example of an image capturing operation in a no-look image capturing mode according to the fourth embodiment.

FIG. 48 is a flow chart of the image capturing operation in the no-look image capturing mode in the third example.

FIGS. 49(a)-(c) are conceptual diagrams for explaining a fourth example of an image capturing operation in a no-look image capturing mode according to the fourth embodiment.

FIG. 50 is a flow chart of the image capturing operation in the no-look image capturing mode in the fourth example.

FIGS. 51(a)-(c) are drawings for explaining another example of the digital camera according to the fourth embodiment.

FIGS. 52(a)-(c) are drawings for explaining another example of the digital camera according to the fourth embodiment.

FIG. 53 is a drawing for explaining another example of the shutter button according to the fourth embodiment.

FIGS. 54(a)-(c) are drawings for explaining another example of the shutter button according to the fourth embodiment.

### DESCRIPTION OF EMBODIMENTS

Hereinafter, some embodiments of the present invention will be described. The embodiments do not limit the invention according to the claims, and all the combinations of the features described in the embodiments are not necessarily essential to means provided by aspects of the invention.

### First Embodiment

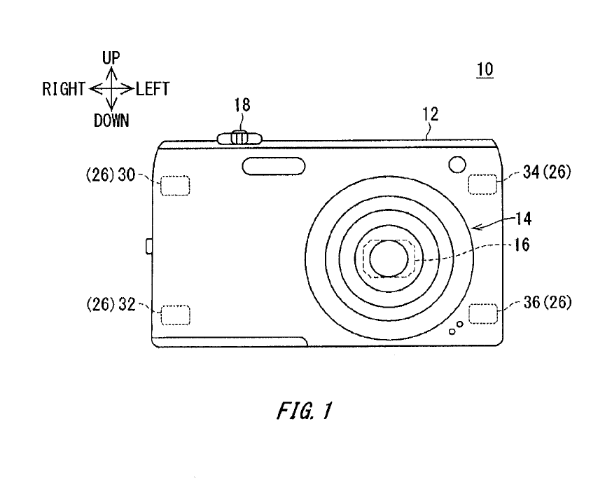

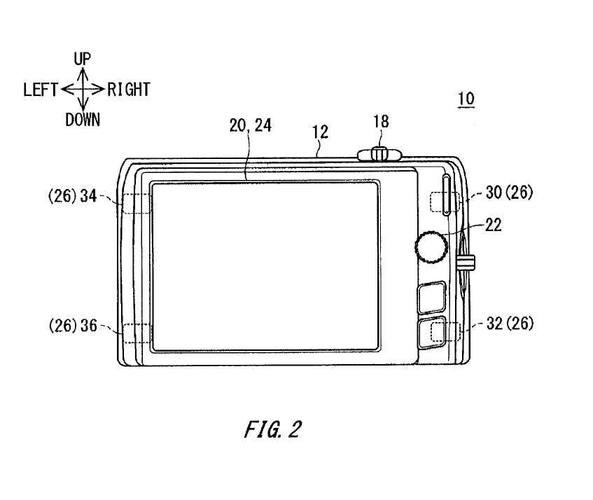

FIG. 1 is a front view of an image capturing apparatus. FIG. 2 is a rear view of the image capturing apparatus. Referring to FIG. 1, the upward, downward, right, and left directions of the image capturing apparatus are defined as the upward, downward, right and left directions of the user who operates the image capturing apparatus, as indicated by the arrows. In addition, the front direction of the image capturing apparatus is defined as the front direction in which the user sees an object.

Referring to FIG. 1 and FIG. 2, the image capturing apparatus 10 includes a case 12, a lens section 14, an image capturing section 16, a release switch 18, a display section 20, a mode setting section 22, a touch panel 24, and a vibrating section 26.

The case 12 has a substantially rectangular parallelepiped and hollow shape. The case 12 contains or retains various components of the image capturing apparatus 10.

The lens section 14 is disposed on a front face of the case 12. The lens section 14 includes a plurality of lenses. The lens section 14 extends and retracts in the front and rear directions. In this way, the lens section 14 has a zoom function with which an object is magnified or demagnified, and a focus function to focus the apparatus on an object.

The image capturing section 16 is disposed on an optical axis of the lens section 14 and on the rear side of the lens section 14. The image capturing section 16 is situated inside the case 12. The image capturing section 16 captures an image of an object, generates and outputs an electric signal of the captured image.

The release switch 18 is held on the upper face of the case 12 such that it can be pressed downward. When a user presses the release switch 18, an image of an object is stored through the light received by the image capturing section 16.

The display section 20 is disposed on the rear face of the case 12. The display section 20 includes a liquid crystal display device, an organic EL display device or the like. The display section 20 displays a captured image (so called “a through image”) that has been generated by the image capturing section 16, and images that have been already stored.

The mode setting section 22 is held by the case 12 such that it is rotatable around an rotation axis that extends in the rear-front direction. A user operates the mode setting section 22 to set the apparatus to a normal mode, a no-look mode or the like. The no-look mode is the mode in which a user captures a specific object without seeing the display section 20. The normal mode includes more than one mode other than the no-look mode, and in the normal mode, a user sees the specific object through the display section 20 or the like to take an image of the object.

The touch panel 24 is provided on the front face of the display section 20. A user inputs various information through the touch panel 24. For example, a user sets a position and size of an object region in which a specific object is captured in the no-look mode.

The vibrating section 26 includes an upper-right vibrating section 30, an lower-right vibrating section 32, a upper-left vibrating section 34, and a lower-left vibrating section 36. The upper-right vibrating section 30, the lower-right vibrating section 32, the upper-left vibrating section 34, and the lower-left vibrating section 36 are each disposed on a different corner of the case 12. Here, the four corners of the case refer to four horizontally and vertically divided regions of the case 12 when it is viewed from the front. The upper-right vibrating section 30, the lower-right vibrating section 32, the upper-left vibrating section 34, and the lower-left vibrating section 36 each include a piezoelectric element. The upper-right vibrating section 30, the lower-right vibrating section 32, the upper-left vibrating section 34, and the lower-left vibrating section 36 each vibrates when a voltage is applied to the piezoelectric element therein.

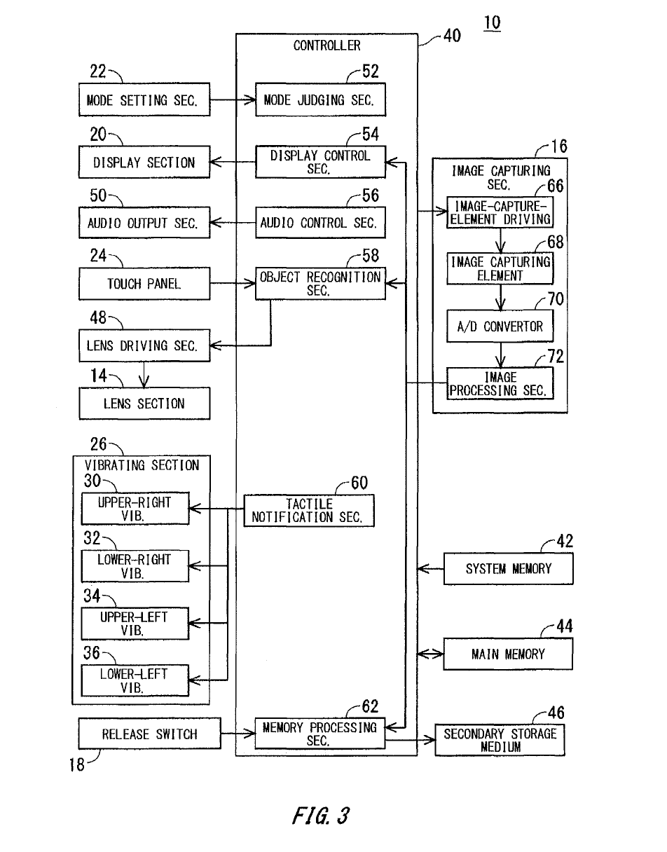

FIG. 3 is a block diagram illustrating a control system of an image capturing apparatus 10. Referring to FIG. 3, the image capturing apparatus 10 further includes a controller 40, a system memory 42, a main memory 44, a secondary storage medium 46, a lens driving section 48, and an audio output section 50.

The controller 40 has a CPU and is in charge of overall controls for the image capturing apparatus 10. The control section 40 includes a mode judging section 52, a display control section 54, an audio control section 56, an object recognition section 58, a tactile notification section 60, and a memory processing section 62.

The mode judging section 52 judges a selected mode among various image capturing modes based on mode information that is input through the mode setting section 22. For example, the mode judging section 52 judges whether the normal mode or the no-look mode is set. When the mode judging section 52 judges that the no-look mode is set, the mode judging section 52 notifies the display control section 54, the audio control section 56, and the object recognition section 58 of it.

The display control section 54 displays an image on the display section 20 based on a captured image generated by the image capturing section 16 and/or image information stored in the secondary storage medium 46. When the mode judging section 52 judges that the no-look mode is set, the display control section 54 halts displaying an image on the display section 20 and no captured image is displayed thereon.

The audio control section 56 outputs, through the audio output section 50, sounds such as a release sound when the release switch 18 is operated. When the mode judging section 52 judges that the no-look mode audio output section 50 is set, the audio control section 56 halts the audio output section 50 and the release sound is not output even if the release switch 18 is operated.

The object recognition section 58 sets an object region in a captured image based on region information that is input through the touch panel 24. The object region is one example of a prescribed region. If a user does not input the object region, the object recognition section 58 may automatically set a center region of image capturing elements 68 as the object region. The object recognition section 58 recognizes a specific object in the captured image generated by the image capturing section 16, and determines if the specific object is included in the captured image or not. For example, when the specific object is a human, the object recognition section 58 judges if the specific object exists or not by recognizing a face of the human.

When the object recognition section 58 determines that the specific object is within the captured image, it drives the lens driving section 48 and causes the lens section 14 to focus on the specific object. Moreover, the object recognition section 58 judges whether the specific object is within the object region or not. When the specific object is out of the object region, the object recognition section 58 determines which direction the specific object is shifted off the object region. The object recognition section 58 then stores information concerning the direction in which the specific object is shifted off the object region as direction information in the main memory 44. When the specific object is within the object region but the size of the specific object is different from the size of the object region, the object recognition section 58 drives the lens driving section 48 to cause the lens section 14 to zoom on the specific object such that the specific object is captured in a substantially equal size as the object region.

The tactile notification section 60 informs a user, through vibration, whether the specific object is within the object region in the captured image based on the recognition by the object recognition section 58. Informing a user through vibration is one example of tactile notification. More specifically, the tactile notification section 60 does not vibrate any of the upper-right vibrating section 30, the lower-right vibrating section 32, the upper-left vibrating section 34, and the lower-left vibrating section 36 when the specific object is within the object region. In this manner, the tactile notification section 60 notifies a user of the specific object being within the object region. Whereas when the specific object is not in the object region, the tactile notification section 60 vibrates, based on the direction information supplied from the object recognition section 58, at least one of the upper-right vibrating section 30, the lower-right vibrating section 32, the upper-left vibrating section 34, and the lower-left vibrating section 36 of the vibrating section 26 by applying an voltage to the corresponding piezoelectric element. In this manner, the tactile notification section 60 notifies a user of the specific object being out of the object region and the direction in which the specific object is shifted off the object region. The tactile notification section 60 outputs a vibration state information of the vibrating section 26 to the memory processing section 62. The vibration status includes a vibration stop time.

When the memory processing section 62 determines that the release switch 18 is operated, it judges, based on the vibration status supplied by the vibrating section 26, whether vibration has been attenuated or not. For example, the memory processing section 62 judges the attenuation of the vibrating section 26 based on whether an attenuation time has lapsed since the stop time of the vibration section 26 that is stored in the secondary storage medium 46. For example, the attenuation time is one second. When the memory processing section 62 finds that the vibration has attenuated, a captured image is stored in the secondary storage medium 46.

The system memory 42 includes at least one of a non-volatile storage medium and a read-only storage medium. The system memory 42 retains, without power supply, firmware or the like which the controller 40 loads and executes.

The main memory 44 includes RAM. The main memory 44 serves as a work area for the controller 40 such that the controller 40 temporally stores image information and the like on the memory.

The secondary storage medium 46 is, for example, a non-volatile storage device such as a flash-memory card. The secondary storage medium 46 is provided detachably from the case 12. Captured image information is stored in the secondary storage medium 46.

The lens driving section 48 drives the lens section 14 such that it extends and retracts according to a driving signal from the controller 40. In this way, the lens section 14 focuses or zooms on the object.

The image capturing section 16 includes an image capturing-element driving section 66, image capturing elements 68, an A/D convertor 70, and an image processing section 72. The image capturing-element driving section 66 drives the image capturing elements 68 at a prescribed image capturing interval. The image capturing elements 68 each has a photoelectric conversion element such as a Charged Coupled Device (CCD) sensor, a Complementary Metal Oxide Semiconductor (CMOS) sensor, or the like. The image capturing elements 68 photoelectric-convert an object image into an image signal at an image capturing interval, and then supplies the image signal to the A/D convertor 70. The A/D convertor 70 converts analog image signals supplied from the image capturing elements 68 into a discretized digital captured image and outputs it to the image processing section 72. The image processing section 72 performs processing of the captured image including correction, compression of the like of the image, and then outputs the processed captured image to the display control section 54 in the controller 40, the object recognition section 58, and the memory processing section 62.

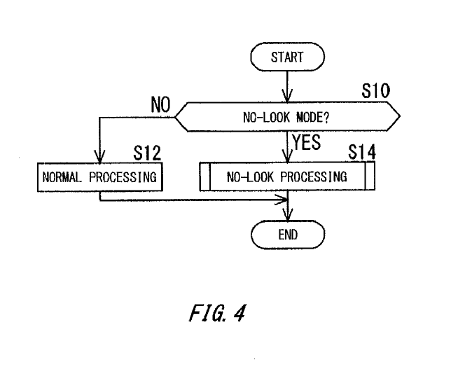

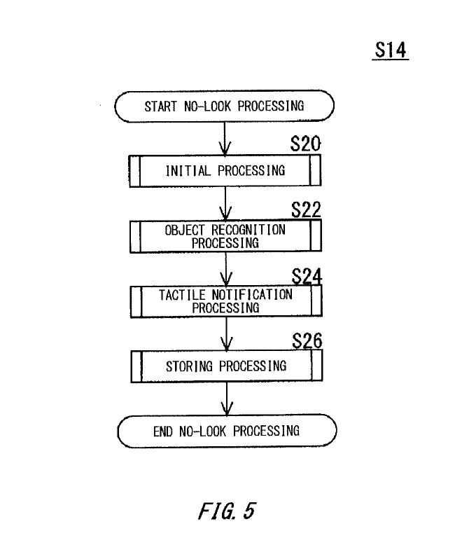

FIG. 4 is a flow chart illustrating a main control processing of the image capturing apparatus 10. Referring to FIG. 4, in the main control processing, the mode judging section 52 in the controller 40 judges, based on the mode information supplied by the mode setting section 22, whether the apparatus is in the no-look mode or not (S10). When the mode judging section 52 judges that the no-look mode is not selected (S10: No), it causes a normal processing to be performed (S12). Consequently, a user takes a shoot while observing a specific object displayed on the display section 20. Whereas when the mode judging section 52 judges that the no-look mode is selected (S10: Yes), the mode judging section 52 notifies the display control section 54, the audio control section 56, and the object recognition section 58 of that, and then a no-look processing is performed (S14).

FIG. 5 is a flow chart illustrating the no-look processing (S14). In the no-look processing, the controller 40 executes an initial processing (S20), an object recognition processing (S22), a tactile notification processing (S24), and a storing processing (S26) in the stated order.

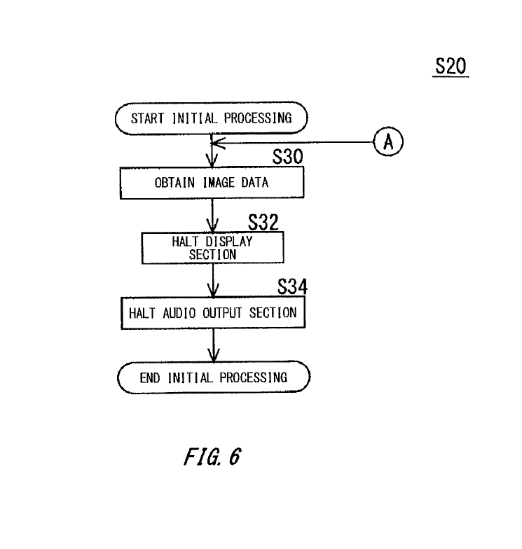

FIG. 6 is a flow chart illustrating the initial processing (S20) of the no-look processing (S14). Referring to FIG. 6, in the initial processing, the object recognition section 58 acquires a captured image (S30). More specifically, the object recognition section 58 acquires a captured image that is captured by the image capturing elements 68 in the image capturing section 16 and that includes an object image. The display control section 54 halts displaying on the display section 20 (S32). When no image is displayed on the display section 20, that non-display state is continued. In this manner, the display section 20 does not display image captured by the image capturing section 16. Subsequently, the audio control section 56 halts the audio output section 50 (S34). In this manner, the audio output section 50 does not output a release sound even when the release switch 18 is operated.

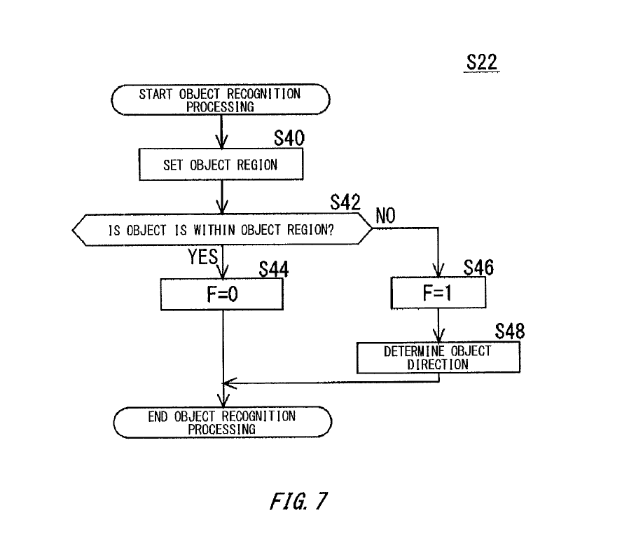

FIG. 7 is a flow chart illustrating an object recognition processing (S22) of the no-look processing (S14). Referring to FIG. 7, in the object recognition processing, the object recognition section 58 set a position and size of the object region in a captured image based on region information that is input by a user via the touch panel 24 (S40). The object recognition section 58 then judges whether a specific object exists in the captured image, and if it exits, also judges whether the specific object is within the object region or not (S42).

When the object recognition section 58 judges that the specific object is within the object region (S42: Yes), the object recognition section 58 drives the lens section 14 and causes it to focus on the specific object, and the object recognition section 58 set “0” in a flag F (S44). When the size of the specific object is different from the size of the object region, the object recognition section 58 drives the lens driving section 48 to cause the lens section 14 to zoom in or out on the specific object such that the size of the specific object becomes substantially same as the size of the object region. Whereas when the object recognition section 58 judges that the specific object is not within the object region (S42: No), it sets “1” in the flag F (S46). The object recognition section 58 further determines a direction in which the specific object is shifted off the object region, and then stores such information in the main memory 44 as direction information (S48).

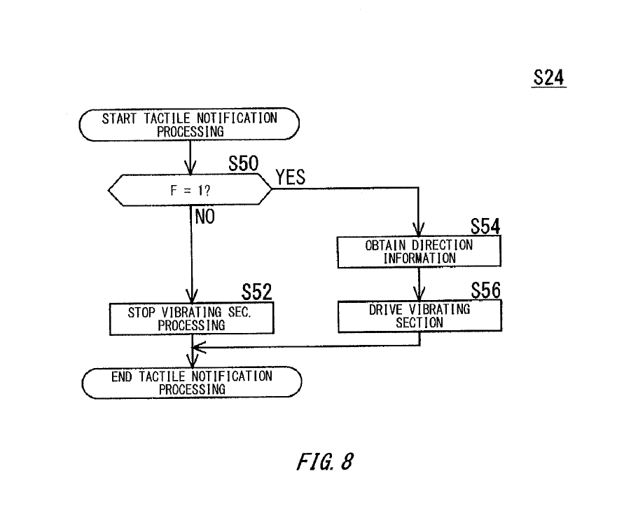

FIG. 8 is a flow chart illustrating a tactile notification processing (S24) of the no-look processing (S14). Referring to FIG. 8, in the tactile notification processing, the tactile notification section 60 judges whether the flag F is “1” or not (S50). When the tactile notification section 60 determines that the flag F is “0” (S50: No), a stopping vibrator processing is performed since the flag F “0” means that the specific object is within the object region. In the stopping vibrator processing, the tactile notification section 60 halts the vibrating section 26 and stores vibration information that includes the vibration stop time in the secondary storage medium 46 (S52). If the operation of the vibrating section 26 has been already stopped, this stop state is maintained.

When the tactile notification section 60 determines that the flag F is “1” (S50: Yes), it obtains the direction information stored in the main memory 44 (S54). The tactile notification section 60 causes the piezoelectric element in one of the upper-right vibrating section 30, the lower-right vibrating section 32, the upper-left vibrating section 34, and the lower-left vibrating section 36 in the vibrating section 26 to oscillate by applying a voltage, based on the direction information (S56). For example, when the tactile notification section 60 determines, based on the direction information, that the specific object is shifted off the object region in the upper-right direction, it vibrates the upper-right vibrating section 30. Moreover, when the tactile notification section 60 determines, based on the direction information, that the specific object is shifted off the object region in the upper direction, it vibrates the upper-right vibrating section 30 and the upper-left vibrating section 34. In this way, a user is able to capture the specific object without seeing the display section 20 and so on.

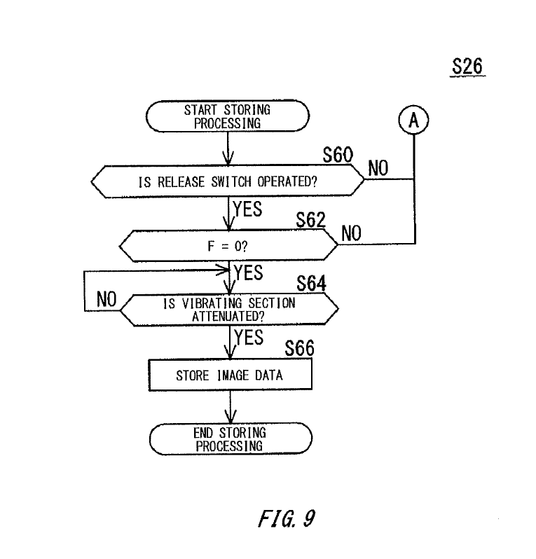

FIG. 9 is a flow chart illustrating the storing processing (S26) of the no-look processing (S14). The memory processing section 62 judges whether the release switch 18 is operated or not (S60). When the memory processing section 62 judges that the release switch 18 is operated (S60: Yes), it further judges whether the flag F is “0” or not (S62). When the memory processing section 62 determines that the flag F is “0” (S62: Yes), it judges whether the vibrating section 26 is attenuated or not (S64). The memory processing section 62 repeats the step S64 until it determines that the vibrating section 26 is attenuated. When the memory processing section 62 determines that the vibrating section 26 is attenuated (S64: Yes), it causes the captured image to be stored in the secondary storage medium 46 (S66). When the memory processing section 62 determines that the release switch 18 is not operated in the step S60 (S60: No) and the flag F is “1” in the step S62 (S62: No), the initial processing is performed.

As described above, in the image capturing apparatus 10, the object recognition section 58 recognizes a specific object, the tactile notification section 60 then informs, based on the recognition, whether the specific object is within an object region or not to the user. In this way, the user can capture a specific object within an object region without looking the display section 20 when the apparatus is in the no-look shooting mode, and the user can take an image of the specific object. Moreover, it is also possible for a user to shoot an image of a specific object easily even if the user cannot see the display section 20 when low-angle shooting, high-angle shooting and so on is performed.

Furthermore, in the image capturing apparatus 10, the object recognition section 58 recognizes the direction in which a specific object is shifted off an object region, and stores the recognized direction in the secondary storage medium 46 as the direction information. The tactile notification section 60 vibrates, corresponding to the direction information, one of the upper-right vibrating section 30, the lower-right vibrating section 32, the upper-left vibrating section 34, and the lower-left vibrating section 36 of the vibration section 26. In this way, a user is able to recognize the direction in which the specific object is shifted off the object region. Consequently, the user will be able to easily and accurately capture the specific object within the object region.

In the image capturing apparatus 10, the upper-right vibrating section 30, the lower-right vibrating section 32, the upper-left vibrating section 34, and the lower-left vibrating section 36 are arranged at the four corners of the case 12 respectively. Therefore, the image capturing apparatus 10 can accurately notify a user of the direction in which the specific object exists.

The image capturing apparatus 10 notifies a user of whether a specific object is within an object region or not through vibration of the vibrating section 26. Therefore, the specific object will not realize such notification in the no-look mode. Consequently, the specific object will not get nervous, and the user is able to shoot an image of the specific object with a natural expression or the like.

In the image capturing apparatus 10 in the no-look mode, the audio control section 56 prevents the audio output section 50 from outputting the release sound. In addition, the vibrating section 26 includes the piezoelectric element that can oscillate without making sounds. Therefore, a specific object will not realize that it is shot by the apparatus, and consequently it is possible for a user of the apparatus to take an image of natural facial expression of the specific object or the like.

In the image capturing apparatus 10 in the no-look mode, the display control section 54 halts the operation of the display section 20. In this way, the image capturing apparatus 10 can save the power consumption.

The memory processing section 62 in the image capturing apparatus 10 stores a captured image in the secondary storage medium 46 when vibration caused by the vibrating section 26 is attenuated. In this way, the image capturing apparatus 10 can avoid storing of an image whose image quality is deteriorated due to vibration.

Another embodiment in which some features are changed from the above-described embodiment will be now described.

Only one of the upper-right vibrating section 30, the lower-right vibrating section 32, the upper-left vibrating section 34, and the lower-left vibrating section 36, for example, only the upper-right vibrating section 30 may be provided on the case 12. In this case, the tactile notification section 60 vibrates the upper-right vibrating section 30 in the step S56 to notify whether a specific object is within the object region. For instance, the tactile notification section 60 may vibrate the upper-right vibrating section 30 when the specific object is within the object region. Whereas when the specific object is not within the object region, the upper-right vibrating section 30 may be vibrated periodically, and the vibration may be stopped when the specific object falls within the object region. For instance, the upper-right vibrating section 30 may be periodically vibrated at two times per second.

Moreover, in the case where only the upper-right vibrating section 30 is provided on the case 12, in the step S56, the tactile notification section 60 may provide vibration patterns of the upper-right vibrating section 30 depending on whether a specific object exists or not and the direction in which the specific object is shifted off the object region. For example, when the specific object is shifted off the object region in the left direction, the tactile notification section 60 vibrates the upper-right vibrating section 30 periodically such that two-times small oscillations occur as one set. Whereas when the specific object is shifted off the object region in the right direction, the tactile notification section 60 vibrates the upper-right vibrating section 30 periodically such that three-times small oscillations occur as one set. In the same manner, different vibrations patters for the upward and downward directions are set. Moreover, the tactile notification section 60 may instruct to vary the magnitude of the vibration of the upper-right vibrating section 30 according to the amount of the distance of the specific object from the object region. In this manner, the image capturing apparatus 10 can notify a user of the position of the specific object and the extent how much the specific object is shifted off the object region by using a single vibrating section, for example, the upper-right vibrating section 30.

In the same manner, when the upper-right vibrating section 30, the lower-right vibrating section 32, the upper-left vibrating section 34, and the lower-left vibrating section 36 are provided on the case 12, more than one vibration pattern can be made for these vibrating sections. For example, the tactile notification section 60 may vibrate the upper-right vibrating section 30 periodically such that two-times small oscillations occur as one set, and vibrate the upper-left vibrating section 34 periodically such that three-times small oscillations occur as one set. In such manner, the tactile notification section 60 can notify a user of the position of the specific object by selecting the vibrating sections and vibration patterns according to the position of the specific object, it is possible to reliably notify a user of the position of the specific object.

In the case where only one vibrating section is used, a driving mechanism which has been already installed in the image capturing apparatus 10 can be used as the vibrating section. For instance, an optical image stabilizer can be used to generate vibration to notify a user. In addition, when the apparatus is moved or shaken by the hand of the user who holds the apparatus, the tactile notification section 60 may notify the user of such motion by vibrating the vibrating section 26. Furthermore, the object recognition section 58 may determine whether any obstacle such as a finger of the user exists between a specific object and the image capturing element 68. When the object recognition section 58 determines that an obstacle exists, the tactile notification section 60 may notify the user of it by vibrating the vibrating section 26, and the memory processing section 62 may prohibit a captured image from being stored in the secondary storage medium 46 even when the release switch 18 is operated.

The apparatus may be configured to allow the user to change the magnitude of the vibration and the vibration patters of the vibrating section 26 through the touch panel 24 or the like.

Although a captured image is stored in the secondary storage medium 46 when the release switch 18 is operated in the above-described embodiment, the memory processing section 62 may alternatively store the captured image with other operation than the release switch 18. For example, when the memory processing section 62 judges that a specific object is within the object region in the no-look mode, the memory processing section 62 may store the captured image in the secondary storage medium 46 without user's operation. Moreover, when memory processing section 62 judges that the specific object is within the object region and the specific object smiles, the memory processing section 62 may store the captured image in the secondary storage medium 46 without user's operation. In this case, the captured image can be stored by each frame or a number of frames in a sequence.

Although the mode judging section 52 judges that the no-look mode is set when the mode setting section 22 is operated to be set to the no-look mode in the above-described embodiment, it is also possible to judge that the no-look mode is set by other operation than the mode setting section 22. For instance, an auxiliary image capturing element may be provided near the display section 20 at the back side of the case 12, and the mode judging section 52 may judges that the no-look mode is set when the auxiliary image capturing element is not capturing a user, in other words, when the user is not looking the display section 20. And then the mode judging section 52 may cause the no-look processing to be performed.

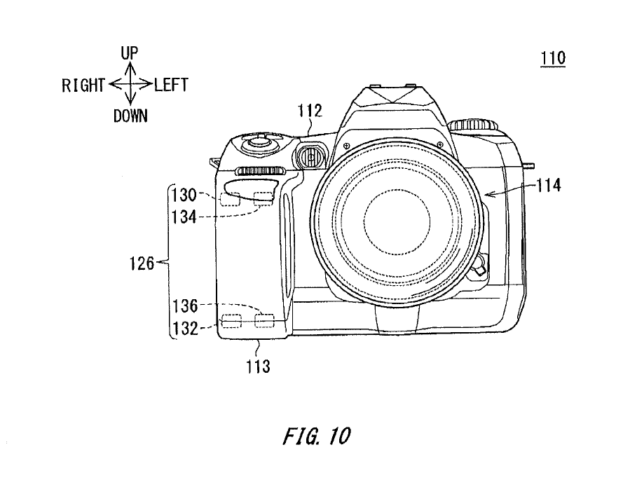

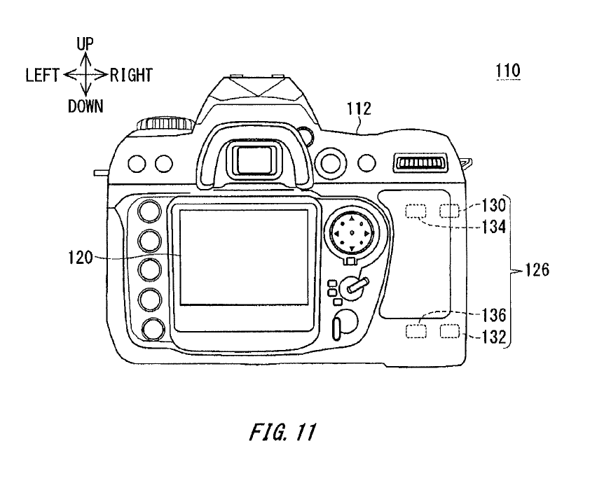

FIG. 10 is a front view of an image capturing apparatus in which the vibrating section is differently arranged. FIG. 11 is a rear view of the image capturing apparatus in which the vibrating section is differently arranged. Referring to FIGS. 10 and 11, an image capturing apparatus 110 includes a case 112, a lens section 114, a vibrating section 126, and a display section 120.

The case 112 has a grip section 113 which is integrally formed on the right front surface. The grip section 113 is arranged such that it protrudes towards the front direction. The grip section 113 extends in the vertical direction. A user can covers the grip section 113 with the hand and can hold the case 112 stably.

The vibrating section 126 includes an upper-right vibrating section 130, a lower-right vibrating section 132, a upper-left vibrating section 134, and a lower-left vibrating section 136 that are contained in the case 112. The upper-right vibrating section 130, the lower-right vibrating section 132, the upper-left vibrating section 134, and the lower-left vibrating section 136 are disposed on four corners of the grip section 113 respectively. In this way, it is possible to transmit vibration caused by the upper-right vibrating section 130, the lower-right vibrating section 132, the upper-left vibrating section 134, and the lower-left vibrating section 136 to the user who holds the grip section 113.

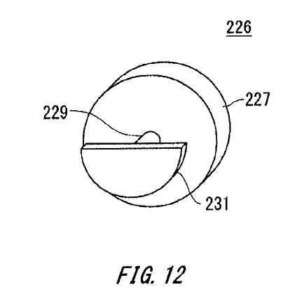

FIG. 12 shows another configuration of the vibrating section. A vibrating section 226 includes a motor 227, a rotation axis 229, and a semicircular member 231. The gravity center of the semicircular member 231 is situated at a different position from the rotation axis 229. In such configuration, the case 12, 112 vibrates when the rotation axis 229 and the semicircular member 231 are driven and rotated by the motor 227. As a result, the image capturing apparatus 10, 110 can transmit the vibration to a user. This vibrating section 226 can be provided in stead of and at any position of the above-described the upper-right vibrating section 30, 130, the lower-right vibrating section 32, 132, the upper-left vibrating section 34, 134, and the lower-left vibrating section 36, 136.

In both of the image capturing apparatus 10 and the image capturing apparatus 110, configuration, the number of, and arrangement of the vibrating section can be adequately changed. Moreover, information of a specific object can be transmitted to a user via other means than vibration. For instance, a concave-convex pattern is formed on a film member, and information about existence and direction of a specific object and so on can be transmitted via the concave-convex pattern. Moreover, information concerning the specific object can be transmitted via heat or the like.

### Second Embodiment

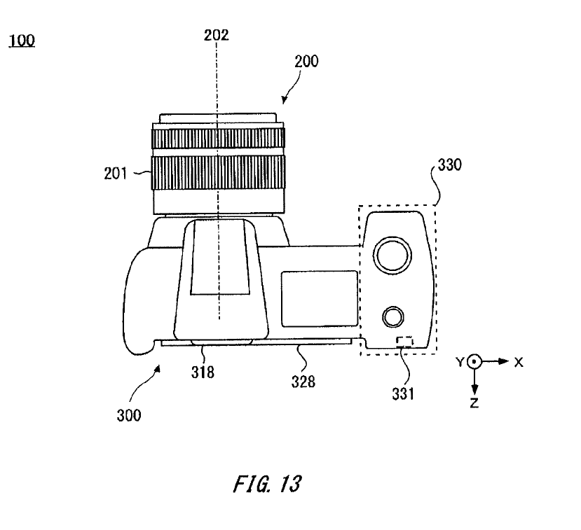

FIG. 13 is a schematic top view of a camera system 100 which is one example of the image capturing apparatus according to a second embodiment. The camera system 100 is a single-lens reflex camera with interchangeable lenses, which includes a lens unit 200 attached to a camera unit 300. The camera system 100 includes a finder window 318 for observing an object, and a display section 328 for displaying a live-view image or the like. The camera system 100 further includes a vibrator 331. The camera system 100 judges a state of an object according to at least a portion of an image of the object, and varies a vibration waveform caused by the vibrator 331 according to the judgment in order to inform a user of a timing to take an image. In this embodiment, the camera system 100 judges a defocused state of the object as the state of the object.

The vibrator 331 is preferably arranged in a portion where a user holds the camera system 100 when the user captures an image. Thus, the vibrator 331 is situated, for example, at the grip section 330 of the camera unit 300. According to this embodiment, when an user holds the lens unit 200 with the left hand and performs a manual focusing operation, the user can know a defocused state of the object with the right hand through vibration, and the user can adjust a focus ring 201 without looking the finder window 318 or the display section 328. In the following description, a z-axis is defined in the direction in which a light beam of the object enters in the camera along an optical axis 202 as illustrated in the drawing. In addition, an x-axis is defined in a direction perpendicular to the z-axis and in parallel to the longitudinal direction of the camera unit 300. A y-axis is defined in a direction perpendicular to the x-axis and z-axis.

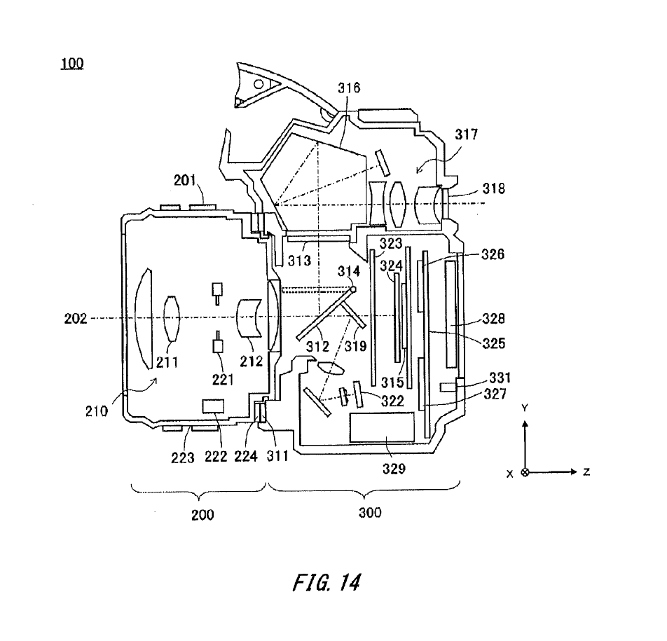

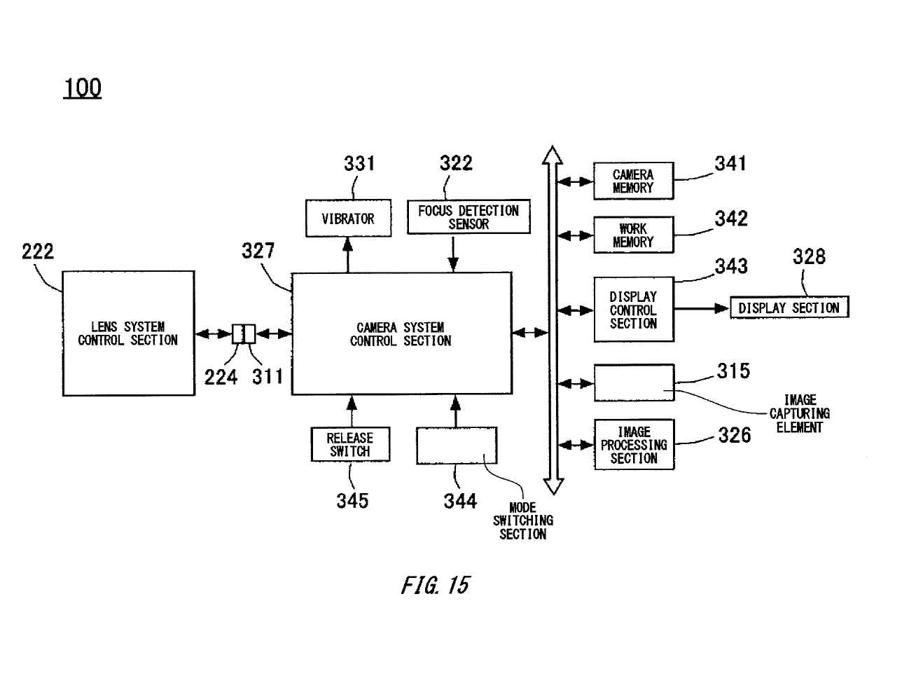

FIG. 14 is a sectional view of the main section of the camera system 100. The lens unit 200 includes a group of lenses 210 and a diaphragm 221 arranged along the optical axis 202. The group of lenses 210 includes a focus lens 211 and a zoom lens 212. The lens unit 200 has more than one motor such as an oscillating-wave motor, a VCM and the like to drive the focus lens 211 in the optical axis 202 direction. The lens unit 200 further includes a lens system control section 222 that controls the lens unit 200 and performs calculation concerning the lens unit 200. The lens unit 200 further includes the focus ring 201. When a user performs a manual focusing operation, the user rotates the focus ring 201 and the focus ring 211 is drive to rotate conjunction with the focus ring 201.

Elements of the lens unit 200 are supported by a lens barrel 223. The lens unit 200 further has a lens mount 224 at a connecting section with the camera unit 300. The lens mount 224 is attached to a camera mount 311 of the camera unit 300 to integrate the lens unit 200 with the camera unit 300. The lens mount 224 and the camera mount 311 each have an electrical connecting section in addition to a mechanical connecting section, and such electrical connection realize power supply from the camera unit 300 to the lens unit 200 and mutual communication therebetween.

The camera unit 300 includes a main mirror 312 that reflects an object image entered thereon from the lens unit 200, and a focusing screen 313 on which the object image that is reflected by the main mirror 312 is imaged. The main mirror 312 rotates on a pivot point 314 and it can be placed by rotation at a portion where the main mirror is placed in and directed diagonally to an object light beam centering on the optical axis 202, or a position where the main mirror is out of the object light beam. When an object image is guided to the focusing screen 313 side, the main mirror 312 is placed in and directed diagonally to the object light beam. The focusing screen 313 is placed at a position conjugate to a light-receiving plane of an image capturing element 315.

The object image imaged at the focusing screen 313 is converted into an erected image by a pentaprism 316, and the erected image is observed by a user through an eyepiece optical system 317. An area near the optical axis 202 of the main mirror 312 that is directed diagonally, forms a half mirror, and a half of the incident beam is transmitted through the area. The transmitted light beam is reflected by a sub-mirror 319 that coordinates with the main mirror 312, and then enters in a focus detection sensor 322. The focus detection sensor 322 is, for example, a phase difference detection sensor that detects a phase difference from the received object light beam. When the main mirror 312 is placed out of the object light beam, the sub-mirror 319 retracts from the object light beam in conjunction with the main mirror 312.

Behind the main mirror 312 that is directed diagonally, a focal plane shutter 323, an optical low-pass filter 324, and the image capturing element 315 are arranged along the optical axis 202. The focal plane shutter 323 is opened when the object light beam is guided toward the image capturing element 315, and closed otherwise. The optical low-pass filter 324 adjusts a spatial frequency of the object image with respect to pixel pitch of the image capturing element 315. The image capturing element 315 is a light receiving element such as a CMOS sensor, and it converts the object image that is imaged at the light receiving plane into an electric signal.

The electric signal photoelectric converted by the image capturing element 315 is then processed to turn into image data by an image processing section 326 that is an ASIC provided on a main substrate 325. In addition to the image processing section 326, the main substrate 325 has a camera system control section 327 which is an MPU that integrally controls the system of the camera unit 300. The camera system control section 327 manages camera sequences and performs input/output processing of each component and the like.

The display section 328 such as a liquid crystal monitor is provided on the back side of the camera unit 300, and an object image which has been processed by the image processing section 326 is displayed on the display section. A live-view display is realized when object images are photoelectric-converted sequentially by the image capturing element 315 and such object images are successively displayed on the display section 328. The camera unit 300 further includes a detachable secondary cell 329. The secondary cell 329 powers not only the camera unit 300 but also the lens unit 200. The camera unit 300 further includes the vibrator 331.

The vibrator 331 is, for example, a piezoelectric element which is placed inside the case of the camera unit 300. The case is vibrated when the piezoelectric element contracts and expands. A vibration waveform of the piezoelectric element, which is a physical amount of displacement of the element, is promotional to a vibration waveform of a driving voltage supplied to the piezoelectric element. The vibrator 331 is placed such that it contracts and expands in the z-axis direction, in this way, the vibration of the vibrator becomes perceptible to the user of the camera, and the user can be notified of defocus information.

FIG. 15 illustrates a system configuration of a camera system 100. The camera system 100 includes a lens control system centered on the lens system control section 222 and a camera control system centered on the camera system control section 327 corresponding to the lens unit 200 and the camera unit 300 respectively. The lens control system and the camera control system exchange various data and control signals to each other via a connecting section that is connected to the lens mount 224 and the camera mount 311.

The image processing section 326 included in the camera control system follows an instruction by the camera system control section 327 to process the captured image signal that has been photoelectrically converted by the image capturing element 315 and covert the signal into image data that has a predetermined image format. More specifically, when a JPEG file is created as a still image, the image processing section 326 performs image processing such as a color conversion processing, a gamma processing, and a white balance processing and the performs compression such as adaptive discrete cosine transformation. When a MPEG file is created as a motion image (video), the image processing section 326 performs compression by performing intra-frame coding and inter-frame coding on frame images which is a sequence of still images whose number of pixels is reduced to a prescribed number.

Camera memory 341 is, for example, non-volatile memory such as flash memory that stores programs to control the camera system 100 and various parameters. Work memory 342 is, for example, fast access memory such as RAM that temporally stores image data which is under processing.

A display control section 343 displays a screen image on the display section 328 in accordance with the instruction by the camera system control section 327. A mode switching section 344 receives mode setting information from the user such as an image capturing mode and a focus mode, and outputs it to the camera system control section 327. The image capturing mode includes a motion image capturing mode (video shooting mode) and a still image capturing mode. The focus mode includes an auto focus mode and a manual focus mode.

For example, one focusing point with respect to the object space is selected by the user and it is set in the focus detection sensor 322. The focus detection sensor 322 detects a phase difference signal at the set focusing point. The focus detection sensor 322 can detect whether the object at the focusing point is in focus or defocused. When the object is defocused, the focus detection sensor 322 can also determine the amount of defocus from the in-focus position.

A release switch 345 has two switch positions along the direction toward which the release switch is pressed. When the camera system control section 327 detects that a switch SW1 placed at the first one of the two positions is turned on, the control section receives the phase difference information from the focus detection sensor 322. When the auto focus mode is selected as the focus mode, the camera system control section 327 transmits information about driving of the focus lens 211 to the lens system control section 222. Moreover, when the camera system control section 327 detects that a switch SW2 placed at the other one of the two positions is turned on, it performs image capturing processing in accordance with a prescribed processing flow.

When the manual focus mode is selected as the focus mode, the camera system control section 327 serves together with the focus detection sensor 322 as a judging section that judges an object state responsive to at least a portion of the object image. More specifically, the camera system control section 327 judges the defocused state of the object based on the phase difference information obtained from the focus detection sensor 322.

The camera system control section 327 changes the vibration waveform generated by the vibrator 331 responsive to the defocused state of the object, in this sense, the camera system control section 327 serves as a vibration control section that notifies the user of an image capturing timing. Here, the image capturing timing refers to a state in which the object is in focus. Thus, even when the user performs image capturing of the object without looking at the finder window 318 or the display section 328, the user can know the image capturing timing through change of the vibration generated by the vibrator 331. The vibrator 331 receives a vibration waveform from the camera system control section 327 and the vibrator extends and contracts in accordance with the vibration waveform.

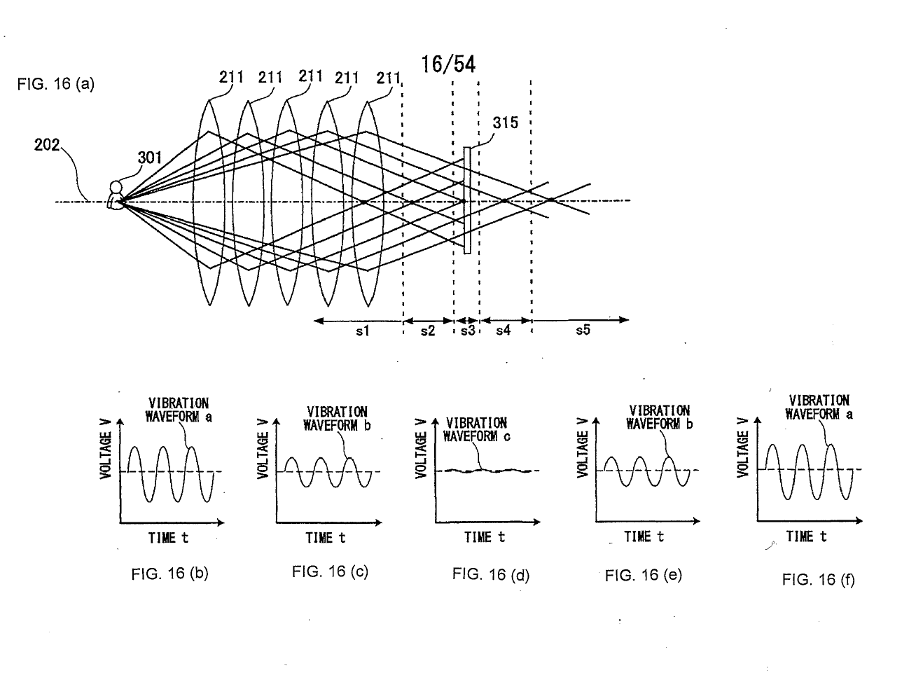

Judgment on a defocused state of the object by the camera system control section 327 will be now described. FIGS. 16(a)-16(f) are illustrative diagrams for explaining the vibration waveform supplied to the vibrator 331. FIG. 16(a) illustrates positional relationships between the image capturing element 315, the focus lens 211, and the optical axis 202 direction of an object 301, in particular, illustrates the positions of the focus lens 211 and segments (s1, s2, s3, s4, s5) that correspond to the defocused states of the object 301.

Here, relationships between the segments corresponding to the defocused states of the object 301 and the defocused amount will be now described. For example, in a front defocused state, such as the state where a light beam is focused in, for example, the area of the segment s2, the defocus amount at the image capturing plane is unambiguously defined. Thus, the camera system control section 327 can determine, in accordance with the defocus amount, which segment the focus lens 211 focuses the light beam in.

Referring to FIG. 16(a), the camera system control section 327 defines the segments that correspond to the defocused states of the object 301 in advance. More specifically, the camera system control section 327 holds information about a range in which it can be considered as in-focus states, in the form of a parameter table that includes parameters such as focal distances and aperture values, and the control section sets the range of in-focus state as the segment s3.

Moreover, the camera system control section 327 defines two segments for the front defocused state depending on the defocus amount, and these two segments are set as the segment s1 and the segment s2. In the same manner, the camera system control section 327 defines two segments for a rear defocused state depending on the defocus amount, and these two segments are set as the segment s4 and the segment s5.

FIGS. 16(b) to 16(f) illustrate vibration waveforms corresponding to the segments respectively. More specifically, FIG. 16(b) shows the vibration waveform that corresponds to the segment s1. In the same manner, FIG. 16(c) shows the vibration waveform that corresponds to the segment s2, FIG. 16(d) shows the vibration waveform that corresponds to the segment s3, FIG. 16(e) shows the vibration waveform that corresponds to the segment s4, and FIG. 16(f) shows the vibration waveform that corresponds to the segment s5. Here, the vibration waveform of FIG. 16 (b) is identical to that of FIG. 16(f). In turn, the vibration waveform of FIG. 16 (c) is identical to that of FIG. 16(e). In each diagram, the vertical axis shows voltage V and the horizontal axis shows time “t”. The vibrator 331 extends when the voltage increases in the vibration waveform whereas the vibrator 331 contracts when the voltage decreases in the vibration waveform. The vibration waveform illustrated in FIG. 16(d) is hereunder referred to as vibration waveform “a,” the vibration waveform illustrated in FIGS. 16(c) and 16(d) is referred to as vibration waveform “b,” and the vibration waveform illustrated in FIGS. 16(b) and 16(f) is referred to as vibration waveform “c.”

The camera system control section 327 sets in advance the vibration waveforms that correspond to the segments respectively as described above. More specifically, the camera system control section 327 holds information about amplitudes, cycles and types of the vibration waveform in the camera memory 341 as setting items for the vibration waveform. An example of the types of the vibration waveform includes sinusoid, sawtooth wave and the like.

When the camera system control section 327 judges that the defocused state of the object 301 corresponds to the segment s3, the vibration waveform “a” is supplied to the vibrator 331. The vibration waveform “a” has the smallest amplitude among the vibration waveforms “a,” “b,” and “c.” Thus, the user feels the vibration and knows that the focus lens 211 is at the position in focus, in other words, knows that this is the image capturing timing, without looking at the finder window 318 or the display section 328. Moreover, the camera system control section 327 supplies the vibration waveform “a” that has the smallest amplitude at the image capturing timing so that the camera will not be shaken by the hand of the user during image capturing action due to the vibration. Alternatively, the camera system control section 327 may set the amplitude of the vibration waveform generated by the vibrator 331 to zero when it judges that the defocused state of the object 301 corresponds to the segment s3.

When the camera system control section 327 judges that the defocused state of the object 301 corresponds to the segment s2 or s4, the vibration waveform “b” is supplied to the vibrator 331. The amplitude of the vibration waveform “b” is larger than that of the vibration waveform “a” but smaller than that of the vibration waveform “c.” Thus, the user feels the vibration and knows that the focus lens 211 is not at the position in focus but the defocus amount is small.

When the camera system control section 327 judges that the defocused state of the object 301 corresponds to the segment s1 or s5, the vibration waveform “c” is supplied to the vibrator 331. The vibration waveform “c” has the largest amplitude among the vibration waveforms “a,” “b,” and “c.” Thus, the user can who recognizes the vibration knows that the defocus amount is large.

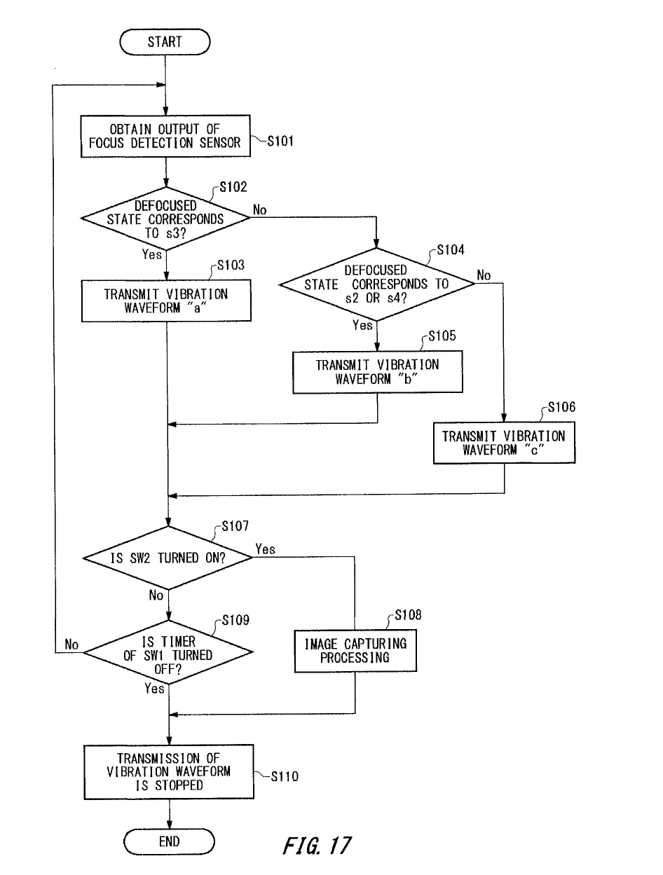

FIG. 17 is a flow chart of an image capturing operation of the camera system 100. The image capturing operation flow starts with detection by the camera system control section 327 to detect that a SW1 is turned on when the focus mode is set to the manual focus mode and the image capturing mode is set to the still image capturing mode. When turning on of the SW1 is detected, the camera system control section 327 obtains the output of the focus detection sensor 322 (step S101).

The camera system control section 327 judges whether the defocused state of the object 301 corresponds to the segment s3 (step S102). When the camera system control section 327 determines that the defocused state of the object 301 corresponds to the segment s3 (step S102: Yes), it transmits the vibration waveform “a” to the vibrator 331 (step S103). When the camera system control section 327 determines that the defocused state of the object 301 does not correspond to the segment s3 (step S102: No), the camera system control section 327 further judges whether the defocused state corresponds to the segment s2 or s4 (step S104). When the camera system control section 327 determines that the defocused state corresponds to the segment s2 or s4 (step S104: Yes), it transmits the vibration waveform “b” to the vibrator 331 (step S105).

When the camera system control section 327 determines that the defocused state does not correspond to the segment s2 or s4 (step S104: No), the defocused state corresponds to the segment s1 or s5. In this case, the camera system control section 327 transmits the vibration waveform “c” to the vibrator 331 (step S106). After the camera system control section 327 transmits any of the vibration waveforms, it then judges whether a SW 2 is turned on (step S107). When the camera system control section 327 determines that the SW2 is turned on (step S107: Yes), the image capturing processing is performed (step S108).

Whereas when the camera system control section 327 determines that the SW2 is not turned on (step S107: No), the camera system control section 327 then judges whether a timer of the SW1 is turned off (step S109). When the camera system control section 327 determines that the timer of the SW1 is not turned off (step S109: No), the flow returns to the step S101. When the camera system control section 327 determines that the timer of the SW1 is turned off (step S109: Yes) or when the image capturing processing is performed, the transmission of the vibration waveform is stopped (step S110) and the series of the image capturing operation flow is ended. When the camera system control section 327 judges that the SW2 is turned on (step S107: Yes), the transmission of the vibration waveform can be stopped before the image capturing processing is performed.

As described above, the camera system control section 327 judges the defocused state of the object 301 while the SW1 is turned on, and supplies the vibration waveform that corresponds to the defocused state of the object 301. In other words, the camera system control section 327 continuously judges the state of the object 301 and continuously changes the vibration waveform according to the state of the object 301.

A first modification example in which the frequency of the vibration waveform is changed according to the defocused state of the object instead of the amplitude of the vibration waveform will be now described. In the first modification example, the camera system control section 327 changes the frequency of the vibration waveform depending on the defocused state of the object to notify a user of the image capturing timing.

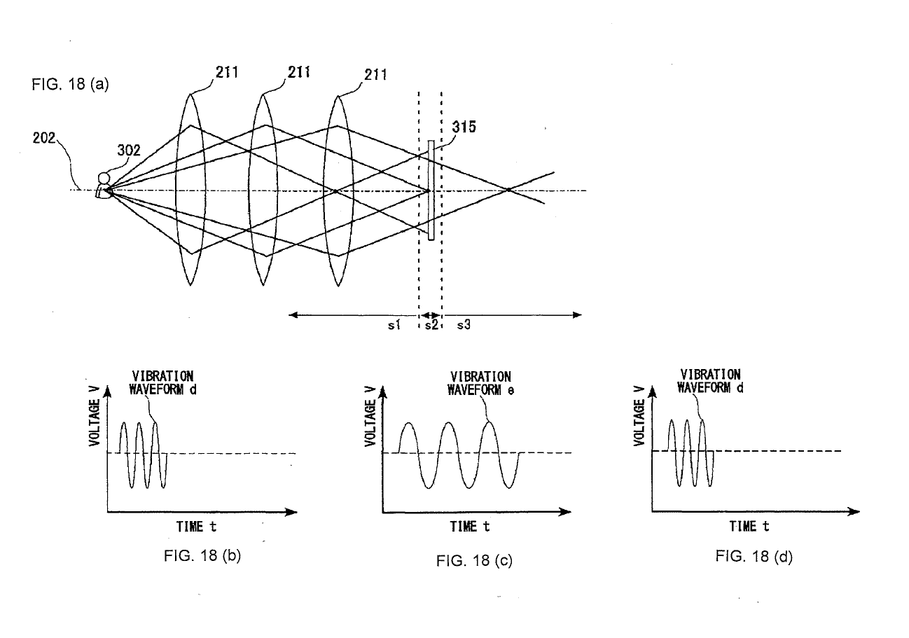

FIGS. 18(a)-18(d) are illustrative diagrams for explaining the vibration waveform supplied to the vibrator 331. FIG. 18(a) illustrates positional relationship between the image capturing element 315, the focus lens 211, and the optical axis 202 direction of an object 302, in particular, illustrates the positions of the focus lens 211 and segments (s1, s2, s3) that correspond to the defocused states of an object 302. Referring to FIG. 18(a), the camera system control section 327 defines the segments that correspond to the defocused states of the object 302 in advance. Here, the camera system control section 327 sets the range of in-focus state to the segment s2. Moreover, the camera system control section 327 sets the front defocused state to the segment s1 and the rear defocused state to the segment s3.

FIGS. 18(b) to 18(d) illustrate vibration waveforms corresponding to the segments respectively. More specifically, FIG. 18(b) shows the vibration waveform that corresponds to the segment s1. In the same manner, FIG. 18(c) shows the vibration waveform that corresponds to the segment s2, and FIG. 18(d) shows the vibration waveform that corresponds to the segment s3. In each diagram, the vertical axis shows voltage V and the horizontal axis shows time “t”. Here, the vibration waveform of FIG. 18 (b) is identical to that of FIG. 18(d). The vibration waveform illustrated in FIGS. 18(b) and 18(d) is hereunder referred to as vibration waveform “d,” and the vibration waveform illustrated in FIG. 18(c) is referred to as vibration waveform “e.” The camera system control section 327 sets in advance the vibration waveforms that correspond to the segments respectively as described above.

Referring to FIGS. 18 (b) to 18(d), the camera system control section 327 changes the frequency of the vibration waveform according to the defocused state of the object 302. More specifically, when the camera system control section 327 judges that the defocused state corresponds to the segment s1 or s3, the vibration waveform “d” that has a higher frequency than that of the vibration waveform “e” is supplied to the vibrator 331. When the camera system control section 327 judges that the defocused state of the object 302 corresponds to the segment s2, the vibration waveform “e” is supplied to the vibrator 331.

Although the amplitudes of the vibration waveforms shown in FIGS. 18(b) to 18(d) are constant, the amplitudes may be changed according to the defocus amount. For example, as shown in FIG. 16, when there are five segments, the camera system control section 327 can increase the amplitude of each vibration waveform as the amount of defocus increases. In this manner, the camera system control section 327 can notify the user of the defocus amount and the defocus direction.

A second modification example in which the vibration waveform is a sawtooth wave will be hereunder described. In the second modification example, the camera system control section 327 judges the state of the object 302 and supplies, to the vibrator 331, a sawtooth wave that corresponds to the result of judgment in order to notify the user of an image capturing timing. In addition, the camera system control section 327 changes the waveform of the sawtooth wave between the front defocused state and the rear defocused state to notify the user of either the front defocused state or the rear defocused state. In the second modification example, the vibrator 331 extends and contracts in only one direction toward the user in the Z axis direction.

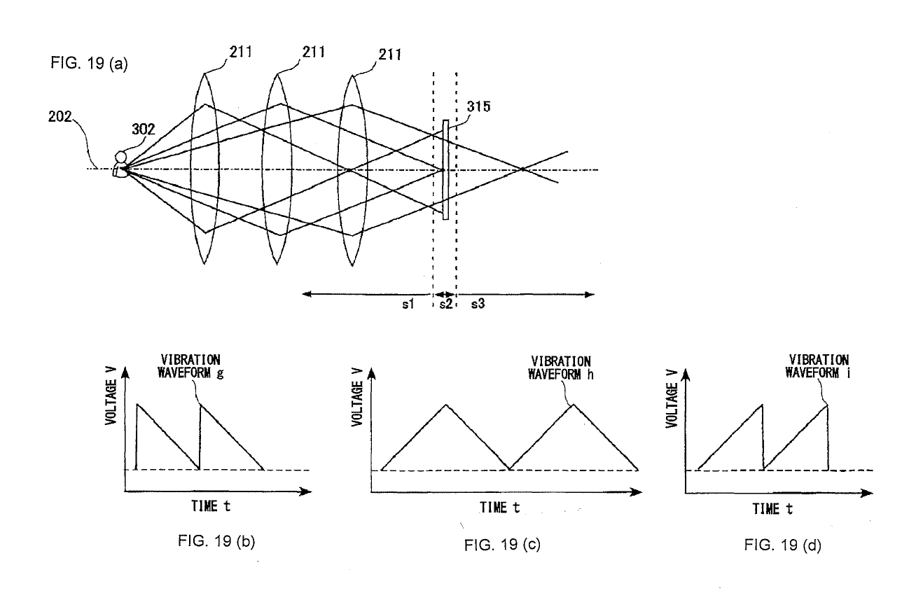

FIGS. 19(a)-19(d) are illustrative diagrams for explaining the vibration waveform supplied to the vibrator 331. Because FIG. 19(a) is identical to FIG. 18(a), the explanation for FIG. 19(a) is omitted. Referring to FIG. 19(a), the camera system control section 327 defines the segments (s1, s2, s3) that correspond to the defocused states of the object 302 respectively in advance.

FIGS. 19(b) to 19(d) illustrate vibration waveforms corresponding to the segments respectively. More specifically, FIG. 19(b) shows the vibration waveform that corresponds to the segment s1. In the same manner, FIG. 19(c) shows the vibration waveform that corresponds to the segment s2, and FIG. 19(d) shows the vibration waveform that corresponds to the segment s3. In each diagram, the vertical axis shows voltage V and the horizontal axis shows time “t”. The vibrator 331 extends when the voltage increases in the vibration waveform whereas the vibrator 331 contracts when the voltage decreases in the vibration waveform. The vibration waveform illustrated in FIG. 19(c) is hereunder referred to as vibration waveform “g,” the vibration waveform illustrated in FIGS. 19(b) and 19(d) is referred to as vibration waveform “h,” and the vibration waveform illustrated in FIG. 19(d) is referred to as vibration waveform “i.” The camera system control section 327 sets in advance the vibration waveforms that correspond to the segments respectively as described above.

When the camera system control section 327 judges that the defocused state corresponds to the segment s1, the vibration waveform “g” is supplied to the vibrator 331. The vibration waveform “g” rises sharply and falls slowly. Thus, the vibrator 331 that is supplied with the vibration waveform “g” rapidly extends toward the user side and then contracts slowly toward the object 302 side. Consequently, the user who recognizes such vibration feels like the camera system 100 is pushed toward the user. In this way, the user is able to know that the defocused state is the front defocused state.

When the camera system control section 327 judges that the defocused state corresponds to the segment s3, the vibration waveform “i” is supplied to the vibrator 331. The vibration waveform “i” rises slowly and falls sharply. Thus, the vibrator 331 that is supplied with the vibration waveform “i” slowly extends toward the user side and then contracts rapidly toward the object 302 side. Consequently, the user who recognizes such vibration feels like the camera system 100 is pulled from the object 302 side. In this manner, the user is able to know that the defocused state is the rear defocused state.

When the camera system control section 327 judges that the defocused state of the object 302 corresponds to the segment s2, the vibration waveform “h” is supplied to the vibrator 331. The vibration waveform “h” has a symmetrical amplitude pattern in one period of the waveform. Therefore, the user who recognizes such vibration of the vibration waveform “h” feels rather flat vibration compared to those of the vibration waveforms “g” and “h.” In this manner, the user is able to know that this is the image capturing timing.

Although the amplitudes of the vibration waveforms shown in FIGS. 19(b) to 19(d) are constant, the amplitudes may be changed according to the defocus amount. For example, as shown in FIG. 16, when there are five segments, the camera system control section 327 can increase the amplitude of each vibration waveform as the amount of defocus increases. In this manner, the camera system control section 327 can notify the user of the defocus amount and the defocus direction.

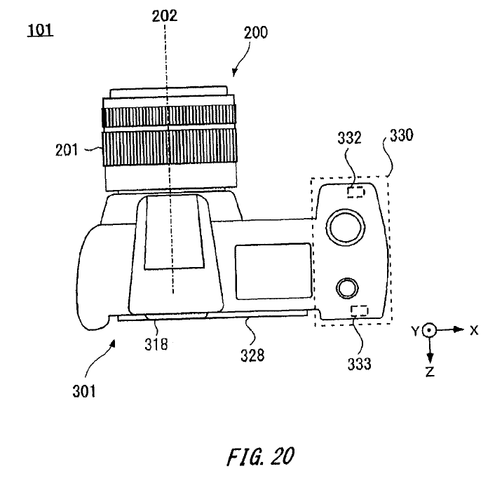

A third modification example in which more than one vibrator is provided in the camera system will be now described. Here, an example in which two vibrators are provided will be described. FIG. 20 is a birds-eye view of a camera system 101. Two vibrators 332, 333 are arranged, for example, on the grip section 330 in the z axis direction with a space therebetween. Here, the vibrator 332 is placed closer to the object and the vibrator 333 is placed closer to the user when the user holds the camera system 101 to take an image of the object. When the two vibrators 332, 333 are arranged with a certain distance therebetween along the z axis, the camera system control section 327 can supply different vibration waveforms to the two vibrators 332, 333 to inform the user of the image capturing timing and the defocused state.

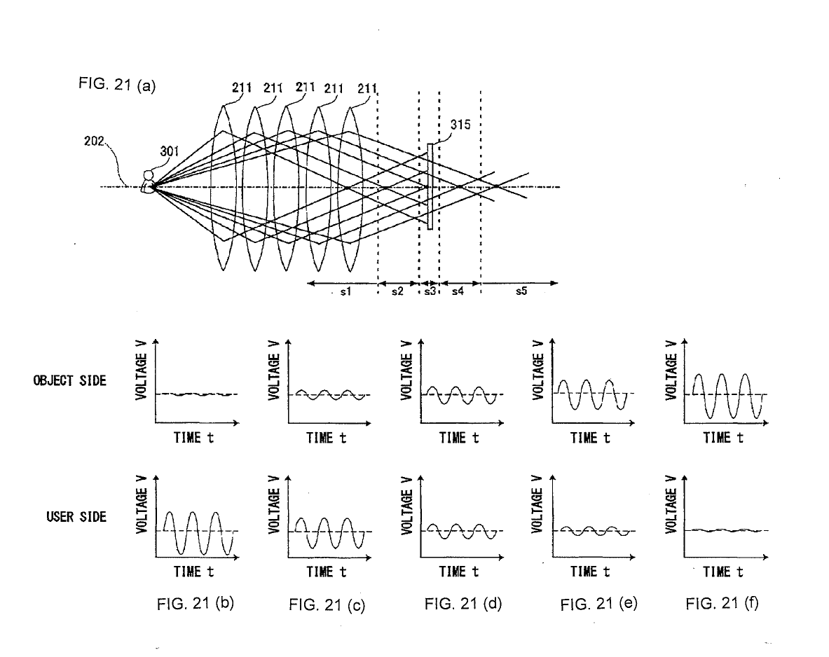

FIGS. 21(a)-21(f) are illustrative diagrams for explaining the vibration waveforms supplied to the vibrators 332 and 333. Because FIG. 21(a) is identical to FIG. 16(a), the explanation for FIG. 21(a) is omitted. Referring to FIG. 21(a), the camera system control section 327 defines respectively the segments (s1, s2, s3, s4, s5) that correspond to the defocused states of the object 301 in advance.

FIGS. 21(b) to 21(f) illustrate vibration waveforms corresponding to the segments respectively. In each diagram, the vertical axis shows voltage V and the horizontal axis shows time “t”. In FIGS. 21(b) to 21(f), the upper charts show the vibration waveforms supplied to the vibrator 332 situated closer to the object side, and the lower charts show the vibration waveforms supplied to the vibrator 333 situated closer to the user side. The camera system control section 327 specifies the vibration waveforms that correspond to the segments respectively. More specifically, as shown in the upper charts of FIGS. 21(b) to 21(f), the camera system control section 327 sets the amplitude of the vibration waveform that is supplied to the vibrator 332 situated closer to the object side to be increased as the defocused state transitions from the segment s1 to the segment s5. Whereas shown in the upper charts of FIGS. 21(b) to 21(f), the camera system control section 327 sets the amplitude of the vibration waveform that is supplied to the vibrator 333 situated closer to the user side to be decreased as the defocused state transitions from the segment s1 to the segment s5.

When the defocused state corresponds to the segment s1 or s2, in other words, when the defocused state is the front defocused state, the camera system control section 327 supplies, to the vibrator 333 situated closer to the user side, a vibration waveform with a larger amplitude than that of the vibration waveform supplied to the vibrator 332 situated closer to the object side. When the defocused state corresponds to the segment s4 or s5, in other words, when the defocused state is the rear defocused state, the camera system control section 327 supplies, to the vibrator 333 situated closer to the user side, a vibration waveform with a smaller amplitude than that of the vibration waveform supplied to the vibrator 332 situated closer to the object side. Thus, the user is able to know the defocused direction by recognizing which vibrator vibrates with a large amplitude.

Referring to FIGS. 21(b) and 21(c), comparing the vibrations waveforms shown in the upper charts to each other, the vibration waveform of the upper chart of FIG. 21(b) has a smaller amplitude than that of the vibration waveform of FIG. 21(c). Comparing the vibrations waveforms shown in the lower charts to each other, the vibration waveform of the lower chart of FIG. 21(c) has a smaller amplitude than that of the vibration waveform of FIG. 21(b). In other words, a difference in the amplitude between the two vibrators is larger in the segment s1 compared to that of the segment s2. Therefore, the user can know the defocus amount through the amount of the difference in the amplitude between the two vibrators.

When the camera system control section 327 judges that the defocused state of the object 301 corresponds to the segment s3, a common vibration waveform is supplied to the vibrators 331 and 332. Because the amplitudes of the vibration waveforms supplied to the vibrators 331 and 332 are the same, the user can know that this is the image capturing timing. Referring to FIGS. 21(b) to 21(f), at least one of the two vibratos vibrates in any segment in this example, so there is an advantage that the user can be assured that the camera system 100 works properly.

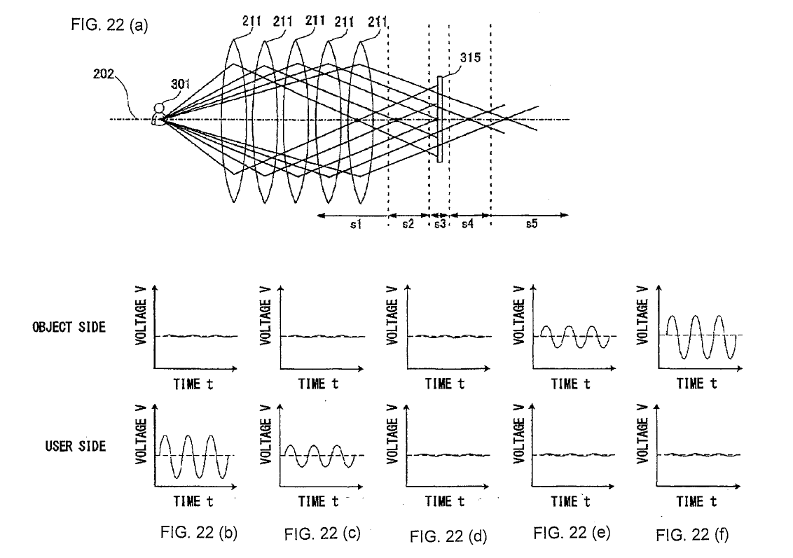

A fourth modification example in which different vibration waveforms are supplied to the two vibrators 332 and 333 will be now described. FIGS. 22(a)-22(f) are illustrative diagrams for explaining the vibration waveforms supplied to the vibrators 332 and 333. Because FIG. 22(a) is identical to FIG. 21(a), the explanation for FIG. 22(a) is omitted. Referring to FIG. 22(a), the camera system control section 327 defines the segments (s1, s2, s3, s4, s5) that correspond to the defocused states of the object 301 in advance.

FIGS. 22(b) to 22(f) illustrate vibration waveforms corresponding to the segments respectively. In each diagram, the vertical axis shows voltage V and the horizontal axis shows time “t”. In FIGS. 22(b) to 22(f), the upper charts show the vibration waveforms supplied to the vibrator 332 situated closer to the object side, and the lower charts show the vibration waveforms supplied to the vibrator 333 situated closer to the user side. More specifically, as shown in the upper charts of FIGS. 22(b) to 22(f), the camera system control section 327 sets the amplitude of the vibration waveform that is supplied to the vibrator 332 to be increased as the defocused state transitions as the segment s3->the segment s4->the segment s5. The difference from the example of FIG. 21 is that when the defocused state is the front defocused state, the camera system control section 327 supplies the same vibration waveform as that of the in-focus state.

Whereas shown in the lower charts of FIGS. 22(b) to 22(f), the camera system control section 327 sets the amplitude of the vibration waveform that is supplied to the vibrator 333 to be increased as the defocused state transitions as the segment s3->the segment s2->the segment s1. The difference from the example of FIGS. 21(a)-21(f) is that when the defocused state is the rear defocused state, the camera system control section 327 supplies the same vibration waveform as that of the in-focus state. Referring to FIGS. 22(b) to 22(f), in this example, both the vibrators vibrate with the smallest amplitudes when the focus lens 211 is at the in-focus position, so there is an advantage that the camera system can be prevented from being shaken by the hand of the user due to the vibration of the vibrators.

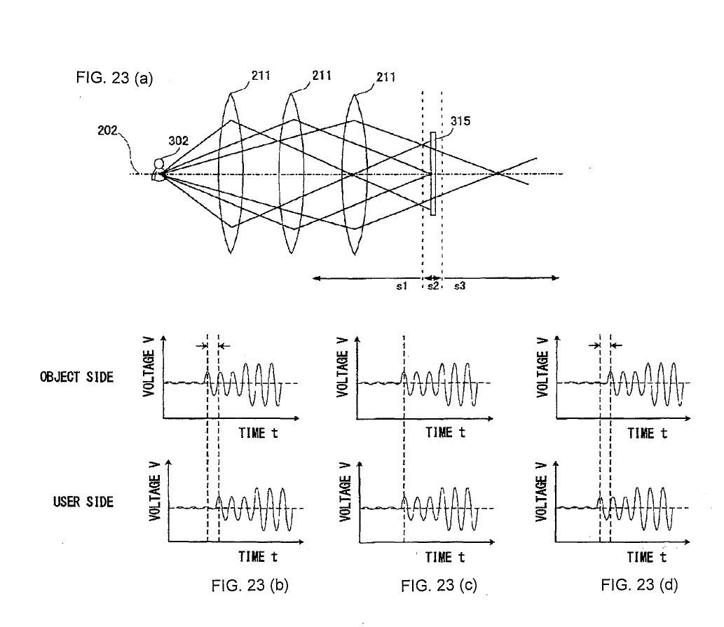

A fifth modification example in which the user is notified of the defocused state by supplying vibration waveforms that have different start timings to the vibrators will be now described. FIGS. 23(a)-23(d) are illustrative diagrams for explaining the vibration waveforms supplied to the vibrators 332 and 333. Because FIG. 23(a) is identical to FIG. 18(a), the explanation for FIG. 23(a) is omitted. Referring to FIG. 23(a), the camera system control section 327 defines the segments (s1, s2, s3) that correspond to the defocused states of the object 302 in advance.

FIGS. 23(b) to 23(d) illustrate vibration waveforms corresponding to the segments respectively. In each diagram, the vertical axis shows voltage V and the horizontal axis shows time “t”. In FIGS. 23(b) to 23(d), the upper charts show the vibration waveforms supplied to the vibrator 332 situated closer to the object side, and the lower charts show the vibration waveforms supplied to the vibrator 333 situated closer to the user side. The camera system control section 327 starts supplying a common vibration waveform to the vibrators 332 and 333 at different timings. The amplitude of the common vibration waveform increases over time.

More specifically, referring to FIG. 23(b), when the camera system control section 327 judges that the defocused state corresponds to the segment s1, the vibration waveform shown in the upper chart of FIG. 23(b) is supplied to the vibrator 332 situated closer to the object side, and the vibration waveform shown in the lower chart of FIG. 23(b) is supplied to the vibrator 333 situated closer to the user side. As indicated by the dotted line of FIG. 23(b), the vibration waveform of the upper chart of FIG. 23(b) rises prior to the vibration waveform of the lower chart of FIG. 23(b). Thus, the user who recognizes such vibration feels that the vibration moves from the object 302 side to the user side. In this way, the user can know that the user should step away from the object 302.

Referring to FIG. 23(d), when the camera system control section 327 judges that the defocused state corresponds to the segment s3, the vibration waveform shown in the upper chart of FIG. 23(b) is supplied to the vibrator 332 situated closer to the object side, and the vibration waveform shown in the lower chart of FIG. 23(d) is supplied to the vibrator 333 situated closer to the user side. As indicated by the dotted line of FIG. 23(d), the vibration waveform of the lower chart of FIG. 23(d) rises prior to the vibration waveform of the upper chart of FIG. 23(d). Thus, the user who recognizes such vibration feels that the vibration moves from the user side to the object 302 side. In this way, the user can know that the user should step forward to the object 302.

Referring to FIG. 23(c), when the camera system control section 327 judges that the position of the object 302 corresponds to the segment s2, the vibration waveform shown in the upper chart of FIG. 23(c) is supplied to the vibrator 332 situated closer to the object side, and the vibration waveform shown in the lower chart of FIG. 23(c) is supplied to the vibrator 333 situated closer to the user side. The begging of the vibration waveform of the upper chart of FIG. 23(c) occurs at the same timing as the vibration waveform of the lower chart of FIG. 23(d). Thus, the user who recognizes such vibration can know that this is the image capturing timing. The camera system control section 327 may differ the start timing of the vibration by shifting a phase of the vibration waveform supplied to the vibrators 332, 333 respectively.

When the two vibrators are provided, the camera system control section 327 judges the state of the object in the same manner as the case where only one vibrator is provided, and it supplies, to the vibrators, the vibration waveforms that correspond to the judgment result respectively to notify the user of the image capturing timing. In addition, as shown in FIGS. 21(a)-21(f) and FIGS. 22(a)-22(f), the camera system control section 327 changes the vibration waveform supplied to each vibrator according to the defocus direction and the defocus amount. Thus, it is possible to notify the user of the defocus direction and the defocus amount by making one of the vibratos vibrate stronger than the other. Moreover, as shown in FIGS. 23(a)-23(d), the camera system control section 327 shifts the vibration waveform supplied to each vibrator depending on the defocus direction. Therefore, the user can know the defocus direction depending on which vibrator starts vibrating first.

A sixth modification example in which the vibration waveform is changed depending on the size of an object in the image displayed in live-view instead of the output of the focus detection sensor 322. In the sixth modification example, the camera system has a single vibrator as illustrated in FIG. 1. The camera system control section 327 changes the vibration waveform according to the size of a specific object in the image displayed in live-view. In this case, the camera system control section 327 stores object images for pattern matching in the camera memory 341 responsive to the user operation. The camera system control section 327 sets, for example, a predetermined object specified by a user as the specific object. The object can be not only human but also an animal. The image processing section 326 recognizes the specific object by performing pattern matching that uses a person recognition feature, a face recognition feature or the like onto the live-view image.

The camera system control section 327 determines the size of the specific object that is recognized by the image processing section 326. The camera system control section 327 changes the vibration waveform supplied to the vibrator 331 depending on the size of the specific object, and notifies the user of the image capturing timing. Here, the image capturing timing means the moment when the object in the live-view image has an appropriate size. More specifically, the camera system control section 327 judges whether the coordinate points of each vertex of the rectangle in which the object is inscribed are situated at the edge of the live-view image. When all the coordinate points of each vertex of the rectangle are situated at the edges of the live-view image, the camera system control section 327 judges that the size of the specific object is too large. Because, in such case, the object likely runs off the edge of the image.

When any of the coordinate points of each vertex is not situated at the edge of the image, the camera system control section 327 calculates the area of the rectangle in which the object in the image is inscribed, and compares the value of the area with a predetermined threshold value. When the calculated value of the area is equal to or larger than the predetermined threshold value, the camera system control section 327 judges that the size of the object is appropriate. In other words, the camera system control section 327 judges that this is the image capturing timing. Whereas the calculated value of the area is less than the predetermined threshold value, the camera system control section 327 judges that the size of the object is too small.

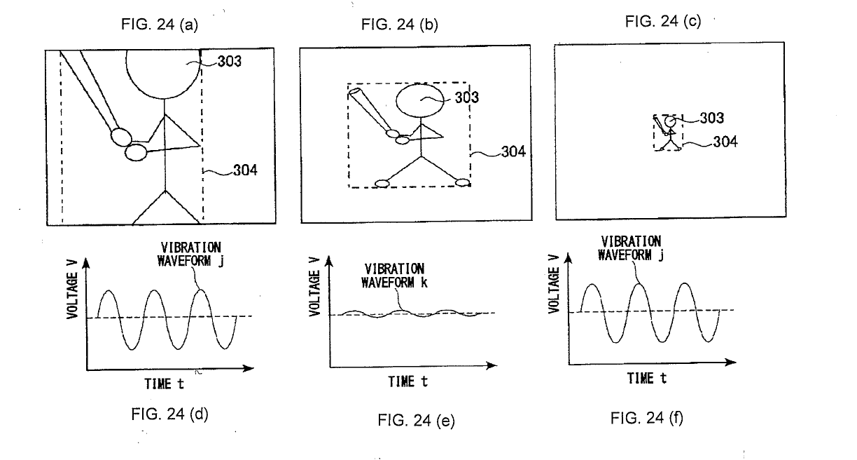

FIGS. 24(a)-24(f) are conceptual diagrams showing relationships between the size of an object 303 in a live-view image and the vibration waveform. FIGS. 24(a) to 24(c) illustrate the cases where the size of the object 303 is too large, appropriate, and too small, respectively. The camera system control section 327 defines the segments that correspond to the size of the object 303 in advance. Here, the camera system control section 327 defines a case where all the coordinate points of each vertex of a rectangle 304 that encloses the object 303 are situated at the edges of the image as

a segment s1. The camera system control section 327 defines a case where the area of the rectangle 304 in which the object 303 is inscribed is equal to or larger than a predetermined threshold value as a segment s2. The camera system control section 327 further defines a case where the area of the rectangle 304 in which the object 303 is inscribed is less than the predetermined threshold value as a segment s3.

FIGS. 24(d) to 24(f) illustrate vibration waveforms corresponding to the segments respectively. More specifically, the vibration waveform of FIG. 24(d) corresponds to the segment s1. In the same manner, the vibration waveform of FIG. 24(e) corresponds to the segment s2, and the vibration waveform of FIG. 24(f) corresponds to the segment s3. In each diagram, the vertical axis shows voltage V and the horizontal axis shows time “t”. Here, the vibration waveform of FIG. 24 (d) is identical to that of FIG. 24(f). The vibration waveform illustrated in FIGS. 24(d) and 24(f) is hereunder referred to as vibration waveform “j,” and the vibration waveform illustrated in FIG. 24(e) is referred to as vibration waveform “k.” The camera system control section 327 sets in advance the vibration waveforms that correspond to the segments respectively as described above.

When the camera system control section 327 judges that the size of the object 303 corresponds to the segment s2, the vibration waveform “k” is supplied to the vibrator 331. The vibration waveform “k” has a smaller amplitude than that of the vibration waveforms “j.” Thus, the user who recognizes such vibration can know that this is the image capturing timing. Moreover, the camera system control section 327 supplies the vibration waveform with the smallest amplitude at the image capturing timing so that the camera will not be shaken by the hand of the user during image capturing action due to the vibration.

When the camera system control section 327 judges that the size of the object 303 corresponds to the segment s1 or the segment s3, the vibration waveform “j” is supplied to the vibrator 331. Because the vibration waveform “j” has a larger amplitude than that of the vibration waveforms “k,” the user who recognizes such vibration can know that the size of the object 303 is not appropriate. The camera system control section 327 may change the frequency of the vibration waveform supplied to the vibrator 331 according to the size of the object 303.

Alternatively, the camera system control section 327 may supply, to the vibrator 331, the sawtooth waveforms shown in FIGS. 19(b) to 19(d) according to the size of the object 303. Moreover, when there are two vibrators provided, the camera system control section 327 may supply, to the two vibrators respectively, the vibration waveforms shown in FIGS. 21(a)-(f) to FIGS. 23(a)-(d) according to the size of the object 303. In these cases, the camera system control section 327 can inform the user whether the size of the object is large or small.

A seventh modification example in which the camera system control section 327 changes the vibration waveform depending on the position of the object in the image displayed in live-view. In the seventh modification example, the camera system has a single vibrator as illustrated in FIG. 1. In the seventh modification example, the camera system control section 327 determines the position of a specific object in the image displayed in live-view, in other words, the position of the specific object with respect to the angle of view of the object, and changes the vibration waveform according to the position of the specific object. In this way, the camera system control section 327 notifies the user of the image capturing timing. Here, the image capturing timing means the moment when the object in the live-view image is at an appropriate position.

The camera system control section 327 estimates a rectangle in which the object in the live-view image is inscribed, and determines a degree of overlap between the area of the rectangle and the area of an appropriate positional range which is prescribed. When the amount of amount of overlap between the area of the rectangle and the area of the appropriate positional range is equal to or larger than a predetermined ratio, the camera system control section 327 judges that the position of the object is appropriate. In other words, the camera system control section 327 judges that this is the image capturing timing.

Whereas when the amount of amount of overlap between the area of the rectangle and the area of the appropriate positional range is less than a predetermined ratio, the camera system control section 327 judges that the position of the object is shifted left or right. More specifically, the camera system control section 327 judges whether the coordinate points of each vertex of the rectangle is shifted right or left with respect to the appropriate positional range to determine offset of the object position.

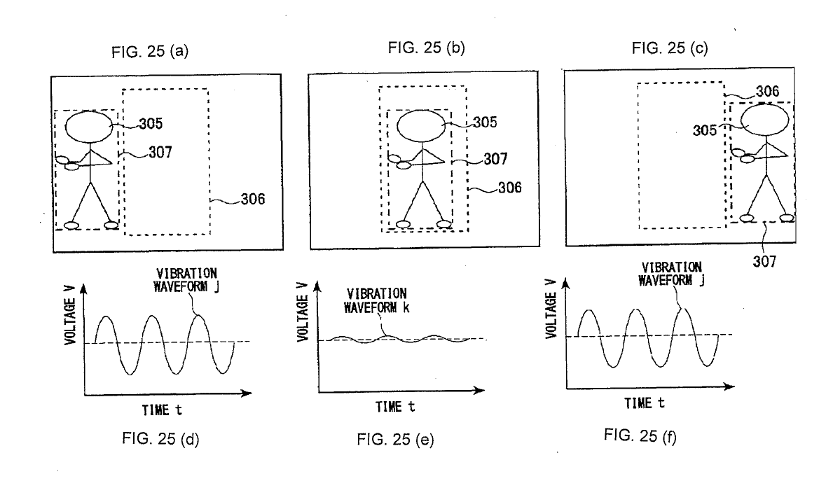

FIGS. 25(a)-25(f) are conceptual diagrams showing relationships between the position of an object 305 in a live-view image and the vibration waveform. FIGS. 25(a) to 25(c) illustrate the relationships between the object 305 and an appropriate positional range 306. The camera system control section 327 sets in advance segments that correspond to the position of the object 305. Here, referring to FIG. 25(a), the camera system control section 327 defines a case where the overlap of the rectangle 307 is less than the predetermined ratio and the coordinate points of each vertex of the rectangle are off the appropriate positional range 306 on the left side of the appropriate positional range 306, in other words, the object 305 is shifted left from the appropriate positional range 306, as a segment s1. Referring to FIG. 25(b), the camera system control section 327 defines a case where the overlap between the rectangle 307 and the appropriate positional range 306 is equal to or larger than the predetermined ratio, in other words, the object 305 is within the appropriate positional range 306, as a segment s2. Referring to FIG. 25(c), the camera system control section 327 defines a case where the overlap of the rectangle 307 is less than the predetermined ratio and the coordinate points of each vertex of the rectangle are off the appropriate positional range 306 on the right side of the appropriate positional range 306, in other words, the object 305 is shifted right from the appropriate positional range 306, as a segment s3.

FIGS. 25(d) to 25(f) illustrate vibration waveforms corresponding to the segments respectively. Because FIGS. 25(d) to 25(f) are identical to FIGS. 24(d) to 24(f), the explanation for FIGS. 25(d) to 25(f) are omitted. The camera system control section 327 sets in advance the vibration waveforms that correspond to the segments respectively as described above.

When the camera system control section 327 judges that the position of the object 305 corresponds to the segment s2, in other words, the object 305 is within the appropriate positional range 306, the vibration waveform “k” is supplied to the vibrator 331. The vibration waveform “k” has a smaller amplitude than that of the vibration waveforms “j.” Thus, the user who recognizes such vibration can know that this is the image capturing timing. Moreover, the camera system control section 327 supplies the vibration waveform with the smallest amplitude at the image capturing timing so that the camera will not be shaken by the hand of the user during image capturing action due to the vibration.

When the camera system control section 327 judges that the position of the object 305 corresponds to the segment s1 or the segment s3, the vibration waveform “j” is supplied to the vibrator 331. The vibration waveform “j” has a larger amplitude than that of the vibration waveforms “k.” Thus, the user who recognizes such vibration can know that the position of the object 305 is not appropriate. The camera system control section 327 may change the frequency of the vibration waveform supplied to the vibrator 331 according to the size of the object 303.

Alternatively, the camera system control section 327 may supply, to the vibrator 331, the sawtooth waveforms shown in FIGS. 19(b) to 19(d) according to the size of the object 303. Moreover, when there are two vibrators provided, the camera system control section 327 may supply, to the two vibrators respectively, the vibration waveforms shown in FIGS. 21(a)-(f) to FIGS. 23(a)-(f) according to the size of the object 303. In these cases, the camera system control section 327 can inform the user of the direction in which the object 305 is off the appropriate range.

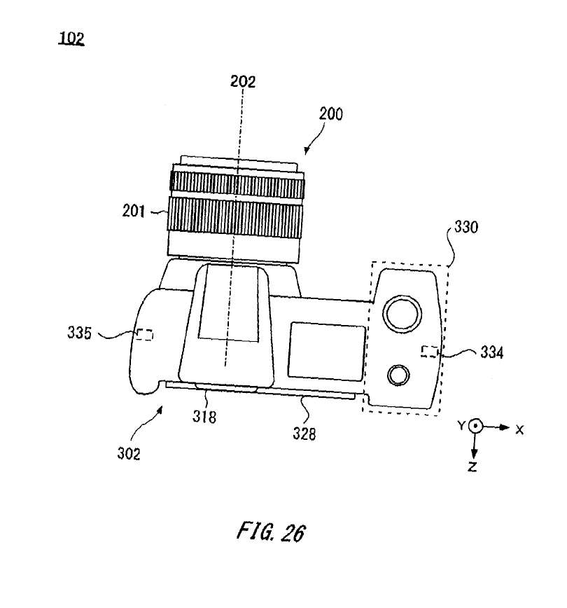

When the camera system control section 327 changes the vibration waveform according to the position of the object 305, the vibrator 331 is preferably arranged such that it oscillates in a direction crossing the optical axis. Moreover, when there are two vibrators provided, the two vibrators are preferably arranged with a certain distance therebetween in the direction crossing the optical axis. FIG. 26 is a birds-eye view of a camera system 102 in which two vibrators are provided. Here two vibrators 334, 335 are arranged in the x axis direction with a space therebetween.

When the camera system control section 327 judges that the position of the object 305 corresponds to the segment s1, the vibration waveform shown in the upper chart of FIG. 23(b) is supplied to the vibrator 334 situated on the right side of the camera system 102 when viewed from the above, and the vibration waveform shown in the lower chart of FIG. 23(b) is supplied to the vibrator 335 situated on the left side of the camera system 102 when viewed from the above. The vibration waveform of the upper chart of FIG. 23(b) rises prior to the vibration waveform of the lower chart of FIG. 23(b). Thus, the user who recognizes such vibration feels that the vibration moves from the right to the left. In this way, the user can know that the user should point the camera system 102 to the right.

When the camera system control section 327 judges that the position of the object 305 corresponds to the segment s3, the vibration waveform shown in the upper chart of FIG. 23(d) is supplied to the vibrator 334 situated on the right side of the camera system, and the vibration waveform shown in the lower chart of FIG. 23(d) is supplied to the vibrator 335 situated on the left side. The vibration waveform of the upper chart of FIG. 23(d) rises posterior to the vibration waveform of the lower chart of FIG. 23(d). Thus, the user who recognizes such vibration feels that the vibration moves from the left to the right. In this way, the user can know that the user should point the camera system 102 to the left.

Although a piezoelectric element is used as the vibrator in the above description, a voice coil motor can also be used as the vibrator. When the voice coil motor can also be used as the vibrator, the voice coil motor is provided inside the case of the camera unit 300 through a membrane to form a vibration unit. When a sinusoidal waveform is used as the vibration waveform, a vibration motor which is typically used for a mobile phone can be used. Even when other elements than the piezoelectric element are used as the vibrators, the camera system control section 327 can notify the user of the image capturing timing by supplying a driving voltage to the element such that a physical displacement of the element becomes smallest at the image capturing timing.

Although the vibrator is arranged at, for example, the grip portion of the camera system in the above description, the vibrator can be situated at the lens unit. Moreover, when the lens unit has a tripod mount section, the vibrator can be provided at the tripod mount section. In this case, the vibrator can be powered by sharing the contact point provided on the lens unit side. Furthermore, the vibrator can be disposed at the gravity center of the camera system. When the vibrator is disposed at the gravity center of the camera system, it is possible to minimize rotary torque caused by the vibration of the vibrator. Therefore, the configuration in which the vibrator is disposed at the gravity center of the camera system is advantageous in terms of image stabilizing.

Although the camera system control section 327 judges the segment that corresponds to the defocus amount and supplies, to the vibrator, the vibration waveform that corresponds to the segment in the above description, alternatively, the control section can supply directly a vibration waveform that has the amplitude proportional to the defocus amount. In this case, the vibration waveform is represented by a function that uses the defocus amount as input. When the image capturing mode is set to the motion image capturing mode, the camera system control section 327 may reduce the amplitude of the vibration waveform compared to that of the still image capturing mode, or may stop supplying the vibration waveform to the vibrator. In this manner, it is possible to prevent sound made by the vibration of the vibrator from being recorded when the motion image capturing is performed.

### Third Embodiment

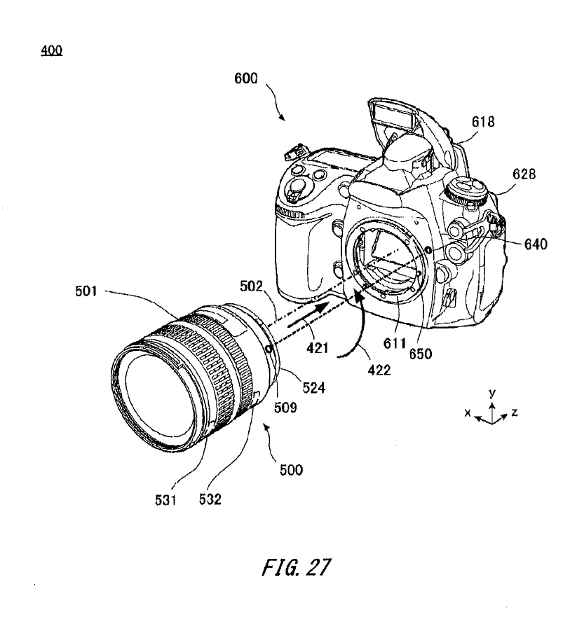

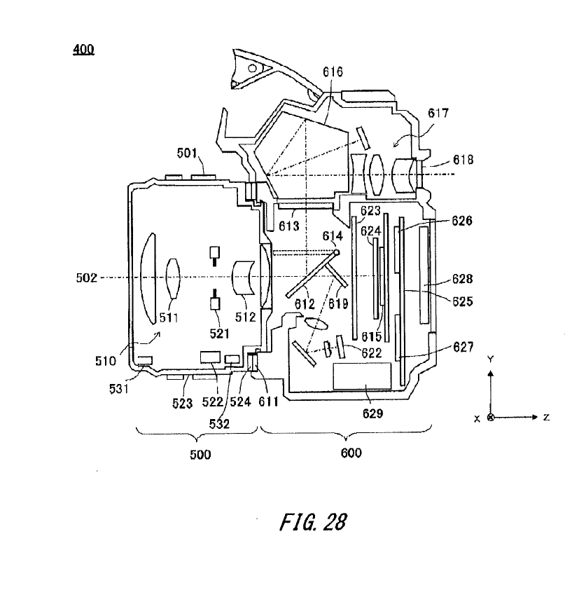

FIG. 27 is a schematic top view of a camera system 400 according to a third embodiment. The camera system 400 is a single-lens reflex camera with interchangeable lenses, which includes a lens unit 500 attached to a camera unit 600. The lens unit 500 includes a lens mount 524, and the camera unit 600 includes a camera mount 611. When the lens unit 500 is integrated with the camera unit 600 by engaging the lens mount 524 with the camera mount 611, the lens unit 500 and the camera unit 600 operate as the camera system 400. In the following description, a z-axis is defined in the direction in which light beam of the object (the light beam emitted from the object) enters in the camera along an optical axis 502 as illustrated in the drawing. In addition, a x-axis is defined in a direction perpendicular to the z-axis and in parallel to the longitudinal direction of the camera unit 600, which can be referred to as the right-left direction. A y-axis is defined in a direction perpendicular to the x-axis and z-axis, which can be referred to as the vertical direction.

The lens mount 524 is brought closer to the camera mount 611 as indicated by the arrow 421 which is parallel to the optical axis 502, and the lens mount is brought in contact with the camera mount such that a lens indicator 509 faces a body indicator 640. The lens unit 500 is then rotated in the direction indicated by the arrow 422 while the mounting surface of the lens mount 524 remains in contact with the mounting surface of the camera mount 611. Then a locking mechanism that uses a locking pin 650 is activated, thereby the lens unit 500 is locked to the camera unit 600. In this state, a communication terminal of the lens unit 500 is connected with a communication terminal of the camera unit 600, and they can exchange communication signal, power and the like.

The camera system 600 includes a finder window 618 for observing an object, and a display section 628 for displaying a live-view image or the like. The lens unit 500 further includes vibrators 531, 532. In the third embodiment, the vibrators 531, 532 are disposed at a potion where the user holds the lens unit 500 when the user captures an image. More specifically, when the lens unit 500 is attached to the camera unit 600 and they are in a lateral attitude, the vibrators 531, 532 are disposed at lower position of the lens unit 500 in the vertical direction. Here, the lateral attitude refers to a state where the bottom of the camera system 400 faces the ground in the vertical direction. The vibrators 531, 532 are disposed along the z axis with a space therebetween.

The camera system 400 judges a state of the object according to at least a portion of an image of the object, and vibrates the vibrators 531, 532 in coordination with each other based on the judgment. In this embodiment, the camera system 400 judges a defocused state of the object as the state of the object. The camera system 400 changes the vibration waveforms generated by the vibrators 531, 532 according to the defocus state of the object.

According to this embodiment, when the user holds the lens unit 500 with the left hand and performs a manual focusing operation, the user can know a defocused state of the object through the vibration received by the left hand. Therefore, the user can adjust a focus ring 501 without looking the finder window 618 or the display section 628.

FIG. 28 is a sectional view of the main section of the camera system 400. The lens unit 500 a group of lenses 510 arranged along the optical axis 502, and a diaphragm 521. The group of lenses 510 includes a focus lens 511 and a zoom lens 512. The lens unit 500 has more than one motor such as an oscillating-wave motor, a VCM and the like to drive the focus lens 511 in the optical axis 502 direction. The lens unit 500 further includes a lens system control section 522 that controls the lens unit 500 and performs calculation concerning the lens unit 500. The lens unit 500 further includes the focus ring 501. When a user performs a manual focusing operation, the user rotates the focus ring 501 in conjunction with the focus ring 511.

The lens unit 500 further includes the two vibrators 531, 532. The vibrators 531, 532 are, for example, piezoelectric elements that are placed at a lens barrel 523. The lens barrel 523 is vibrated when the piezoelectric element contracts and expands. A vibration waveform of the piezoelectric element, which is a physical amount of displacement of the element, is promotional to a vibration waveform of a driving voltage supplied to the piezoelectric element.

Elements of the lens unit 500 are held by the lens barrel 523. The lens unit 500 further has the lens mount 524 at a connecting section with the camera unit 600. The lens mount 524 is attached to the camera mount 611 of the camera unit 600 to integrate the lens unit 500 with the camera unit 600.

The camera unit 600 includes a main mirror 612 that reflects an object image entered thereon from the lens unit 500, and a focusing screen 613 on which the object image that is reflected by the main mirror 612 is imaged. The main mirror 612 rotates on a pivot point 614 and it can be placed by rotation at a state in which the main mirror is placed in and directed diagonally to an object light beam centering on the optical axis 502, or a state in which the main mirror is out of the object light beam. When an object image is guided to the focusing screen 613 side, the main mirror 612 is placed in and directed diagonally to the object light beam. The focusing screen 613 is placed at a position conjugate to a light-receiving plane of an image capturing element 615.

The object image imaged at the focusing screen 613 is converted into an erected image by a pentaprism 616, and the elected image is observed by a user through an eyepiece optical system 617. An area near the optical axis 502 of the main mirror 612 that is directed diagonally, forms a half mirror, and a half of the incident beam is transmitted through the area. The transmitted light beam is reflected by a sub-mirror 619 that coordinates with the main mirror 612, and then enters in a focus detection sensor 622. The focus detection sensor 622 is, for example, a phase difference detection sensor that detects a phase difference from the received object light beam. When the main mirror 612 is placed out of the object light beam, the sub-mirror 619 retracts from the object light beam in conjunction with the main mirror 612.

Behind the main mirror 612 that is directed diagonally, a focal plane shutter 623, an optical low-pass filter 624, and the image capturing element 615 are arranged along the optical axis 502. The focal plane shutter 623 is opened when the object light beam is guided toward the image capturing element 615, and closed otherwise. The optical low-pass filter 624 adjusts a spatial frequency of the object image with respect to pixel pitch of the image capturing element 615. The image capturing element 615 is a light receiving element such as a CMOS sensor, and it converts the object image that is imaged at the light receiving plane into an electric signal.

The electric signal photoelectric converted by the image capturing element 615 is then processed to turn into image data by an image processing section 626 that is an ASIC provided on a main substrate 625. In addition to the image processing section 626, the main substrate 625 has a camera system control section 627 which is an MPU that integrally controls the system of the camera unit 600. The camera system control section 627 manages camera sequences and performs input/output processing of each component and the like.

The display section 628 such as a liquid crystal monitor is provided on the back side of the camera unit 600, and an object image which has been processed by the image processing section 626 is displayed on the display section. A live-view display is realized when object images are photoelectric-converted sequentially by the image capturing element 615 and such object images are successively displayed on the display section 628. The camera unit 600 further includes a detachable secondary cell 629. The secondary cell 629 powers not only the camera unit 600 but also the lens unit 500.

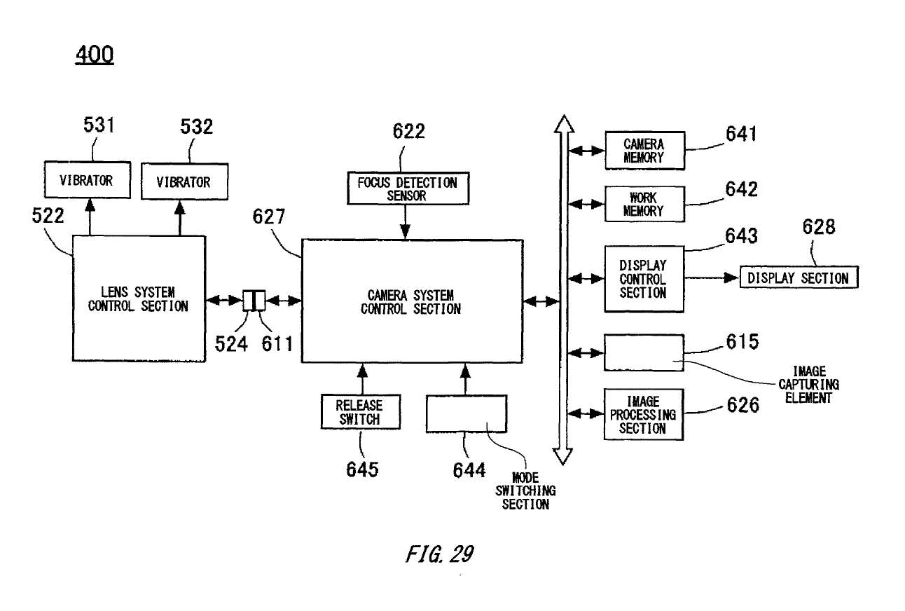

FIG. 29 illustrates a system configuration of the camera system 400. The camera system 400 includes a lens control system centered on the lens system control section 522 and a camera control system centered on the camera system control section 627 corresponding to the lens unit 500 and the camera unit 600 respectively. The lens control system and the camera control system exchange various data and control signals to each other via a connecting section that is connected to the lens mount 524 and the camera mount 611.

The image processing section 626 included in the camera control system follows an instruction by the camera system control section 627 to process the captured image signal that has been photoelectrically converted by the image capturing element 615 and covert the signal into image data that has a predetermined image format. More specifically, when a JPEG file is created as a still image, the image processing section 626 performs image processing such as a color conversion processing, a gamma processing, and a white balance processing and the performs compression such as adaptive discrete cosine transformation.

When a MPEG file is created as a motion image, the image processing section 626 performs compression by performing intra-frame coding and inter-frame coding on frame images which is a sequence of still images whose number of pixels is reduced to a prescribed number.

Camera memory 641 is, for example, non-volatile memory such as flash memory that stores programs to control the camera system 400 and various parameters. Work memory 642 is, for example, fast access memory such as RAM that temporally stores image data which is under processing.

A display control section 643 displays a screen image on the display section 628 in accordance with the instruction by the camera system control section 627. A mode switching section 644 receives mode setting information from the user such as an image capturing mode and a focus mode, and outputs it to the camera system control section 627. The image capturing mode includes a motion image capturing mode and a still image capturing mode. The focus mode includes an auto focus mode and a manual focus mode.

For example, one focusing point with respect to the object space is selected by the user and it is set in the focus detection sensor 622. The focus detection sensor 622 detects a phase difference signal at the set focusing point. The focus detection sensor 622 can detect whether the object at the focusing point is in focus or defocused. When the object is defocused, the focus detection sensor 622 can also determine the amount of defocus from the in-focus position.

A release switch 645 has two switch positions along the direction toward which the release switch is pressed down. When the camera system control section 627 detects that a switch sw1 placed at the first one of the two positions is turned on, the control section receives the phase difference information from the focus detection sensor 622. When the auto focus mode is selected as the focus mode, the camera system control section 627 transmits information about driving of the focus lens 511 to the lens system control section 522. Moreover, when the camera system control section 627 detects that a switch sw2 placed at the other one of the two positions is turned on, it performs image capturing processing in accordance with a prescribed processing flow.

When the manual focus mode is selected as the focus mode, the camera system control section 627 serves together with the focus detection sensor 622 as a judging section that judges a depth state of the object with reference to at least a portion of the object image. More specifically, the camera system control section 627 judges the defocused state of the object based on the phase difference information obtained from the focus detection sensor 622.

The camera system control section 627 the supplies to the vibrators 531, 532 with vibration waveforms that correspond to the defocused state of the object through the lens system control section 522. Thus, even when the user performs image capturing of the object without looking at the finder window 618 or the display section 628, the user can know the image capturing timing through change of the vibration generated by the vibrators 531, 532. The vibrators 531, 532 receive the vibration waveforms from the camera system control section 627 and the vibrator extends and contracts in accordance with the vibration waveform.

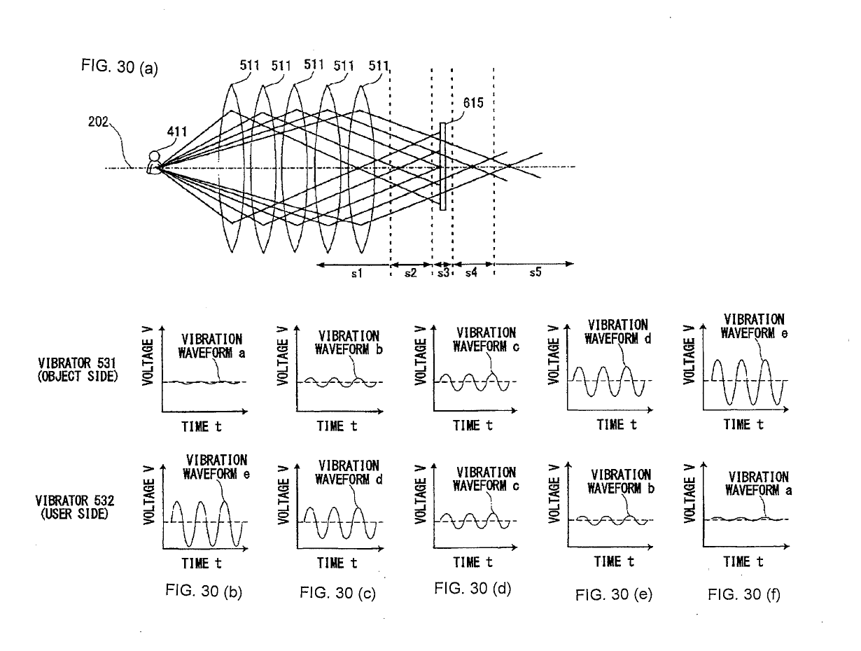

Judgment on a defocused state of the object by the camera system control section 627 will be now described. FIGS. 30(a)-30(f) are illustrative diagrams for explaining the vibration waveforms supplied to the vibrators 531, 532. FIG. 30(a) illustrates positional relationships between the image capturing element 615, the focus lens 511, and the optical axis 502 direction of an object 411, in particular, illustrates the positions of the focus lens 511 and segments (s1, s2, s3, s4, s5) that correspond to the defocused states of the object 411.

Here, relationships between the segments corresponding to the defocused states of the object 411 and the defocused amount will be now described. For example, in a front defocused state, such as the state where a light beam is focused in, for example, the range of the segment s2, the defocus amount at the image capturing plane is unambiguously defined. Thus, the camera system control section 627 can determine, in accordance with the defocus amount, which segment the focus lens 511 focuses the light beam in.

Referring to FIG. 30(a), the camera system control section 627 defines the segments that correspond to the defocused states of the object 411 in advance. More specifically, the camera system control section 627 holds information about a range in which it can be considered as in-focus states, in the form of a parameter table that includes parameters such as focal distances and aperture values, and the control section sets the range of in-focus state as the segment s3.

Moreover, the camera system control section 627 defines two segments for the front defocused state depending on the defocus amount, and these two segments are set as the segment s1 and the segment s2. In the same manner, the camera system control section 627 defines two segments for a rear defocused state depending on the defocus amount, and these two segments are set as the segment s4 and the segment s5.

FIGS. 30(b) to 30(f) illustrate vibration waveforms corresponding to the segments respectively. More specifically, FIG. 30(b) shows the vibration waveform that corresponds to the segment s1. In the same manner, FIG. 30(c) shows the vibration waveform that corresponds to the segment s2, FIG. 30(d) shows the vibration waveform that corresponds to the segment s3, FIG. 30(e) shows the vibration waveform that corresponds to the segment s4, and FIG. 30(f) shows the vibration waveform that corresponds to the segment s5. Here, the vibration waveform of FIG. 30 (b) is identical to that of FIG. 30(f). Here, the upper chart of FIG. 30(c) is identical to the lower chart of FIG. 30(e), the upper chart of FIG. 30(d) is identical to the lower chart of FIG. 30(d), the upper chart of FIG. 30(d) is identical to the lower chart of FIG. 30(c), the upper chart of FIG. 30(f) is identical to the lower chart of FIG. 30(b). In each diagram, the vertical axis shows voltage V and the horizontal axis shows time “t”. The vibrators 531, 532 extend when the voltage increases in the vibration waveform whereas the vibrators 531, 532 contract when the voltage decreases in the vibration waveform.

The vibration waveform illustrated in the upper chart of FIG. 30(b) and the lower chart of FIG. 30(f) are hereunder referred to as vibration waveform “a,” the vibration waveform illustrated in the upper chart of FIG. 30(c) and the lower chart of FIG. 30(e) are referred to as vibration waveform “b,” and the vibration waveform illustrated in the upper chart of FIG. 30(d) and the lower chart of FIG. 30(d) is referred to as vibration waveform “c”. The vibration waveform illustrated in the upper chart of FIG. 30(e) and the lower chart of FIG. 30(c) are hereunder referred to as vibration waveform “d,” and the vibration waveform illustrated in the upper chart of FIG. 30(f) and the lower chart of FIG. 30(b) are referred to as vibration waveform “f”. In FIGS. 30(b) to 30(f), the upper charts show the vibration waveforms supplied to the vibrator 531 that is situated closer to the object side, and the lower charts show the vibration waveforms supplied to the vibrator 532 that is situated closer to the user side.

The camera system control section 627 sets in advance the vibration waveforms that correspond to the segments respectively. More specifically, the camera system control section 627 holds information about amplitudes, cycles and types of the vibration waveform in the camera memory 641 as setting items for the vibration waveform. An example of the types of the vibration waveform includes sinusoid, sawtooth wave and the like.

As shown in the lower charts of FIGS. 30(b) to 30(f), the camera system control section 627 sets the amplitude of the vibration waveform that is supplied to the vibrator 531 situated closer to the object side to be increased as the defocused state transitions from the segment s1 to the segment s5. Whereas shown in the lower charts of FIGS. 30(b) to 30(f), the camera system control section 627 sets the amplitude of the vibration waveform that is supplied to the vibrator 532 situated closer to the user side to be decreased as the defocused state transitions from the segment s1 to the segment s5.

When the defocused state corresponds to the segment s1 or s2, in other words, when the defocused state is the front defocused state, the camera system control section 627 supplies, to the vibrator 532 situated closer to the user side, a vibration waveform with a larger amplitude than that of the vibration waveform supplied to the vibrator 531 situated closer to the object side. When the defocused state corresponds to the segment s4 or s5, in other words, when the defocused state is the rear defocused state, the camera system control section 627 supplies, to the vibrator 532 situated closer to the user side, a vibration waveform with a smaller amplitude than that of the vibration waveform supplied to the vibrator 531 situated closer to the object side. Thus, the user is able to know the defocused direction sensuously by recognizing which vibrator vibrates with a large amplitude.

Referring to FIGS. 30(b) and 30(c), comparing the vibrations waveforms shown in the upper charts to each other, the vibration waveform of the upper chart of FIG. 30(b) has a smaller amplitude than that of the vibration waveform of FIG. 30(c). Comparing the vibrations waveforms shown in the lower charts to each other, the vibration waveform of the lower chart of FIG. 30(c) has a smaller amplitude than that of the vibration waveform of FIG. 30(b). In other words, a difference in the amplitude between the two vibrators is larger in the segment s1 compared to that of the segment s2. Therefore, the user can know the defocus amount sensuously through the amount of the difference in the amplitude between the two vibrators.

When the camera system control section 627 judges that the defocused state of the object 411 corresponds to the segment s3, a common vibration waveform is supplied to the vibrators 531 and 532. Because the amplitudes of the vibration waveforms supplied to the vibrators 531 and 532 are the same, the user can know that this is the image capturing timing without looking the finder window 618 or the display section 628. Referring to FIGS. 30(b) to 30(f), at least one of the two vibratos vibrates in any segment in this example, so there is an advantage that the user can be assured that the camera system 400 works properly.

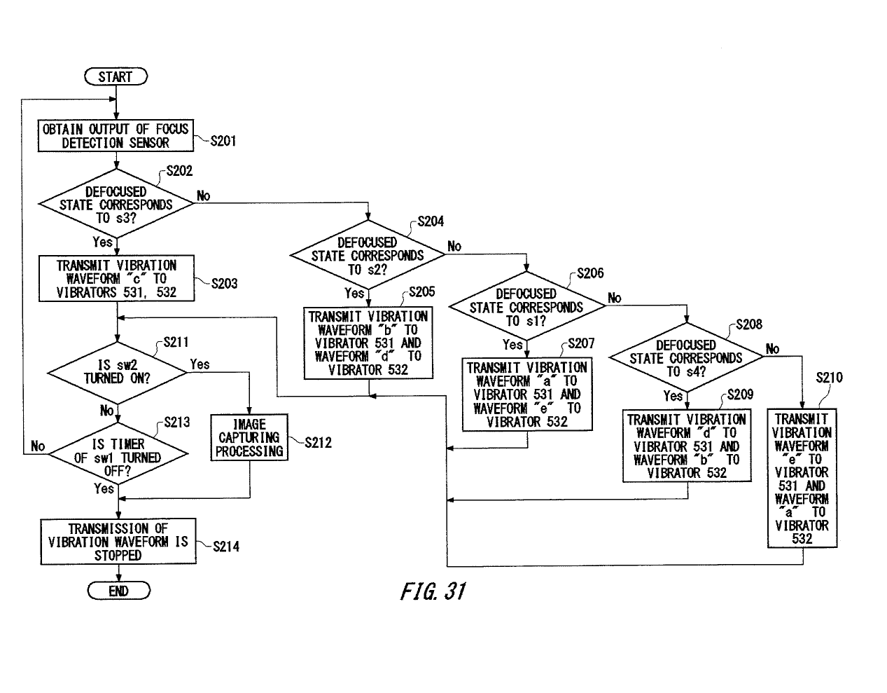

FIG. 31 is a flow chart of an image capturing operation of the camera system 400. The image capturing operation flow starts with detection by the camera system control section 627 to detect that a SW1 is turned on when the focus mode is set to the manual focus mode and the image capturing mode is set to the still image capturing mode. When turning on of the SW1 is detected, the camera system control section 627 obtains the output of the focus detection sensor 622 (step S201).

The camera system control section 627 judges whether the defocused state of the object 411 corresponds to the segment s3 (step S202). When the camera system control section 627 determines that the defocused state of the object 411 corresponds to the segment s3 (step S202: Yes), it transmits the vibration waveform “c” to the vibrators 531, 532 (step S203). When the camera system control section 627 determines that the defocused state of the object 411 does not correspond to the segment s3 (step S202: No), the camera system control section 627 further judges whether the defocused state corresponds to the segment s2 (step S204). When the camera system control section 627 determines that the defocused state corresponds to the segment s2 (step S204: Yes), it transmits the vibration waveform “d” to the vibrators 531, 532 (step S205).

When the camera system control section 627 determines that the defocused state does not correspond to the segment s2 (step S204: No), the camera system control section 527 further judges whether the defocused state corresponds to the segment s1 (step S206). When the camera system control section 627 determines that the defocused state corresponds to the segment s1 (step S206: Yes), it transmits the vibration waveform “a” to the vibrator 531 and the vibration waveform “e” to the vibrator 532 (step S207).

When the camera system control section 627 determines that the defocused state does not correspond to the segment s1 (step S206: No), the camera system control section 527 further judges whether the defocused state corresponds to the segment s4 (step S208). When the camera system control section 627 determines that the defocused state corresponds to the segment s4 (step S208: Yes), it transmits the vibration waveform “d” to the vibrator 531 and the vibration waveform “b” to the vibrator 532 (step S209).

When the camera system control section 627 determines that the defocused state does not correspond to the segment s4 (step S208: No), the defocused state corresponds to the segment s5. In this case, the camera system control section 627 transmits the vibration waveform “e” to the vibrator 531 and the vibration waveform “a” to the vibrator 532 (step S210).

After the camera system control section 627 transmits any of the vibration waveforms, it then judges whether a SW 2 is turned on (step S211). When the camera system control section 627 determines that the SW2 is turned on (step S211: Yes), the image capturing processing is performed (step S212).

Whereas when the camera system control section 627 determines that the SW2 is not turned on (step S211: No), the camera system control section 627 then judges whether a timer of the SW1 is turned off (step S213). When the camera system control section 627 determines that the timer of the SW1 is not turned off (step S213: No), the flow returns to the step S201. When the camera system control section 627 determines that the timer of the SW1 is turned off (step S213: Yes) or when the image capturing processing is performed, the transmission of the vibration waveform is stopped (step S214) and the series of the image capturing operation flow is ended. When the camera system control section 627 judges that the SW2 is turned on (step S211: Yes), the transmission of the vibration waveform can be stopped before the image capturing processing is performed.

As described above, the camera system control section 627 judges the defocused state of the object 411 while the sw1 is turned on, and vibrates the vibrators 531, 532 in coordination with each other according to the vibration waveforms that corresponds to the defocused state of the object 411. In other words, the camera system control section 627 continuously judges the state of the object 411, and continuously vibrates the vibratos 531, 532 according to the state of the object 411.

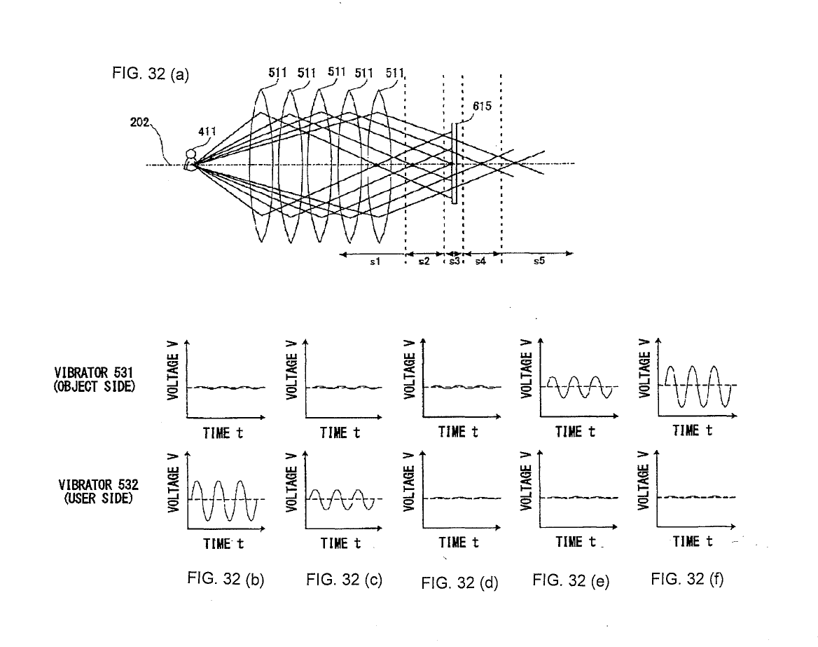

A first modification example in which a different vibration waveform is supplied to each vibrator will be now described. FIGS. 32(a)-32(f) are illustrative diagrams for explaining the vibration waveforms supplied to the vibrators 531 and 532. Because FIG. 32(a) is identical to FIG. 30(a), the explanation for FIG. 32(a) is omitted. Referring to FIG. 32(a), the camera system control section 627 defines the segments (s1, s2, s3, s4, s5) that correspond to the defocused states of the object 411 in advance.

FIGS. 32(b) to 32(f) illustrate vibration waveforms corresponding to the segments respectively. In each diagram, the vertical axis shows voltage V and the horizontal axis shows time “t”. In FIGS. 32(b) to 32(f), the upper charts show the vibration waveforms supplied to the vibrator 531 situated closer to the object side, and the lower charts show the vibration waveforms supplied to the vibrator 532 situated closer to the user side. More specifically, as shown in the upper charts of FIGS. 32(b) to 32(f), the camera system control section 627 sets the amplitude of the vibration waveform that is supplied to the vibrator 531 situated closer to the object side to be increased as the defocused state transitions as the segment s3->the segment s4->the segment s5. The difference from the example of FIGS. 30(a)-(f) is that when the defocused state is the front defocused state, the camera system control section 627 supplies the same vibration waveform as that of the in-focus state.

Whereas shown in the lower charts of FIGS. 32(b) to 32(f), the camera system control section 627 sets the amplitude of the vibration waveform that is supplied to the vibrator 532 to be increased as the defocused state transitions as the segment s3->the segment s2->the segment s1. The difference from the example of FIG. 30 is that when the defocused state is the rear defocused state, the camera system control section 627 supplies the same vibration waveform as that of the in-focus state. Referring to FIGS. 32(b) to 32(f), in this example, both the vibrators vibrate with the smallest amplitudes when the focus lens 511 is at the in-focus position, so there is an advantage that the camera system can be prevented from being shaken by the hand of the user due to the vibration of the vibrators. Alternatively, the camera system control section 627 may set the amplitude of the vibration waveform generated by the vibrators 531, 532 to zero when it judges that the focus lens 511 is at the in-focus position.

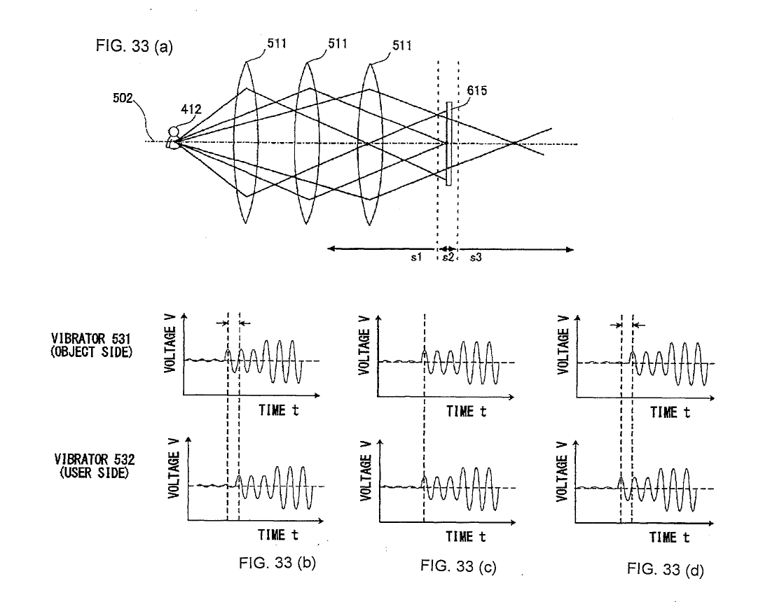

A second modification example in which the user is notified of the defocused state by supplying vibration waveforms that has different start timings to the vibrators will be now described. FIGS. 33(a)-(d) are illustrative diagrams for explaining the vibration waveforms supplied to the vibrators 531 and 532. FIG. 33(a) illustrates positional relationships between the image capturing element 615, the focus lens 511, and the optical axis 502 direction of an object 412, in particular, illustrates segments (s1, s2, s3) that correspond to the defocused states of the object 412. Referring to FIG. 33(a), the camera system control section 627 defines the segments that correspond to the defocused states of the object 412 in advance. Here, the camera system control section 627 sets the range of in-focus state to the segment s2. Moreover, the camera system control section 627 sets the front defocused state to the segment s1 and the rear defocused state to the segment s3.

FIGS. 33(b) to 33(d) illustrate vibration waveforms corresponding to the segments respectively. In each diagram, the vertical axis shows voltage V and the horizontal axis shows time “t”. In FIGS. 33(b) to 33(d), the upper charts show the vibration waveforms supplied to the vibrator 531 situated closer to the object side, and the lower charts show the vibration waveforms supplied to the vibrator 532 situated closer to the user side. The camera system control section 627 starts supplying a common vibration waveform to the vibrators 531 and 532 at different timings. The amplitude of the common vibration waveform increases over time.

More specifically, referring to FIG. 33(b), when the camera system control section 627 judges that the defocused state corresponds to the segment s1, the vibration waveform shown in the upper chart of FIG. 33(b) is supplied to the vibrator 531 situated closer to the object side, and the vibration waveform shown in the lower chart of FIG. 33(b) is supplied to the vibrator 532 situated closer to the user side. As indicated by the dotted line of FIG. 33(b), the vibration waveform of the upper chart of FIG. 33(b) rises prior to the vibration waveform of the lower chart of FIG. 33(b). Thus, the user who recognizes such vibration feels that the vibration moves from the object 412 side to the user side. In this way, the user can know that the user should step away from the object 412.

Referring to FIG. 33(d), when the camera system control section 627 judges that the defocused state corresponds to the segment s3, the vibration waveform shown in the upper chart of FIG. 33(b) is supplied to the vibrator 531 situated closer to the object side, and the vibration waveform shown in the lower chart of FIG. 33(d) is supplied to the vibrator 532 situated closer to the user side. As indicated by the dotted line of FIG. 33(d), the vibration waveform of the lower chart of FIG. 33(d) rises prior to the vibration waveform of the upper chart of FIG. 33(d). Thus, the user who recognizes such vibration feels that the vibration moves from the user side to the object 412 side. In this way, the user can know that the user should step forward to the object 412.

Referring to FIG. 33(c), when the camera system control section 627 judges that the position of the object 412 corresponds to the segment s2, the vibration waveform shown in the upper chart of FIG. 33(c) is supplied to the vibrator 531 situated closer to the object side, and the vibration waveform shown in the lower chart of FIG. 33(c) is supplied to the vibrator 532 situated closer to the user side. The begging of the vibration waveform of the upper chart of FIG. 33(c) occurs at the same timing as the vibration waveform of the lower chart of FIG. 33(c). Thus, the user who recognizes such vibration can know that this is the image capturing timing. The camera system control section 627 may differ the start timing of the vibration by shifting a phase of the vibration waveform supplied to the vibrators 531, 532 respectively.

A third modification example in which the frequency of the vibration waveform is changed according to the defocused state of the object instead of the amplitude of the vibration waveform will be now described. In the third modification example, the camera system control section 627 changes the frequency of the vibration waveform depending on the defocused state of the object to notify a user of the image capturing timing.

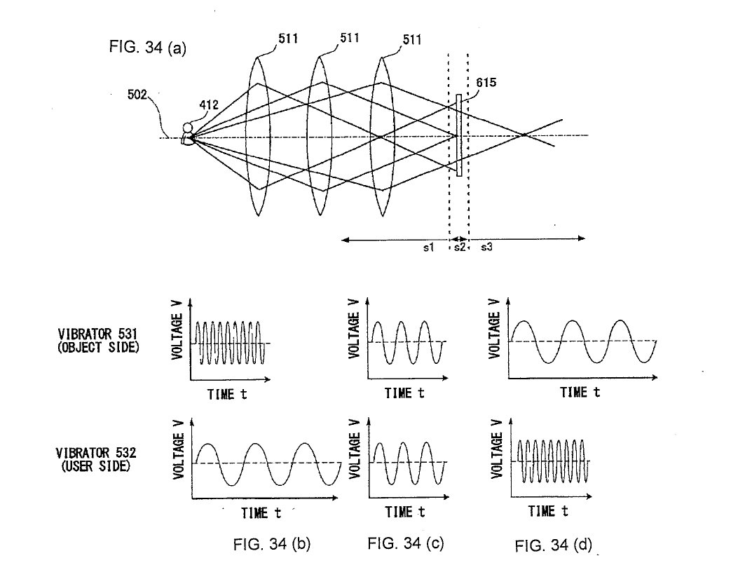

FIGS. 34(a)-34(d) are illustrative diagrams for explaining the vibration waveforms supplied to the vibrators 531, 532. Because FIG. 34(a) is identical to FIG. 18(a), the explanation for FIG. 33(a) is omitted. Referring to FIG. 34(a), the camera system control section 627 defines the segments (s1, s2, s3) that correspond to the positions of the object 412 respectively in advance.

FIGS. 34(b) to 34(d) illustrate vibration waveforms corresponding to the segments respectively. In each diagram, the vertical axis shows voltage V and the horizontal axis shows time “t”. In FIGS. 34(b) to 34(d), the upper charts show the vibration waveforms supplied to the vibrator 531 situated closer to the object side, and the lower charts show the vibration waveforms supplied to the vibrator 532 situated closer to the user side. The camera system control section 627 specifies the vibration waveforms that correspond to the segments respectively. More specifically, as shown in the upper charts of FIGS. 34(b) to 34(d), the camera system control section 627 sets the frequency of the vibration waveform that is supplied to the vibrator 531 situated closer to the object side to be decreased as the defocused state transitions from the segment s1 to the segment s3.

Whereas shown in the upper charts of FIGS. 34(b) to 34(f), the camera system control section 627 sets the frequency of the vibration waveform that is supplied to the vibrator 532 situated closer to the user side to be increased as the defocused state transitions from the segment s1 to the segment s3. Thus, the user is able to know sensuously the defocused direction by recognizing which vibrator vibrates with a higher frequency.

When the camera system control section 627 judges that the defocused state of the object 412 corresponds to the segment s2, sets the frequency of the vibration waveforms supplied to the vibrators 531 and 532 to an identical value. In this manner, the user can know that the apparatus is in the in-focus state.

A fourth modification example in which the vibrators 531, 532 are vibrated in coordination with each other depending on the size of an object in the image displayed in live-view instead of the output of the focus detection sensor 622. In the fourth modification example, the camera system control section 627 vibrates the vibrations 531, 532 according to the size of a specific object in the image displayed in live-view. In this case, the camera system control section 627 stores object images for pattern matching in the camera memory 641 responsive to the user operation. The camera system control section 627 sets, for example, a predetermined object specified by a user as the specific object. The object can be not only human but also an animal. The image processing section 626 recognizes the specific object by performing pattern matching that uses a person recognition feature, a face recognition feature or the like onto the live-view image.

The camera system control section 627 determines the size of the specific object that is recognized by the image processing section 626. The camera system control section 627 changes the vibration waveform supplied to the vibrators 531, 532 in conjunction with each other depending on the size of the specific object. In this manner, the camera system control section 627 notifies the user of the size of the object in the image. More specifically, the camera system control section 627 judges whether the coordinate points of each vertex of the rectangle in which the object is inscribed are situated at the edge of the live-view image. When all the coordinate points of each vertex of the rectangle are situated at the edges of the live-view image, the camera system control section 627 judges that the size of the specific object is too large. This is because, in such case, the object likely runs off the edge of the image.

When any of the coordinate points of each vertex is not situated at the edge of the image, the camera system control section 627 calculates the area of the rectangle in which the object in the image is inscribed, and compares the value of the area with a predetermined threshold value. When the calculated value of the area is equal to or larger than the predetermined threshold value, the camera system control section 627 judges that the size of the object is appropriate. In other words, the camera system control section 627 judges that this is the image capturing timing. Whereas the calculated value of the area is less than the predetermined threshold value, the camera system control section 627 judges that the size of the object is too small.

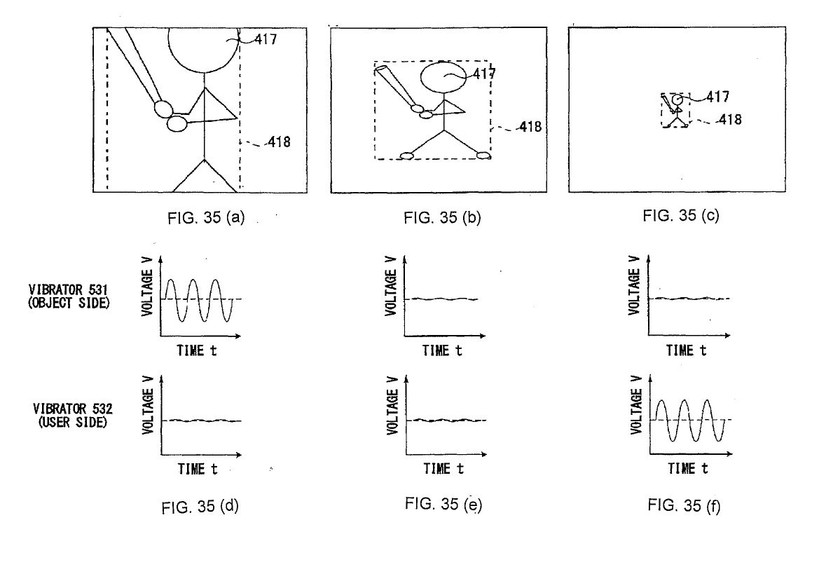

FIGS. 35(a)-35(f) are conceptual diagrams showing relationships between the size of an object 417 in a live-view image and the vibration waveform. FIGS. 35(a) to 35(c) illustrate the cases where the size of the object 417 is too large, appropriate, and too small, respectively. The camera system control section 627 defines the segments that correspond to the size of the object 417 in advance. Here, the camera system control section 627 defines a case where all the coordinate points of each vertex of a rectangle 418 that encloses the object 417 are situated at the edges of the image as a segment s1. The camera system control section 627 defines a case where the area of the rectangle 418 in which the object 417 is inscribed is equal to or larger than a predetermined threshold value as a segment s2. The camera system control section 627 further defines a case where the area of the rectangle 418 in which the object 417 is inscribed is less than the predetermined threshold value as a segment s3

FIGS. 35(d) to 35(f) illustrate vibration waveforms corresponding to the segments respectively. The vibration waveform of the upper chart shown in FIG. 35 (e) is identical to that of the upper chart shown in FIG. 35(f). In the same manner, the vibration waveform of the lower chart shown in FIG. 35 (d) is identical to that of the lower chart shown in FIG. 35(e). In each diagram, the vertical axis shows voltage V and the horizontal axis shows time “t”. In FIGS. 35(d) to 35(f), the upper charts show the vibration waveforms supplied to the vibrator 531 situated closer to the object side, and the lower charts show the vibration waveforms supplied to the vibrator 532 situated closer to the user side. The camera system control section 627 sets in advance the vibration waveforms that correspond to the segments respectively as described above.

More specifically, the camera system control section 627 sets a vibration waveform supplied to the vibrator 531 situated to closer the object side in the case of the segment s1 such that the it has a larger amplitude than those of the vibration waveforms supplied in the cases of other segments. Whereas in the case of the segment s3, the camera system control section 627 sets a vibration waveform supplied to the vibrator 532 situated closer to the user side such that it a larger amplitude than those of the vibration waveforms supplied in the cases of other segments.

When the camera system control section 627 judges that the size of the object 417 corresponds to the segment s2, the vibration waveforms illustrated in FIG. 35(e) are supplied to the vibrators 531, 532 respectively. The amplitudes of the vibration waveforms supplied to the vibrators 531, 532 are both small, and the user who recognizes such vibration can know that the size of the object is appropriate, in other words, this is the image capturing timing. Moreover, the camera system control section 627 supplies the vibration waveform that has the smallest amplitude at the image capturing timing so that the camera will not be shaken by the hand of the user during image capturing action due to the vibration.

When the camera system control section 627 judges that the size of the object 417 corresponds to the segment s1, the vibration waveforms illustrated in FIG. 35(d) are supplied to the vibrators 531, 532 respectively. When the camera system control section 627 judges that the size of the object 417 corresponds to the segment s3, the vibration waveforms illustrated in FIG. 35(f) are supplied to the vibrators 531, 532 respectively. In these cases, only one of the vibrators 531, 532 vibrates strongly so that the user who recognizes such vibration can know that the size of the object 417 is too large or small.

A fifth modification example in which the camera system control section 627 vibrates the vibrators 531, 532 in coordination with each other according to a displacement of an object in an image displayed in live-view. In the fifth modification example, the camera system control section 627 calculates the area of a specific object in the image displayed in live-view as a first area. After a predetermined time has elapsed, the camera system control section 627 calculates the area of the specific object as a second area, and then compares the second area to the first area.

When a difference between the first area and the second area falls within a certain range, the camera system control section 627 judges that the object is not displaced (transferred). Whereas when the difference between the first area and the second area does not fall within the certain range and the second area is larger than the first area, the camera system control section 627 judges that the object is displaced closer to the user side. When the second area is smaller than the first area, the camera system control section 627 judges that the object is displaced further from the user side.

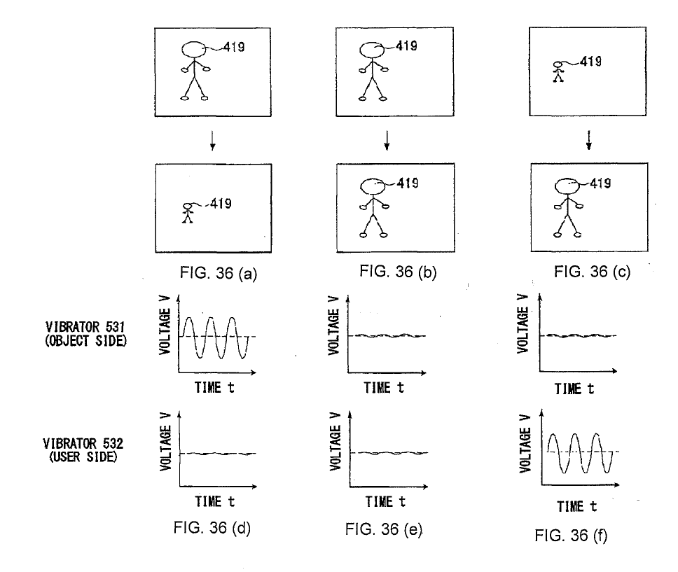

FIGS. 36(a)-36(f) are illustrative diagrams for explaining the vibration waveforms supplied to the vibrators 531, 532. FIGS. 36(a) to 36(c) illustrate states of the object 419. The camera system control section 627 defines the segments that correspond to the displacement states of the object 419 in advance. Referring to FIG. 36(a), the camera system control section 627 sets the state of the object 419 where the object is displaced further from the user as a segment s1. Referring to FIG. 36(b), the camera system control section 627 sets the state of the object 419 where the object is not displaced as a segment s2. Referring to FIG. 36(b), the camera system control section 627 sets the state of the object 419 where the object is displaced closer to the user as a segment s3.

FIGS. 36(d) to 36(f) illustrate vibration waveforms corresponding to the segments respectively. Because FIGS. 36(d) to 36(f) are identical to FIGS. 35(d) to 35(f), the explanation for FIGS. 36(d) to 36(f) are omitted. The camera system control section 627 sets in advance the vibration waveforms that correspond to the segments respectively.

When the camera system control section 627 judges that the displacement of the object 419 corresponds to the segment s2, the vibration waveforms illustrated in FIG. 36(e) are supplied to the vibrators 531, 532 respectively. The amplitudes of the vibration waveforms supplied to the vibrators 531, 532 are both small, and the user who recognizes such vibration can know that there is no displacement of the object, in other words, this is the image capturing timing. Moreover, the camera system control section 627 supplies the vibration waveform that has the smallest amplitude at the image capturing timing so that the camera will not be shaken by the hand of the user during image capturing action due to the vibration.

When the camera system control section 627 judges that the displacement of the object 419 corresponds to the segment s1, the vibration waveforms illustrated in FIG. 36(d) are supplied to the vibrators 531, 532 respectively. When the camera system control section 627 judges that the displacement of the object 419 corresponds to the segment s3, the vibration waveforms illustrated in FIG. 36(f) are supplied to the vibrators 531, 532 respectively. In these cases, only one of the vibrators 531, 532 vibrates strongly so that the user who recognizes such vibration can know whether the object 419 is displaced closer to or further from the user.

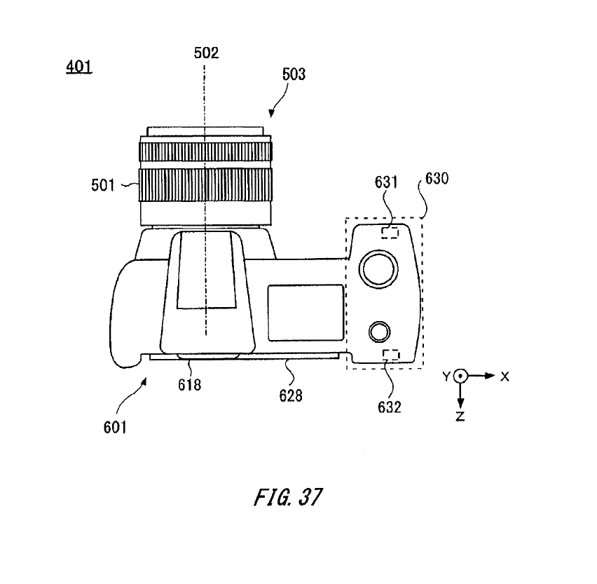

A sixth modification example in which two vibrators are provided will be now described. In the sixth modification example, the camera system control section 627 judges the defocused state of the object. FIG. 37 is a birds-eye view of a camera system 401. Here, two vibrators 631, 632 are disposed on a grip section 630 of a camera unit 601 along the z axis direction with a prescribed distance therebetween. Thus, when a user holds the lens unit 503 with the left hand and performs a manual focusing operation, the user can know the defocused state of the object with the right hand through vibration without looking the finder window 618 or the display section 628, and the user can adjust the focus ring 501 while the user knows the defocused state of the object.

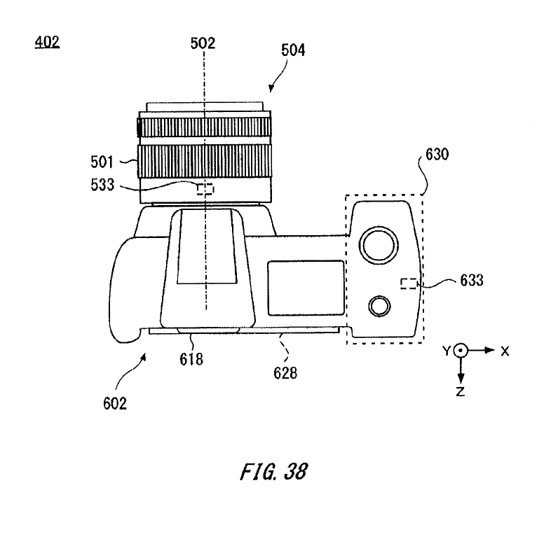

A seventh modification example in which one of two vibrators is provided in the lens unit and the other is provided in the camera unit will be now described. In the seventh modification example, the camera system control section 627 judges the defocused state of the object. FIG. 38 is a birds-eye view of a camera system 402. Here, a vibrator 533 is disposed in the lens unit 504 and a vibrator 633 is disposed in a grip section 630 of a camera unit 602 along the z axis direction with a prescribed distance therebetween. The vibrator 533 is disposed at lower position of the lens unit 504 in the vertical direction. Thus, when a user holds the lens unit 504 with the left hand and performs a manual focusing operation, the user can know the defocused state of the object with the both hands through vibration without looking the finder window 618 or the display section 628, and the user can adjust the focus ring 501 while the user knows the defocused state of the object.

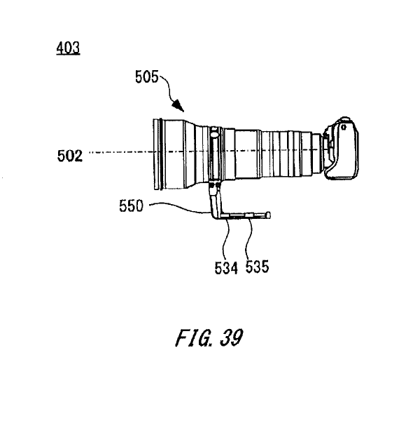

Moreover, when the lens unit has a tripod mount section, the vibrators can be provided at the tripod mount section. In this case, the camera system judges the size of the object. FIG. 39 is a schematic side view of a camera system 403. The lens unit 505 has a tripod mount 550, and the vibrators 534, 535 are disposed inside the tripod mount 550 along the optical axis 502 with a prescribed distance therebetween. Thus, when a user holds the tripod mount 550 with the left hand and performs an image capturing operation, the user can know the size of the object with the left hand through vibration without looking the finder window 618 or the display section 628, and the user can perform image capturing while the user knows the size of the object. Alternatively, the camera system 403 may judges the displacement of the object. Although the camera system control section 627 judges a depth state of the object with reference to at least a portion of the object image and the vibrators 531, 532 are vibrated in conjunction with each other responsive to the judgment, the lens system control section 522 may be equipped with such functionality.

Although a piezoelectric element is used as the vibrator in the above description, a voice coil motor can also be used as the vibrator. When the voice coil motor can also be used as the vibrator, the voice coil motor is provided inside the case of the lens unit or the camera unit through a membrane to form a vibration unit. When a sinusoidal waveform is used as the vibration waveform, a vibration motor which is typically used for a mobile phone can be used. Even when other elements than the piezoelectric element are used as the vibrators, the camera system control section 627 can notify the user of the defocused state by supplying a driving voltage to the element such that a physical displacement of the element becomes smallest at the image capturing timing. Regarding to the size and displacement of the object, the camera system control section 627 can notify the user of the object state by adequately adjusting the driving voltage.

Although the camera system control section 627 judges the segment that corresponds to the defocus amount and supplies, to the vibrator, the vibration waveform that corresponds to the segment in the above description, alternatively, the control section can supply directly a vibration waveform that has the amplitude proportional to the defocus amount. In this case, the vibration waveform is represented by a function that uses the defocus amount as input. When the image capturing mode is set to the motion image capturing mode, the camera system control section 627 may reduce the amplitude of the vibration waveform compared to that of the still image capturing mode, or may stop supplying the vibration waveform to the vibrator. In this manner, it is possible to prevent sound made by the vibration of the vibrator from being recorded when the motion image capturing is performed.

### Fourth Embodiment

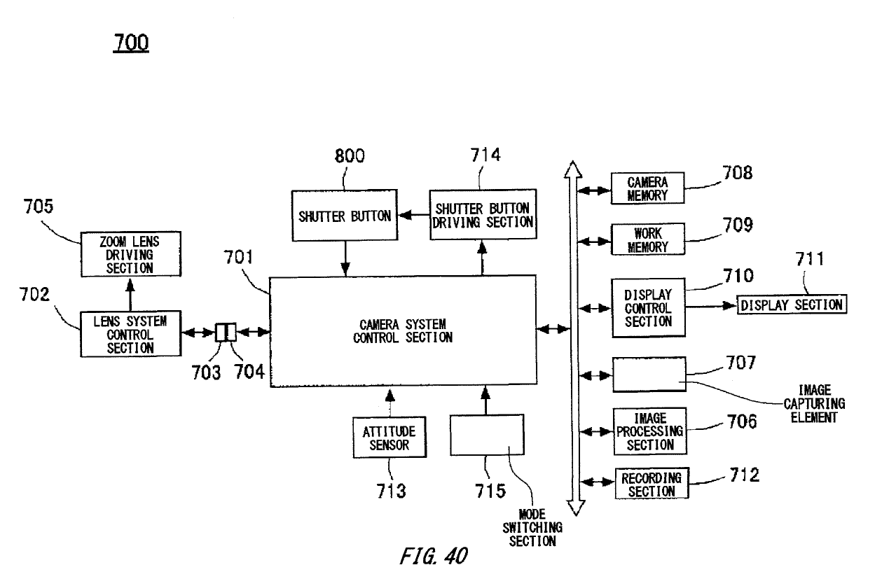

FIG. 40 illustrates a system configuration of a digital camera 700 according to a fourth embodiment. The digital camera 700 includes a camera system control section 701 that directly or indirectly controls the digital camera 700, and a lens system control section 702 that controls an optical system including a zoom lens and the like. The digital camera 700 includes a camera control system centered on the camera system control section 701, and a lens control system centered on the lens system control section 702. The lens control system and the camera control system exchange various data and control signals to each other via a connecting section that is connected to a lens mount 703 and ae camera mount 704. The lens system control section 702 receives an instruction by the camera system control section 701, and transmits a zoom lens control signal to a zoom lens driving section 705. The zoom lens driving section 705 drives the zoom lens in accordance with the zoom lens control signal received from the lens system control section 702.

An image processing section 706 included in the camera control system follows an instruction by the camera system control section 701 to process the captured image signal that has been photoelectrically converted by an image capturing element 707 which is the image capturing section, and to covert the signal into image data that has a predetermined image format. More specifically, when a JPEG file is created as a still image, the image processing section 706 performs image processing such as a color conversion processing, a gamma processing, and a white balance processing and the performs compression such as adaptive discrete cosine transformation. When a MPEG file is created as a motion image, the image processing section 706 performs compression by performing intra-frame coding and inter-frame coding on frame images which is a sequence of still images whose number of pixels is reduced to a prescribed number.

Camera memory 708 is, for example, non-volatile memory such as flash memory that stores programs to control the digital camera 700 and various parameters. Work memory 709 is, for example, fast access memory such as RAM that temporally stores image data which is under processing. The image data processed by the image processing section 706 is recorded in a recording section 712 from the work memory 709. The recording section 712 is non-volatile memory such as flash memory that is detachable to the digital camera 700. The image processing section 706 creates image data for display concurrently with the image data that is processed for recording. The image data for display is generated by copying the image data for recording and thinning out the copy to include fewer pixels.

A display control section 710 displays a screen image on a display section 711 in accordance with the instruction by the camera system control section 701. The image data for display generated by the image processing section 706 is displayed on the display section 711 in accordance with the control by the display control section 710. The display control section 710 generates image data for successive display and displays a live-view image of the display section 711.

The digital camera 700 has an attitude sensor 713 that detects the attitude of the digital camera 700. The attitude sensor 713 is, for example, an acceleration sensor that has three axes which are orthogonal to each other, and that can detect the attitude of the digital camera 700. The attitude sensor 713 can also serve as a gravitational acceleration sensor that accurately detects a direction of gravitational force. In this case, the camera system control section 701 determines the direction of gravitational force responsive to a signal output by the attitude sensor 713 by changing a sampling frequency or sensitivity which is used for analyzing the signal output by the attitude sensor 713.

A mode switching section 715 receives mode setting information from the user such as an image capturing mode, and outputs it to the camera system control section 701. The image capturing mode according to this embodiment includes a no-look image capturing mode. Here, the no-look image capturing mode means an image capturing mode which supports the user who performs image capturing of the object without looking at an optical finder image or a live-view image displayed on the display section 711. The image capturing action in such no-look image capturing mode will be hereunder described.

A shutter button 800 has two switch positions along the direction toward which the shutter button is pressed down, and the user can instruct the image capturing action by using this shutter button. When the user pressed the shutter button 800 down to a first position, the camera system control section 701 performs focus adjustment and photometry as an image capturing preparation action. When the user pressed the shutter button 800 down to a second position, the camera system control section 701 performs an image capturing action.

The shutter button 800 according to this embodiment has a feature which allows the user to know a change of the rotational direction of the digital camera 700 through perception of the user. Information concerning the change of the rotational direction of the digital camera is necessary for the image capturing element 707 to appropriately capture the object image when the image is captured in the above-mentioned no-look image capturing mode. More specifically, the shutter button 800 has a tactile sense generating section that generates tactile sense for the user who touches the shutter button 800. A shutter button driving section 714 drives the tactile sense generating section disposed on the shutter button 800 in accordance with the instruction by the camera system control section 701.

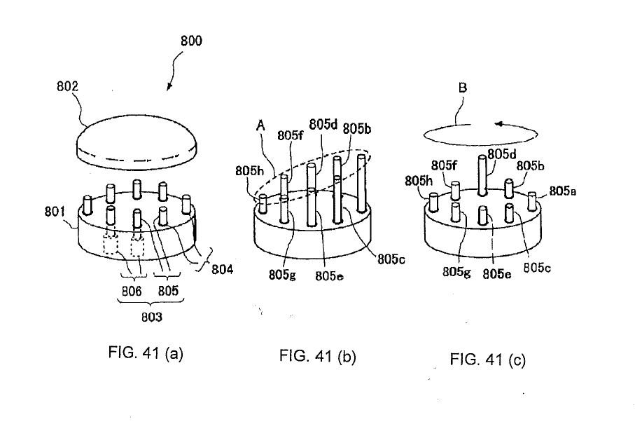

FIGS. 41(a)-41(c) are explanatory drawings for the shutter button 800 according to the embodiment. FIG. 41(a) is an exploded perspective view of the shutter button 800. The shutter button 800 includes a base portion 801 that is going to be attached to the main body of the digital camera 700, a cover 802 attached from the above the base portion 801, and a tactile sense generating section 803. The base portion 801 is a hollow member that has a cylindrical shape, and a plurality of through-holes 804 are formed in the upper face of the base portion 801. In this embodiment, eight through-holes 804 are arranged on the upper face of the base portion 801 in a circumferential direction at a substantially same interval.

The tactile sense generating section 803 tactile sense poles 805 that each goes through the corresponding through-hole 804, and tactile sense pole driving sections 806 that each drives the corresponding tactile sense pole 805 in the vertical direction and that is stored in the base portion 801. The tactile sense pole driving section 806 includes, for example, solenoid that drives the corresponding tactile sense pole 805 in the vertical direction responsive to the instruction by the shutter button driving section 714. The cover 802 is formed of, for example, a flexible material such as a rubber sheet, and it is attached in contact with the tactile sense pole 805 from up the base section 801.

FIG. 41(b) illustrates the state where the tactile sense poles 805 are arranged such that the user can detect the tilt direction through the tactile sense generating section 803. Referring to FIG. 41(b), the tactile sense pole driving section 806 drives a tactile sense pole 805a that is situated at the right edge of the drawing page to the highest position among the tactile sense poles. Tactile sense poles 805b, 805c that are arranged adjacent to the tactile sense pole 805a on the left side of the drawing page are driven to a lower position than the tactile sense pole 805a. In the same manner, the tactile sense pole driving sections 806 drive tactile sense poles 805d, 805e to a lower position than the tactile sense poles 805b, 805c, and drive tactile sense poles 805f, 805g to lower position than the tactile sense poles 805d, 805e. The tactile sense pole driving section 806 drives a tactile sense pole 805h that is situated at the left edge of the drawing page to the lowest position among the tactile sense poles.

When the tactile sense pole driving sections 806 drive the tactile sense poles 805 as illustrated by FIG. 41(b), the cover 802 that covers the upper ends of the tactile sense poles 805 is tilted and deforms from the right to the left as illustrated as a virtual plane A of FIG. 41(b). In this way, the user can perceive the tilt direction formed by the tactile sense poles 805 through tactile sense. Tilts in various directions can be created by changing the driving amount of each tactile sense pole 805 by the corresponding tactile sense pole driving section 806.

FIG. 41(c) illustrates the state where the tactile sense pole driving sections 806 drive the tactile sense poles 805 such that the user can know change in the state which relates to the rotational direction. In the state of FIG. 41(c), the tactile sense pole driving section 806 drives the tactile sense pole 805d to the highest position among the tactile sense poles 805. For example, the tactile sense pole driving section 806 subsequently drives the tactile sense pole 805d to be lowered to the position same as the other tactile sense pole 805, and the tactile sense pole 805f may be driven to the highest position among the tactile sense poles 805. In the same manner, the tactile sense pole driving section 806 sequentially drives the tactile sense pole 805f, 805h, 805g, 805e, 805c, 805a, and 805b to the highest position among the tactile sense poles 805 in the sated order. Through this sequence of the tactile sense pole's movement, the user feels the rotational movement in the counterclockwise fashion when viewed from above the drawing page, as indicated by the arrow B of FIG. 41(b).

In the same manner, the tactile sense generating section 803 can generate for the user a rotational movement in the clockwise fashion when viewed from above the drawing page, which is the opposite direction to the direction indicated by the arrow B. In this case, the tactile sense pole driving section 806 sequentially drives the tactile sense pole 805d, 805b, 805a, 805c, 805e, 805g, 805h, and 805f to the highest position among the tactile sense poles 805 in the sated order. The tactile sense pole driving section 806 may vibrates the tactile sense poles 805 in the stated order so that the user can know change in the state which relates to the rotational direction.

The tactile sense generating section 803 can further notify the user of information of two directions at the same time through perception by combining the tilt illustrated in FIG. 41(b) and the rotation illustrated in FIG. 41(c). More specifically, in the arrangement of the tactile sense poles 805 shown in FIG. 41(b), the tactile sense pole 805 that protrudes upper direction from the virtual plane A of FIG. 41(b) can be sequentially changed as illustrated in FIG. 41(c). In this way, the tactile sense generating section 803 can allow the user to sense the two directional information at the same time, which are the tilt direction and the rotational direction.

When an image capturing preparation action or an image capturing instruction is performed on the digital camera 700, the user presses down the cover 802. The shutter button 800 detects the downward force applied to the base portion 801 through the cover 802. For example, the base portion 801 is disposed on the body of the digital camera 700 such that it can be displaced downward in two stages responsive to the force which the user generates to press down the cover. The shutter button 800 receives the two-stage switch operation by the user by detecting the displacement of the base portion 801.

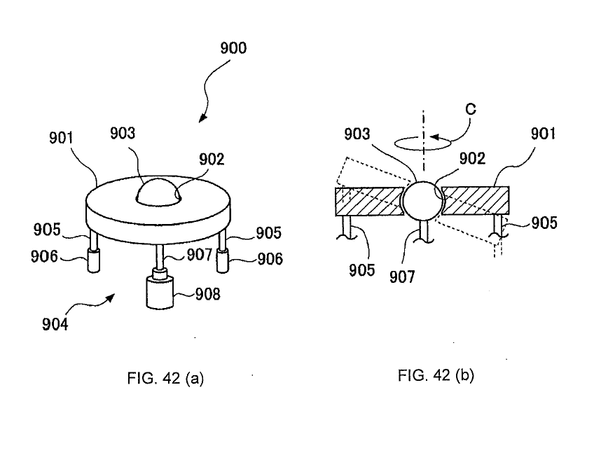

FIGS. 42(a)-42(b) are drawings for explaining another example of a shutter button 900 according to the embodiment. FIG. 42(a) is a perspective view of the shutter button 900. The shutter button 900 includes a ring section 901 that has an annular shape, a spherical section 903 that is placed inside a central hole 902 of the ring section 901, and a tactile sense generating section 904 that drives the ring section 901 and the spherical section 903. A plurality of driving poles 905 that pivotally support the lower surface of the ring section 901 are provided. The lower end of each driving pole 905 is coupled to a ring section driving section 906 that includes, for example, solenoid, like the above-described tactile sense pole driving section 806. The spherical section 903 includes a driving pole 907 that extends downward. The lower end of the driving pole 907 is connected to a spherical section driving section 908. The spherical section driving section 908 includes, for example, a motor. Alternatively, the tactile sense generating section includes the ring section driving section 906 and the spherical section driving section 908.

FIG. 42(b) is a sectional view of a shutter button 900. An inner wall of the central hole 902 is formed such that it is conformal with the periphery of the spherical section 903 that is disposed inside the central hole 902. There is a gap between the periphery of the spherical section 903 and the inner wall of the central hole 902, and the spherical section 903 and the ring section 901 can move relative to each other.

In the same manner as the shutter button 800, the shutter button 900 allows the user to sense the two directional information at the same time, which are the tilt direction and the rotational direction. More specifically, the ring section driving section 906 drives the corresponding driving pole 905 in the vertical direction responsive to the instruction by the shutter button driving section 714. For example, the ring section driving section tilts the ring section 901 from the left to the right as indicated by the dotted line of FIG. 42(b) by moving the driving pole 905 that is disposed on the left side of the drawing page to upward and moving the driving pole 905 that is disposed on the right side of the drawing page to downward. The ring section driving section can tilt the ring section 901 in various directions other than the tilt direction of FIG. 42(b) by adequately displacing the driving poles 905.

The spherical section driving section rotates the driving poles 905 about the vertical axis in accordance with the instruction by the shutter button driving section 714. When the driving poles 905 are rotationally driven, the spherical section 903 rotates about the vertical axis as indicated by the arrow C of FIG. 42(b). The spherical section driving section rotates the spherical section 903 about the vertical axis in the clockwise or counterclockwise when viewed from the above the drawing page. When a user operates the shutter button 900, the user touches both the ring section 901 and the spherical section 903. Thus the user can perceive information about the two directions through the tilt direction of the ring section 901 and the rotational direction of the spherical section 903. The ring section driving section may rotate the ring section 901 in order to let the user sense the rotational direction through perception.

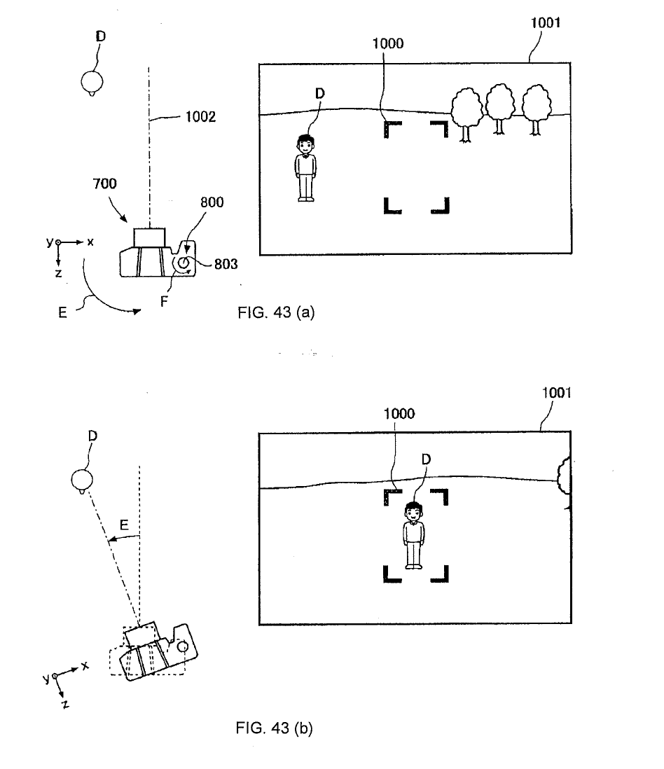

The image capturing operation in the no-look image capturing mode of the digital camera 700 will be hereunder described in detail. FIGS. 43(a)-43(b) are conceptual diagrams for explaining a first example of the image capturing operation in the no-look image capturing mode according to the fourth embodiment. FIG. 43(a) illustrates an initial state of image capturing of an object, the left drawing of FIG. 43(a) schematically shows a positional relation between the digital camera 700 and an object D, and the right drawing of FIG. 43(a) shows image data of an image capturing target space output by the image capturing element 707. As shown in the drawing, an optical axis direction from the objects side toward the back side of the camera is defined as a +z axis direction, a right side with respect to a long side of the image capturing element 707 when viewed from the back side of the camera is defined as +x axis direction, and an upper side with respect to a short side of the image capturing element 707 is defined as +y axis direction.

When the user sets the image capturing mode of the digital camera 700 to the no-look image capturing mode, the mode switching section 715 receives the mode setting including the image capturing mode and the like from the user and then outputs it to the camera system control section 701. The camera system control section 701 starts the live-view operation and transmits an instruction to the image capturing element 707 to obtain an image of the object. The image processing section 706 then generates the image data.

In the first example, the user sets an area where the user wishes to include the object with respect to the angle of view in the image capturing target space as an object region 1000. Setting information about the object region 1000 is recorded in the camera memory 708. The camera system control section 701 reads out the setting information about the object region 1000 from the camera memory 708 in the no-look image capturing mode according to the first example, and sets the object region 1000 for the image data of the image capturing target space output by the image capturing element 707. For example, in the case of FIG. 43, the object region 1000 is set in the central area of an image 1001 of the image capturing target space. Setting of the object region 1000 is recorded in the camera memory 708.

In the state shown in FIG. 43(a), the object D is situated at −x axis direction with respect to an optical axis 1002 of the digital camera 700. Thus, the object D is situated on the −x axis direction side of the object region 1000 that the user sets in the image 1001 output by the image capturing element 707. Such configuration does not serve the user's intention. In such case, the user needs to rotate the image capturing element 707 or the digital camera 700 in the direction indicated by the arrow E which is the counterclockwise direction with respect to the +y direction in order to include the object D within the object region 1000 to capture the image of the object.

Therefore, in the no-look image capturing mode according to the first example, the camera system control section 701 recognizes the object D from the image 1001 output by the image capturing element 707 using a body recognition technique that utilizes, for example, a face recognition feature, and detects a position of the object D in the image 1001. In this sense, the camera system control section 701 according to the first example serves as a detecting section that detects a positional relative relation between the image capturing target space and the image capturing element 707. The camera system control section 701 subsequently specifies a recommended direction to rotate the digital camera 700 depending on the position of the object D in the image capturing target space and the object region 1000 that is set in advance. In the case of the example of FIG. 43(a), the camera system control section 701 specifies the direction E as the recommended direction. The camera system control section 701 then drives the tactile sense poles 805 of the shutter button 800 via the shutter button driving section 714 such that the user perceives change of the state that corresponds to the rotational direction identical to the recommended direction. In this manner, the camera system control section 701 cooperates with the shutter button driving section 714 and serves as a driving control section that drives the tactile sense poles 805 such that the user perceives the change of the state that corresponds to the rotational direction identical to the recommended direction.

The camera system control section 701 sends an instruction to the shutter button driving section 714 to drive the tactile sense generating section 803 of the shutter button 800. By the operation described above with reference to FIG. 41(c), the tactile sense generating section 803 drives and rotates the tactile sense poles 805 in the direction indicated by the arrow F which is the counterclockwise direction with respect to the +y axis direction such that the user is allowed to perceive the recommended direction. In this way, the user can know the rotational direction to rotate the digital camera 700 in order to include the object D within the object region 1000 without looking at the optical finder or the display section 711.

FIG. 43(b) illustrates a state where the object D is included within the object region 1000 in the image 1001 of the image capturing target space. The camera system control section 701 analyzes the image 1001 sequentially output by the image capturing element 707, and when the camera system control section 701 judges that the object image D falls within the object region 1000 by rotating the digital camera 700 in the direction indicated by the arrow E, it stops to drive the tactile sense generating section 803. Through such operation, the user perceives that the object D falls within the object region 1000. According to the first example, the user can place the object D within the object region 1000 without looking at the optical finder or the display section 711, and capture the image of the object D.

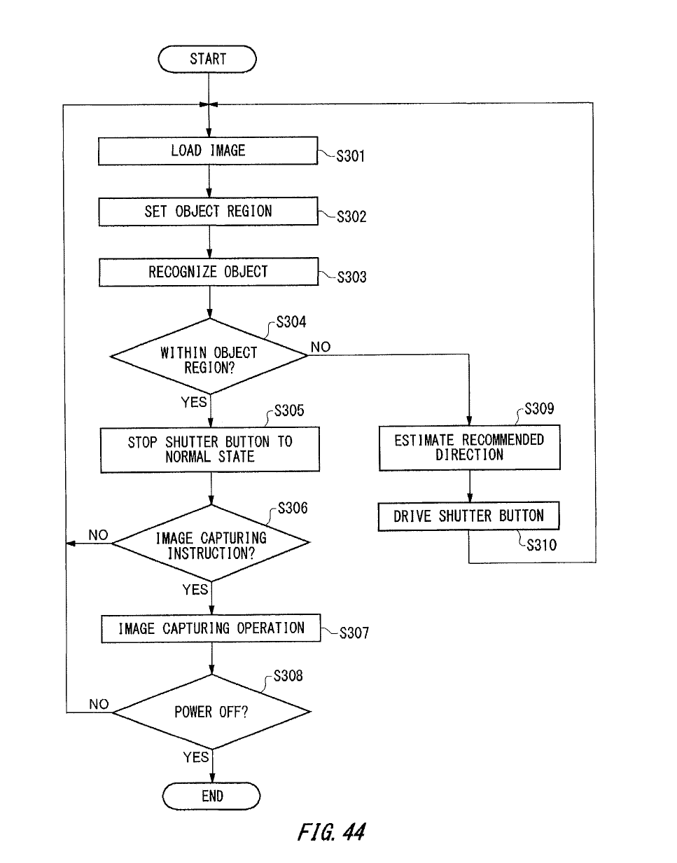

FIG. 44 is a flow chart of the image capturing operation in the no-look image capturing mode according to the first example. When the user starts the above-described no-look image capturing mode, the camera system control section 701 starts the operational flow shown in FIG. 44. In a step S301, the camera system control section 701 loads an image of the image capturing target space. In a step S302, the camera system control section 701 set the object region 1000 for the image 1001 of the image capturing target space. More specifically, as described with reference to FIG. 4, the camera system control section 701 reads out the setting information about the object region 1000 which is set in advance by the user from the camera memory 708, and sets the object region 1000 for the image 1001 output by the image capturing element 707.

In the no-look image capturing mode according to the first example, the image 1001 loaded in the step S301 can be displayed on the display section 711 as a live-view image, or the live-view image may not be displayed. Because, in the no-look image capturing mode, the user is able to perform image capturing of the object with a desired composition without looking at the live-view image. When the live-view image is not displayed on the display section 711 in the no-look image capturing mode, it is possible to save power.

In a step S303, the camera system control section 701 recognizes the object D. For example, the camera system control section 701 analyzes the image 1001 and performs a face recognition process onto the object D to detect a position of the object D in the image 1001. In such case, the camera system control section 701 may estimate a body region of the object D that includes a torso, hands and legs from the position of the face of the object D that is obtained through the face recognition process.

In a step S304, the camera system control section 701 judges whether the object D is within the object region 1000. More specifically, the camera system control section 701 compares the position of the object D in the image 1001 that is detected in the step S103 to the object region 1000, and judges whether the object D is within the object region 1000 or not. When the camera system control section 701 judges that the object D is within the object region 1000, the flow goes to a step S305. When the camera system control section 701 judges that the object D is not within the object region 1000, the flow goes to a step S309.

When the judgment result is NO in the step S304, the camera system control section 701 estimates the recommended direction to rotate the digital camera 700 in a step S309 as described above with reference to FIG. 4. In a step S310, the camera system control section 701 drives the tactile sense generating section 803 of the shutter button 800. More specifically, the camera system control section 701 sends an instruction to the shutter button driving section 714 to drive and rotate the tactile sense poles 805 in order to allow the user to perceive the recommended direction. The camera system control section 701 returns to the step S301 in the flow chart.

When the judging result is YES in the step S304, the camera system control section 701 causes the shutter button 800 to stop and be back to the normal state in the step S305. In the case of the embodiment of FIG. 41, the camera system control section 701 transmits an instruction to the shutter button driving section 714 to cause the tactile sense poles 805 of the tactile sense generating section 803 to be back to the normal arrangement and to stop driving of the tactile sense poles 805.

In a step S306, the camera system control section 701 judges whether there is an image capturing instruction from a user. When the camera system control section 701 judges that there is the image capturing instruction from the user, goes to a step S307. When the camera system control section 701 judges that there is no image capturing instruction from the user, goes back to the step S301.

In the step S307, the camera system control section 701 conducts the image capturing operation. More specifically, When the user pressed the shutter button 800 down to a first position, the camera system control section performs focus adjustment and photometry as an image capturing preparation action. When the user pressed the shutter button 800 down to a second position, the camera system control section 701 performs an image capturing action of the object D and creates an image file as the image data. Note that the first example assumes that the user instructs image capturing after the shutter button 800 is stopped in the step S105. However, the first example is not limited to this, whenever the camera system control section 701 receives the image capturing instruction from the user, it preferentially conducts the image capturing operation even when the shutter button 800 is being driven in the step S110.

In a step S308, the camera system control section 701 judges whether the digital camera 700 is turned off. When the camera system control section 701 judges that the digital camera 700 is powered off, it ends the flow of the image capturing. Whereas when the camera system control section 701 judges that the digital camera 700 is powered on, goes back to the step S301.

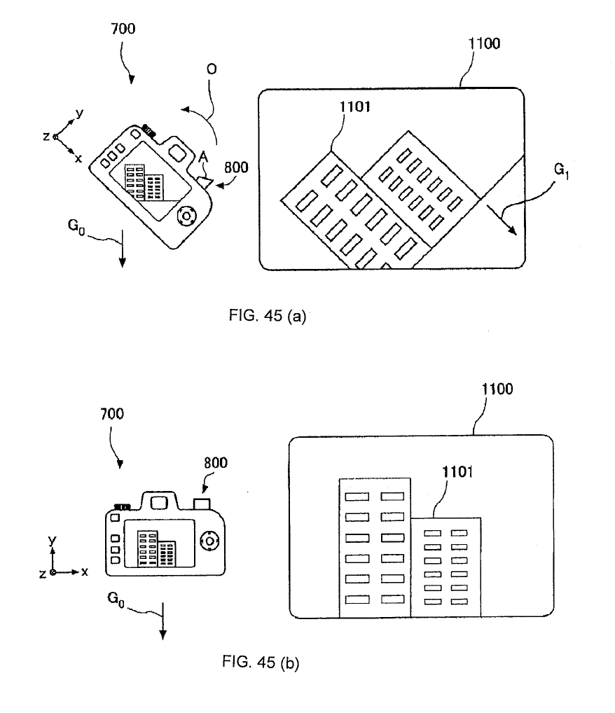

FIGS. 45(a)-45(b) are conceptual diagrams for explaining a second example of the image capturing operation in the no-look image capturing mode according to the fourth embodiment. FIG. 45(a) illustrates an initial state of image capturing of an object, the left drawing of FIG. 45(a) schematically shows a positional relation between the digital camera 700 and the image capturing target space, and the right drawing of FIG. 45(a) shows an image 1100 of the image capturing target space output by the image capturing element 707.

In the no-look image capturing mode according to the second example, the camera system control section 701 notifies through perception the user of a recommended direction to rotate the digital camera 700 such that a gravitational direction G₁ in the object image output by the image capturing element 707 corresponds to a short side direction of the image 1100. More specifically, the camera system control section 701 refers a signal output by the attitude sensor 713, and detects an actual direction of gravitational force that is indicated by the arrow G₀ in FIG. 45.

In the example of FIG. 45(a), the digital camera 700 is tilted as the user holds the camera, and the actual gravitational direction G₀ does not corresponds to the short side direction of the image 1100, in other words, the y axis direction. Thus, in the image 1100 output by the image capturing element 707, a building 1101 which is the object is captured as it is tilted. In such case, in order to capture the composition where the building 1101 stands vertically in the image 1100, the user has to rotate the image capturing element 707 or the digital camera 700 about the z axis in the direction indicated by the arrow O, which is the counterclockwise direction with respect to the +z axis direction.

Therefore, in the no-look image capturing mode according to the second example, the camera system control section 701 detects the actual gravitational direction G₀ using the attitude sensor 713, and determines a recommended direction to rotate the digital camera 700 such that the actual gravitational direction G₀ corresponds to the −y axis direction of the digital camera 700. As described above, in the example of FIG. 45(a), the camera system control section 701 specifies the direction of the arrow O as the recommended direction. The camera system control section 701 then drives the tactile sense poles 805 of the shutter button 800 such that the user perceives change of the state that corresponds to the rotational direction identical to the recommended direction.

More specifically, the camera system control section 701 sends an instruction to the shutter button driving section 714 to drive the tactile sense generating section 803 of the shutter button 800. For example, the tactile sense generating section 803 drives the tactile sense poles 805 to form the tilted virtual plane A which was described above with reference to FIG. 41(b) in order to notify the user through perception that the digital camera 700 should be rotated in the direction of the arrow O. In this case, in order to notify the user of the rotation in the direction indicated by the arrow O, for example, the tactile sense generating section 803 forms the virtual plane A that tilts downward to the −x axis direction side as illustrated in FIG. 45(a). In this way, the user can know the rotational direction to rotate the digital camera 700 through the tilted direction of the tactile sense generating section 803 without looking at the optical finder or the display section 711.

FIG. 45(b) illustrates the state where the gravitational direction G₀ coincides with the −y axis direction. When the camera system control section 701 judges that the gravitational direction G₀ coincides with the −y axis direction, it brings the tactile sense poles 805 back to the normal position and stops driving the tactile sense generating section 803. By this operation, the user perceives that the gravitational direction G₀ coincides with the −y axis direction. According to the second example, the user can perform image capturing when the gravitational direction G₁ in the image 1100 coincides with the short side of the image 1100 without looking at the optical finder or the display section 711.

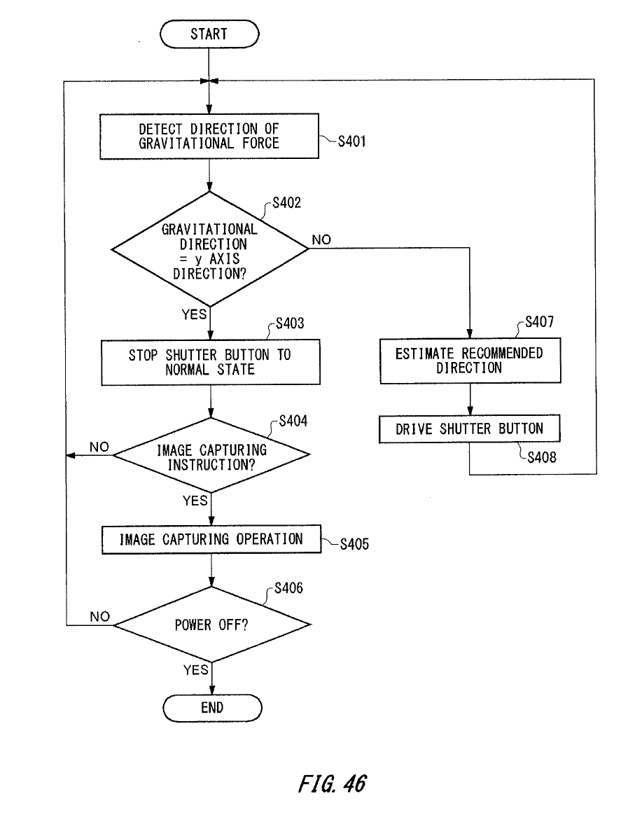

FIG. 46 is a flow chart of the image capturing operation in the no-look image capturing mode in the second example. When the user starts the no-look image capturing mode, the camera system control section 701 starts the operational flow shown in FIG. 46. In a step S401, the camera system control section 701 detects the gravitational direction. In a step S402, the camera system control section 701 judges whether the gravitational direction corresponds to the −y axis direction as described above with reference to FIGS. 45(a)-(b). When the camera system control section 701 judges that the gravitational direction corresponds to the −y axis direction, goes to a step S403. Whereas when the camera system control section 701 judges that the gravitational direction does not correspond to the −y axis direction, goes to a step S407.

When the judgment result is NO in the step S402, the camera system control section 701 estimates the recommended direction to rotate the digital camera 700 in a step S407 as described above with reference to FIGS. 45(a)-(b). In a step S408, the camera system control section 701 drives the tactile sense generating section 803 of the shutter button 800. More specifically, as described above with reference to FIGS. 45(a)-(b), the camera system control section 701 sends an instruction to the shutter button driving section 714 to arrange the tactile sense poles 805 to form the tilted virtual plane A in order to allow the user to perceive change of the state that corresponds to the rotational direction P. The camera system control section 701 then returns to the step S401 in the flow chart.

When the judging result is YES in the step S402, the camera system control section 701 causes the shutter button 800 to stop and be back to the normal state in the step S403. In the case of the embodiment of FIGS. 41(a)-(c), the camera system control section 701 transmits an instruction to the shutter button driving section 714 to cause the tactile sense poles 805 of the tactile sense generating section 803 to be back to the normal arrangement as shown in FIG. 41(a) and to stop driving of the tactile sense poles 805.

In a step S404, the camera system control section 701 judges whether there is an image capturing instruction from a user. When the camera system control section 701 judges that there is the image capturing instruction from the user, goes to a step S405. When the camera system control section 701 judges that there is no image capturing instruction from the user, goes back to the step S401.

In the step S405, the camera system control section 701 conducts the image capturing operation. More specifically, When the user pressed the shutter button 800 down to the first position, the camera system control section 701 performs focus adjustment and photometry as an image capturing preparation action. When the user pressed the shutter button 800 down to the second position, the camera system control section 701 performs an image capturing action of the object and creates an image file as the image data. Like the first example described above, whenever the camera system control section 701 receives the image capturing instruction from the user, it preferentially conducts the image capturing operation.

In a step S406, the camera system control section 701 judges whether the digital camera 700 is turned off. When the camera system control section 701 judges that the digital camera 700 is powered off, it ends the flow of the image capturing. Whereas when the camera system control section 701 judges that the digital camera 700 is powered on, goes back to the step S401.

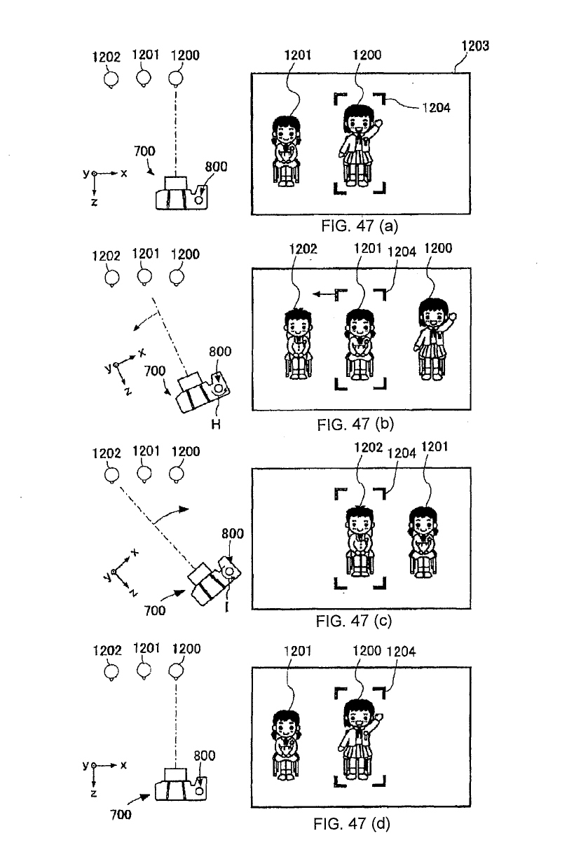

FIGS. 47(a)-47(d) are conceptual diagrams for explaining a third example of the image capturing operation in the no-look image capturing mode according to the embodiment. FIG. 47(a) illustrates an initial state of image capturing of an object, the left drawing of FIG. 47(a) schematically shows a positional relation between the digital camera 700 and the image capturing target space, and the right drawing of FIG. 47(a) shows an image of the image capturing target space output by the image capturing element 707.

In the no-look image capturing mode according to the third example, the user can perform image capturing of the object through a desired camera work without looking at the optical finder or the display section 711. In the third example, the user first selects a program concerning the camera work. Programs concerning the camera work are stored in advance in the camera memory 708. Here, the programs concerning the camera work include, for example, a program that instructs the user a direction to point the camera in order to add dramatic impact to a motion picture captured by the user. For example, in the example of FIG. 47, assume the camera work in which the user first captures an object 1200 that is a main figure, then captures an object 1201 and 1202 sequentially, and captures the object 1200 again.

In such case, the camera work program includes Conditions 1 to 3. For instance, Condition 1 is “the object 1200 is recognized,” Condition 2 is “the object 1202 is recognized,” and Condition 3 is “the object 1200 is recognized.” The camera system control section 701 drives the tactile sense poles 805 of the shutter button 800 depending on whether each condition is satisfied or not.

Referring to FIGS. 47(a)-47(d), the camera system control section 701 first drives the tactile sense poles 805 until Condition 1 is satisfied. In this case, the camera system control section 701 may conduct the image capturing flow described above with reference to FIG. 4 to satisfy Condition 1. More specifically, the user sets in advance a region in which the user wishes to include the object 1200 in the image 1203 as an object region 1204. In the example shown in FIGS. 47(a)-47(d), the object region 1204 is set in the central region of the image 1203 in the same manner as FIG. 4. The camera system control section 701 subsequently specifies a recommended direction to rotate the digital camera 700 depending on the position of the object 1200 in the image capturing target space and the object region 1204 that is set in advance. The camera system control section 701 then drives the tactile sense poles 805 of the shutter button 800 such that the user perceives change of the state that corresponds to the rotational direction identical to the recommended direction.

When the object 1200 falls within the object region 1204, the image 1203 becomes as shown in FIG. 47(a). The camera system control section 701 judges that Condition 1 is satisfied when the object 1200 is in the object region 1204. The camera system control section 701 then drives the tactile sense generating section 803 of the shutter button 800 to notify the user of a camera work which the user should perform to satisfy Condition 2 through perception. In the example of FIG. 47, the tactile sense generating section 803 drives and rotates the tactile sense poles 805 such that the user perceives that the digital camera 700 should be rotated counterclockwise when viewed from the +y axis direction.

FIG. 47(b) illustrates the state where the user is rotating the digital camera 700 in the counterclockwise direction around the y axis in accordance with the movement of the tactile sense generating section 803. The camera system control section 701 keeps rotating the tactile sense poles 805 as indicated by the arrow H of FIG. 47(b).

FIG. 47(c) illustrates the state where the object 1202 falls within the object region 1204. The camera system control section 701 judges that Condition 2 is satisfied when the object 1202 is in the object region 1204 as shown in FIG. 47(c). Operation flow which camera system control section 701 performs in order to recognize that the object 1202 is in the object region 1204 may be same as the above described flow. After Condition 2 is satisfied, the camera system control section 701 drives the tactile sense generating section 803 of the shutter button 800 to notify through haptic sense the user of a camera work which the user should perform until Condition 3 is satisfied.

In the example shown in FIGS. 47(a)-47(d), the tactile sense generating section 803 drives and rotates the tactile sense poles 805 as indicated by the arrow I of FIG. 47(c) to notify the user that the user should rotate the digital camera 700 in the clockwise direction when viewed from the +y axis direction through perception. The user is able to known the camera work which the user should perform next through perception by the movement of the tactile sense generating section 803.

FIG. 47(d) illustrates the state where the object 1200 again falls within the object region 1204. The camera system control section 701 judges that Condition 3 is satisfied when the object 1202 is in the object region 1204 as shown in FIG. 47(d). As described above, in the third example, the camera system control section 701 drives and rotates the tactile sense generating section 803 responsive to the program concerning the camera work to satisfy conditions which would change as image capturing progresses. According to the third example, the user can capture an object through a desired camera work so that it is possible to provide images which can highly satisfy the user. Note, in the case of motion image capturing, the tactile sense generating section 803 can be driven with a different way than that of still image capturing. For example, the amount of driving can be decreased in order to reduce the noise caused by driving of the generating section.

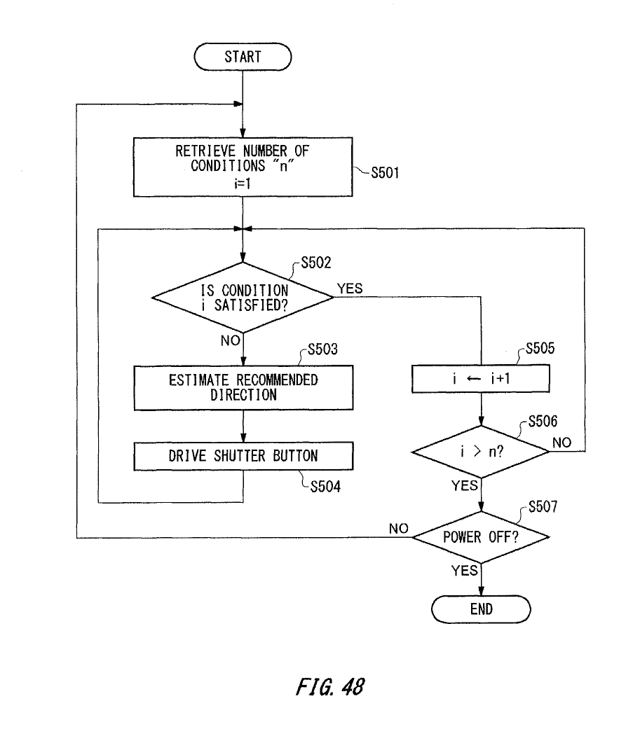

FIG. 48 is a flow chart of the image capturing operation in the no-look image capturing mode according to the third example. When the user selects a program concerning the camera work in advance and starts the no-look image capturing mode, the camera system control section 701 starts the operational flow shown in FIG. 48. In a step S501, the camera system control section 701 reads out the number of conditions “n” and inputs 1 to a variable “i”. The camera system control section 701 also reads out the content of each condition. In the case of the example described with reference to FIGS. 47(a)-47(d), the camera system control section 701 reads out Conditions 1 to 3 of the camera work program from the camera memory 708.

In a step S502, the camera system control section 701 judges whether the condition i is satisfied. In the case of the example described with reference to FIGS. 47(a)-47(d), the camera system control section 701 firstly judges whether Condition 1 “the object 1200 is recognized” is satisfied or not after the operation flow starts. When the camera system control section 701 judges that the condition i is not satisfied, goes to a step S503. When the camera system control section 701 judges that the condition i is satisfied, goes to a step S505.

When the camera system control section 701 judges that the condition is not satisfied (NO) in the step S502, it estimates the recommended direction to rotate the digital camera 700 in the step S503. In the step S504, the camera system control section 701 drives the tactile sense generating section 803 of the shutter button 800. In the case of the example described with reference to FIG. 47, the camera system control section 701 drives the tactile sense poles 805 such that the object 1200 falls within the object region 1204 in order to satisfy Condition 1.

When the camera system control section 701 judges that the condition is satisfied (YES) in the step S502, it increments the variable “i” in a step S505. In a step S506, the camera system control section 701 judges whether the variable i incremented in the step S505 exceeds the number of the conditions “n” or not. More specifically, the camera system control section 701 judges whether all the conditions read out in the step S501 are satisfied or not. When the camera system control section 701 judges that the incremented variable i exceeds the number of the conditions “n,” it goes to a step S507. Whereas when the camera system control section 701 judges that the incremented variable i does not exceed the number of the conditions “n,” it goes back to the step S502, and performs the steps S502 to S504 in order to satisfy the next condition specified in the program. More specifically, following Condition 1, the camera system control section 701 conducts the corresponding operation for Condition 2 and Condition 3 sequentially.

In a step S507, the camera system control section 701 judges whether the digital camera 700 is turned off. When the camera system control section 701 judges that the digital camera 700 is powered off, it ends the flow of the image capturing. Whereas when the camera system control section 701 judges that the digital camera 700 is powered on, goes back to the step S501.

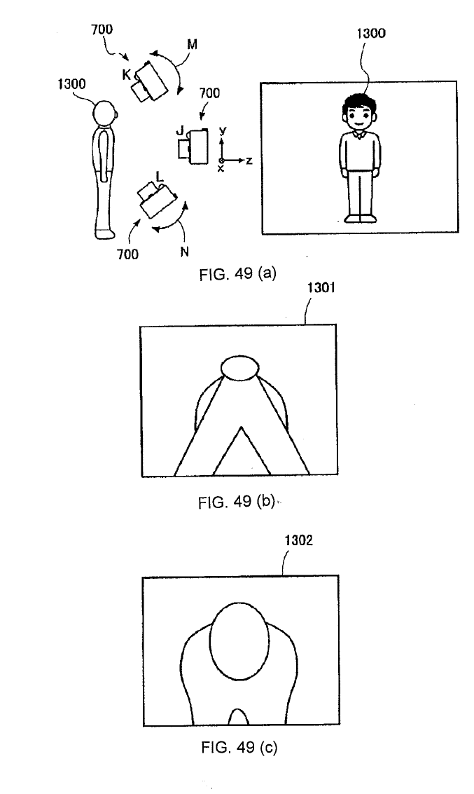

FIGS. 49(a)-49(c) are conceptual diagrams for explaining a fourth example of the image capturing operation in the no-look image capturing mode according to the embodiment. The left drawing of FIG. 49(a) schematically shows a positional relation between the digital camera 700 and an object 1300, and the right drawing of FIG. 49(a) shows an image of an image capturing target space output by the image capturing element 707 when the digital camera 700 is placed at the position J in front of the object 1300.

Not only from the position J of FIG. 49(a) which is the front of the object 1300, the user may wish to capture the object at different angles such that capturing from above the object as indicated by the position K of FIG. 49(a) or from below the object as indicated by the position L of FIG. 49(a). Recently, more needs for so-called “self-image capturing” which is to capture an image of the user himself/herself from the direction above the user are rising. When such image capturing is performed, the user may not be able to see the optical finder or the display section 711 that displays a live-view image. Thus, a composition of an actually captured image can be different from what the user intended.

In the no-look image capturing mode according to the fourth example, the user can capture an image of an object with a desired composition without looking at the optical finder or the display section 711 by using a sample image which is recorded in advance as a reference. In the fourth example, the user specifies in advance a sample image with a composition which the user wishes to capture. The sample images are stored in a recording section 712. An example of the sample images includes a sample image which is referred when the object is captured from below the object, and a sample image which is referred when the object is captured from above the object.

FIG. 49(b) illustrates a sample image 1301 which is referred when the object is captured from blow. When the user wishes to capture the object 1300 diagonally from the position lower than the object 1300, the digital camera 700 is retained blow the object 1300 at the position L as shown in FIG. 49(a). The user then rotates the position of the digital camera 700 about the x axis as indicated by the arrow N of FIG. 49(a) to adjust the position of the object 1300 in the image of the image capturing target space.

When the object is captured from the lower position, the torso and legs of the user are captured larger than the head in the captured image. Thus the digital camera 700 uses an image data that has a composition similar to the composition where the object 1300 is captured from the lower position such as the sample image 1301 of FIG. 49(b) as a reference. The camera memory 708 stores more than one pattern of sample image such as the sample image 1301. The user selects, from the sample images, the one that has a composition closest to the desired composition. As the sample image, an outlined geometric image such as the one shown in FIG. 49(b) can be used. Alternatively, a picture image data can be used as the sample image.

FIG. 49(c) illustrates a sample image 1302 which is referred when the object is captured from above the object. When the user wishes to capture the object 1300 diagonally from the position higher than the object 1300, the digital camera 700 is retained above the object 1300 at the position K as shown in FIG. 49(a). The user then rotates the position of the digital camera 700 about the x axis as indicated by the arrow M of FIG. 49(a) to adjust the position of the object 1300 in the image of the image capturing target space.

When the object is captured from the higher position, the head of the user is captured larger than the torso and legs of the user in the captured image. Thus the digital camera 700 uses an image data that has a composition similar to the composition where the object 1300 is captured from the higher position such as the sample image 1302 of FIG. 49(c) as a reference. The camera memory 708 stores more than one pattern of sample image such as the sample image 1301. The user selects, from the sample images, the one that has a composition closest to the desired composition.

In the no-look image capturing mode according to the fourth example, the camera system control section 701 firstly read outs the sample image which the user selects. The camera system control section 701 recognizes the object 1300 in the image of the image capturing target space output by the image capturing element 707. In this case, the lens system control section 702 may transmit an instruction to the zoom lens driving section 705 to perform auto zooming in order to adjust the size of the object 1300 in the image of the image capturing target space.

After the object 1300 is recognized, the camera system control section 701 compares the object image to the sample image. More specifically, the camera system control section 701 detects feature points of the object image and the sample image and analyzes these feature points to perform the comparison between the object image and the sample image.

The camera system control section 701 determines a recommended direction to rotate the digital camera 700 in accordance with the comparison result between the object image and the sample image. The camera system control section 701 then drives the tactile sense poles 805 of the shutter button 800 such that the user perceives change of the state that corresponds to the rotational direction identical to the recommended direction. For example, the tactile sense generating section 803 arranges the tactile sense poles 805 to form the tilted virtual plane A which was described above with reference to FIG. 41(b) in order to notify the user through perception that the digital camera 700 should be rotated about the x axis in the direction of the arrows M, N of FIG. 49(a).

More specifically, in order to notify the user through perception that the user should rotate the digital camera 700 in the counterclockwise direction when viewed from the −x axis direction, for example, the tactile sense generating section 803 forms the virtual plane A that tilts downward to the −z axis direction side. In this way, the user can know the rotational direction to rotate the digital camera 700 through the tilted direction of the tactile sense generating section 803 without looking at the optical finder or the display section 711.

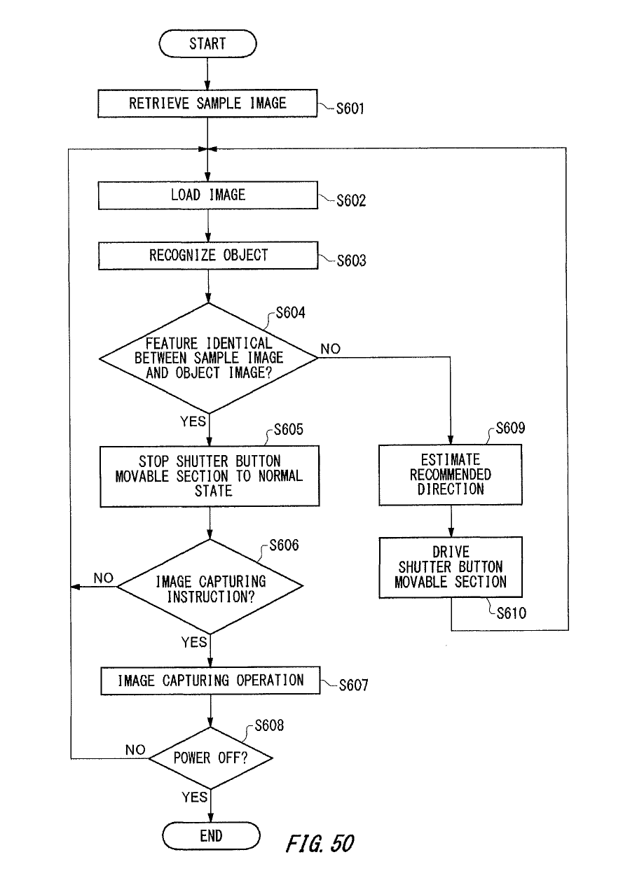

FIG. 50 is a flow chart of the image capturing operation in the no-look image capturing mode in the fourth example. When the user selects a sample image in advance and starts the no-look image capturing mode, the camera system control section 701 starts the operational flow shown in FIG. 50. In a step S601, the camera system control section 701 retrieves the sample image which the user selects from the recording section 712. In a step S602, the camera system control section 701 loads an image of an image capturing target space. In a step S603, the camera system control section 701 recognizes the object in the image of the image capturing target space.

In a step S604, the camera system control section 701 judges whether feature points of the object image correspond to feature points of the sample image. When the camera system control section 701 judges that the feature points of the object image correspond to those of the sample image, goes to a step S605. When the camera system control section 701 judges that the feature points of the object image do not correspond to those of the sample image, goes to a step S609.

When the judgment result is NO in the step S604, the camera system control section 701 estimates the recommended direction to rotate the digital camera 700 in a step S609. In a step S610, the camera system control section 701 drives the tactile sense generating section 803 of the shutter button 800. In the example of FIG. 49, in order to notify the user through perception that the user should rotate the digital camera 700 about the x axis direction, the camera system control section 701 arranges the tactile sense poles 805 to form the virtual plane A that tilts downward to the − or +z axis direction side. The camera system control section 701 then goes back to the step S602 of the operation flow.

When the judging result is YES in the step S604, the camera system control section 701 causes the shutter button 800 to stop and be back to the normal state in the step S605. In a step S606, the camera system control section 701 judges whether there is an image capturing instruction from the user. When the camera system control section 701 judges that there is the image capturing instruction from the user, goes to a step S607. When the camera system control section 701 judges that there is no image capturing instruction from the user, goes back to the step S602.

In a step S607, the camera system control section 701 conducts the image capturing operation. Like the other example, in the fourth example, whenever the camera system control section 701 receives the image capturing instruction from the user, it preferentially conducts the image capturing operation. In a step S608, the camera system control section 701 judges whether the digital camera 700 is turned off. When the camera system control section 701 judges that the digital camera 700 is powered off, it ends the flow of the image capturing. Whereas when the camera system control section 701 judges that the digital camera 700 is powered on, goes back to the step S602.

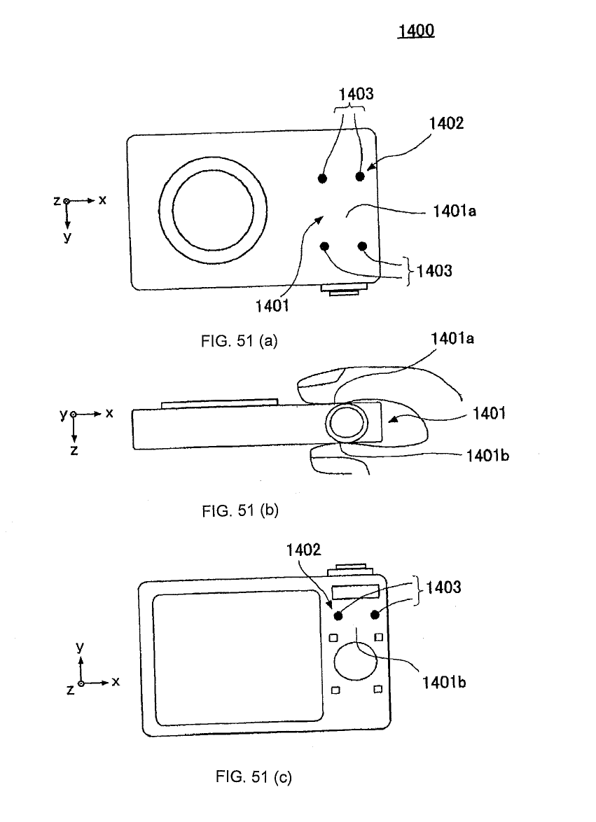

In this embodiment, the tactile sense generating section 803 is provided in the shutter button 800. However, the embodiment is not limited to this, the tactile sense generating section 803 may be disposed at the main body of the digital camera. Another example of the digital camera according to the embodiment will be now described with reference to FIGS. 51(a)-51(c).

FIGS. 51(a)-51(c) are drawings for explaining another example of a digital camera 1400 according to the embodiment. In other examples of the embodiment, a tactile sense generating section 1402 is disposed at a grip section 1401 which is a portion where a user uses to hold the digital camera 1400. The tactile sense generating section 1402 includes a plurality of vibrating sections 1403 which are, for example, piezoelectric elements. The vibrating sections 1403 are disposed at a front face 1401a and a back face 1401b of the grip section 1401. The tactile sense generating section 1402 generates a haptic sense through which the user can know change of the state. More specifically, responsive to the instruction by the shutter button driving section 714, the vibrating sections 1403 are vibrated sequentially around the y axis in order to notify the user of the rotation about the y axis through perception. By vibrating the vibrating sections 1403 sequentially around the y axis, the tactile sense generating section 1402 can allow the user to sense the rotation about the y axis.

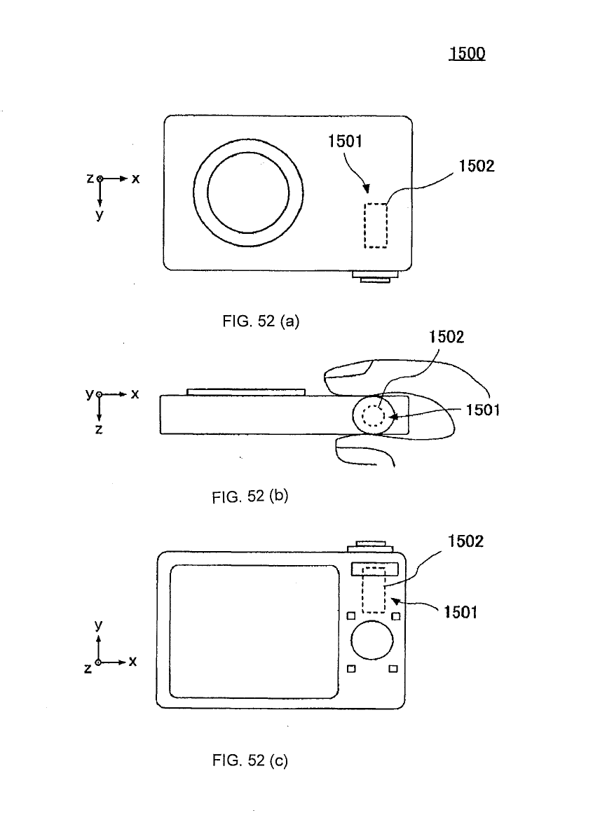

In this embodiment, the digital camera imparts the tactile sense to the user in order to notify the user of the change of the state that corresponds to the rotational direction identical to the recommended direction. However, the embodiment is not limited to this, the digital camera may impart a kinesthetic sense for a user to notify the user of the change of the state that corresponds to the rotational direction identical to the recommended direction. Another example of the digital camera according to the embodiment will be now described with reference to FIGS. 52(a)-52(c).

FIGS. 52(a)-52(c) are drawings for explaining another example of a digital camera 1500 according to the embodiment. The digital camera 1500 according to another example of the embodiment is equipped with a kinesthetic sense generating section 1501. For example, the kinesthetic sense generating section 1501 includes a rotator 1502 that spins about an x axis, y axis or z axis inside the digital camera 1500. An example of the rotator 1502 includes a rotating device which is installed in, for example, a mobile phone to provide a vibration feature. The camera system control section 701 allows the user to feel the kinesthetic sense by rotating the rotator 1502 or stopping the rotation of the rotator 1502. In this manner, the user is able to perceive the rotational direction about the x axis, the y axis or the z axis. The kinesthetic sense generating section 1501 may include an eccentric rotator that eccentrically spins about the x axis, the y axis or the z axis inside the digital camera 1500. By rotating the eccentric rotator, the user is able to feel the kinesthetic sense.

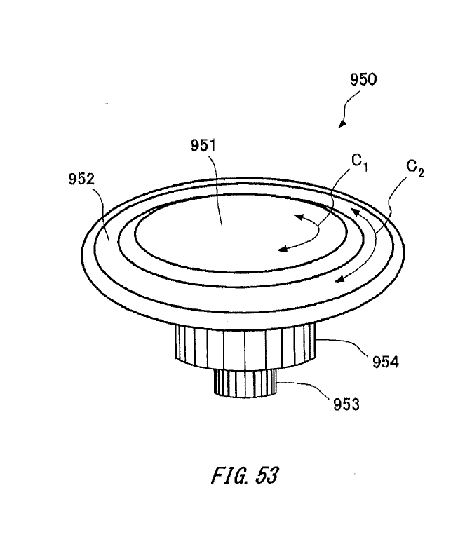

In the examples of the shutter button shown in FIGS. 41(a)-(c) and 42(a)-(b), the shutter button rotates and tilts in order to notify the user of the state change that corresponds to the rotational directions about the two axes at the same time. However, the embodiment is not limited to this, when the shutter button allows the user to perceive at least a state change which corresponds to one rotational direction about one axis, it is effective to support the user who captures an image of the object in the no-look image capturing mode. For example, the configuration of a shutter button 950 illustrated in FIG. 53 can be used to allow the user to perceive at least a state change which corresponds to one rotational direction about one axis.

FIG. 53 is a perspective view of the shutter button 950 which is another example of the shutter button according to the fourth embodiment. The shutter button 950 in this example has two rotating members. More specifically, the shutter button 950 includes a central rotating section 951 which is a circular plate, and an outer rotating section 952 which is a ring plate disposed on the outer side of the central rotating section 951. The central rotating section 951 includes a gear shaft 953 that extends downward. The central rotating section 951 is rotated in the direction indicated by the arrow C₁ of FIG. 53 by a motor through a gear train that interdigitates with the gear shaft 953.

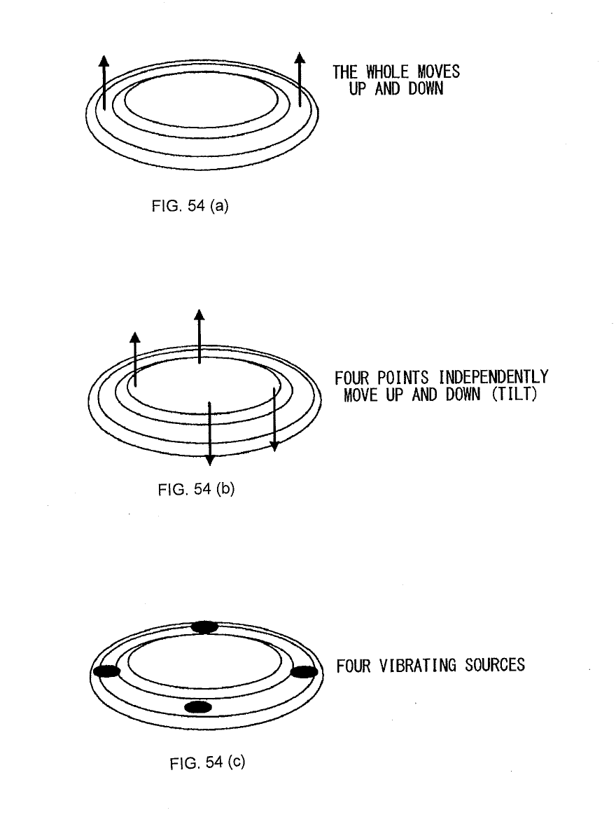

The outer rotating section 952 has a gear shaft 954 that extends downward and has a cylindrical shape. The gear shaft 953 of the central rotating section 951 penetrates the gear shaft 954 of the outer rotating section 952, and the gear shaft 953 can rotate with respect to the gear shaft 954. In the same manner as the central rotating section 951, the outer rotating section 952 is rotated in the direction indicated by the arrow C₂ of FIG. 53 by a motor through a gear train that interdigitates with the gear shaft 954. The central rotating section 951 and the outer rotating section 952 are independently rotated from each other by the two motors. Alternatively, in another example, the shutter button 950 allows the user to perceive a rotation about one axis. In this case, the central rotating section 951 and the outer rotating section 952 may be rotated at different speeds of rotation by using one motor and one reducer. Alternatively, only one of the central rotating section 951 and the outer rotating section 952 may be rotated. When another mechanism is combined to the shutter button 950 of FIG. 53, it makes it possible for the user to perceive the state change that corresponds to rotational directions about two or more axes at the same time as illustrated by FIGS. 54(a)-(c).

As described above, the digital camera has the haptic sense generating section that allows the user to feel the tactile sense or the kinesthetic sense. The haptic sense generating section may include the above-described tactile sense generating section and the kinesthetic sense generating section.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### REFERENCE NUMERALS

10 image capturing apparatus, 12 case, 13 lens section, 16 image capturing section, 18 release switch, 20 display section, 22 mode setting section, 24 touch panel, 26 vibrating section, 30 upper-right vibrating section, 32 lower-right vibrating section, 34 upper-left vibrating section, 36 lower-left vibrating section, 40 controller, 42 system memory, 44 main memory, 46 secondary storage medium, 48 lens driving section, 50 audio output section, 52 mode judging section, 54 display control section, 56 audio control section, 58 object recognition section, 60 tactile notification section, 62 memory processing section, 66 image capturing-element driving section, 68 image capturing element, 70 A/D convertor, 72 image processing section, 110 image capturing apparatus, 112 case, 113 grip section, 114 lens section, 120 display section, 126 vibrating section, 130 upper-right vibrating section, 132 lower-right vibrating section, 134 upper-left vibrating section, 136 lower-left vibrating section, 226 vibrating section, 227 motor, 229 rotation axis, 231 semicircular member, 301 object, 302 object, 303 object, 304 rectangle, 305 object, 306 appropriate positional range, 307 rectangle, 100 camera system, 101 camera system, 102 camera system, 200 lens unit, 300 camera unit, 201 focus ring, 202 optical axis, 210 group of lenses, 211 focus lens, 212 zoom lens, 221 diaphragm, 222 lens system control section, 223 lens barrel, 224 lens mount, 311 camera mount, 312 main mirror, 313 focusing screen, 314 pivot point, 315 image capturing element, 316 pentaprism, 317 eyepiece optical system, 318 finder window, 319 sub-mirror, 322 focus detection sensor, 323 focal plane shutter, 324 optical low-pass filter, 325 main substrate, 326 image processing section, 327 camera system control section, 328 display section, 329 secondary cell, 330 grip section, 331 vibrator, 332 vibrator, 333 vibrator, 334 vibrator, 335 vibrator, 341 camera memory, 342 work memory, 343 display control section, 344 mode switching section, 345 release switch, 400 camera system, 401 camera system, 402 camera system, 403 camera system, 411 object, 412 object, 417 object, 418 rectangle, 419 object, 421 arrow, 422 arrow, 500 lens unit, 503 lens unit, 504 lens unit, 505 lens unit, 600 camera unit, 601 camera unit, 602 camera unit, 501 focus ring, 502 optical axis, 509 lens indicator, 510 group of lenses, 511 focus lens, 512 zoom lens, 521 diaphragm, 522 lens system control section, 523 lens barrel, 524 lens mount, 531 vibrator, 532 vibrator, 533 vibrator, 534 vibrator, 535 vibrator, 550 tripod mount, 611 camera mount, 612 main mirror, 613 focusing screen, 614 pivot point, 615 image capturing element, 616 pentaprism, 617 eyepiece optical system, 618 finder window, 619 sub-mirror, 622 focus detection sensor, 623 focal plane shutter, 624 optical low-pass filter, 625 main substrate, 626 image processing section, 627 camera system control section, 628 display section, 629 secondary cell, 630 secondary cell, 631 vibrator, 632 vibrator, 633 vibrator, 640 body indicator, 641 camera memory, 642 work memory, 643 display control section, 644 mode switching section, 645 release switch, 650 locking pin, 700, 1400, 1500 digital camera, 701 camera system control section, 702 lens system control section, 703 lens mount, 704 camera mount, 705 zoom lens driving section, 706 image processing section, 707 image capturing element, 708 camera memory, 709 work memory, 710 display control section, 711 display section, 712 recording section, 713 attitude sensor, 714 shutter button driving section, 715 mode switching section, 800, 900, 950 shutter button, 801 base portion, 802 cover, 803, 1402 tactile sense generating section, 804 through-hole, 805, 805a, 805b, 805c, 805d, 805e, 805f, 805g, 805h tactile sense pole, 806 tactile sense pole driving section, 901 ring section, 902 central hole, 903 spherical section, 904 tactile sense generating section, 905, 907 driving pole, 906 ring section driving section, 908 spherical section driving section, 951 central rotating section, 952 outer rotating section, 953, 954 gear shaft, 1000, 1204 object region, 1001, 1100, 1203 image, 1002 optical axis, 1101 building, 1200, 1201, 1202, 1300 object, 1301, 1302 sample image, 1401 grip section, 1401a front face, 1401b back face, 1403 vibrating section, 1501 kinesthetic sense generating section, 1502 rotator

What is claimed is:

1. An image capturing apparatus comprising:
an image capturing section that captures an image of an object and generates a captured image;
an object recognition section that recognizes a specific object in the captured image generated by the image capturing section; and
a tactile notification section that notifies a user in a tactile manner concerning whether the specific objet is in a predetermined region of the captured image or not based on recognition by the object recognition section.

2. The image capturing apparatus according to claim 1, wherein
the object recognition section judges whether the specific object is included in the captured image.

3. The image capturing apparatus according to claim 1, wherein
the object recognition section judges which direction the specific object is shifted off the predetermined region.

4. The image capturing apparatus according to claim 3, further comprising:
a plurality of vibrating sections that are arranged at different positions, wherein
the tactile notification section notifies the user of the direction in which the specific object is shifted off the predetermined region by vibrating one of the plurality of vibrating sections, the direction being recognized by the object recognition section.

5. The image capturing apparatus according to claim 1, wherein
the object recognition section judges whether any obstacle exists between the specific object and the image capturing section, and when the object recognition section judges that an obstacle exists, the tactile notification section notifies the user about this judgment.

6. The image capturing apparatus according to claim 1, further comprising:
four vibrating sections that are vibrated by the tactile notification section; and
a case on which the four vibrating sections are disposed at four corners thereof.

7. The image capturing apparatus according to claim 1, further comprising:
four vibrating sections that are vibrated by the tactile notification section; and
a case that has a grip section protruding toward a front direction and in which the four vibrating sections are disposed, wherein
the four vibrating sections are disposed at four corners of the grip section.

8. The image capturing apparatus according to claim 1, further comprising:
a vibrating section that us vibrated by the tactile notification section, wherein
the tactile notification section vibrates the vibrating section in two or more vibration patterns.

9. The image capturing apparatus according to claim 1, further comprising:
a mode judging section that judges a selected image capturing mode among a plurality of image capturing modes including a no-look mode in which the object recognition section operates;
a display section that displays a captured image generated by the image capturing section; and
a display control section that controls the display section, wherein
when the mode judging section judges that the selected image capturing mode is the no-look mode, the display control section does not display the captured image on the display section.

10. The image capturing apparatus according to claim 1, further comprising:
a mode judging section that judges a selected image capturing mode among a plurality of image capturing modes including a no-look mode in which the object recognition section operates;
an audio output section that outputs a release sound; and
an audio control section that controls the audio output section, wherein
when the mode judging section judges that the selected image capturing mode is the no-look mode, the audio control section prevents the audio output section from outputting the release sound.

11. The image capturing apparatus according to claim 1, further comprising:
a vibrating section that includes a piezoelectric element that is vibrated by the tactile notification section.

12. An image capturing apparatus comprising:
a vibrator;
a judging section that judges an object state based on at least a portion of an image of the object; and
a vibration control section that notifies a user of an image capturing timing by changing a vibration waveform generated by the vibrator in accordance with judgment by the judging section.

13. The image capturing apparatus according to claim 12, wherein
the judging section continuously judges the object state and the vibration control section continuously changes the vibration waveform.

14. The image capturing apparatus according to claim 12, wherein
the judging section judges a defocused state of the object, and
the vibration control section changes the vibration waveform generated by the vibrator in accordance with the defocused state of the object judged by the judging section.

15. The image capturing apparatus according to claim 14, wherein
the vibration control section uses a vibration waveform with a smallest amplitude when a lens is at an in-focus position to notify the user of the image capturing timing.

16. The image capturing apparatus according to claim 14, wherein
the vibration control section changes a frequency of the vibration waveform in accordance with the defocused state of the object judged by the judging section.

17. The image capturing apparatus according to claim 14, wherein
when a lens is at an in-focus position, the vibration control section uses a vibration waveform with an amplitude that changes symmetrically over time during one period of the waveform to notify the user of the image capturing timing.

18. The image capturing apparatus according to claim 17, wherein
the vibration control section changes the vibration waveform between a front defocused state and a rear defocused state.

19. The image capturing apparatus according to claim 12, wherein
the judging section judges a size of the object that is a predetermined target, and
the vibration control section changes the vibration waveform in accordance with the size of the object judged by the judging section.

20. The image capturing apparatus according to claim 19, wherein
when the object is within a predetermined range in a captured image and the size of the object is equal to or larger than a predetermined size, the vibration control section uses the vibration waveform with a smallest amplitude to notify the user of the image capturing timing.

21. The image capturing apparatus according to claim 19, wherein
the vibration control section changes a frequency of the vibration waveform in accordance with the size of the object.

22. The image capturing apparatus according to claim 19, wherein
when the object is within a predetermined range in a captured image, the vibration control section uses a vibration waveform with an amplitude that changes symmetrically over time during one period of the waveform to notify the user of the image capturing timing.

23. The image capturing apparatus according to claim 22, wherein
the vibration control section changes the vibration waveform between a state where the object is not within the predetermined range and a state where the size of the object is smaller than a predetermined size.

24. The image capturing apparatus according to claim 12, wherein
the judging section judges a size of the object that is a predetermined target, and
the vibration control section changes the vibration waveform in accordance with a position of the specific object with respect to an angle of view of the object, the position being judged by the judging section.

25. The image capturing apparatus according to claim 24, wherein
the vibration control section uses a vibration waveform with a smallest amplitude when the object exists in a predetermined range in a captured image.

26. The image capturing apparatus according to claim 24, wherein
the vibration control section changes a frequency of the vibration waveform in accordance with a position of the object.

27. The image capturing apparatus according to claim 24, wherein
when the object exists in a predetermined range in a captured image, the vibration control section uses a vibration waveform with an amplitude that changes symmetrically over time during one period of the waveform to notify the user of the image capturing timing.

28. The image capturing apparatus according to claim 27, wherein
when the object does not exist in the predetermined range, the vibration control section changes the vibration waveform depending on which direction the object is shifted off the predetermined range to further notify the user of an image capturing direction.

29. The image capturing apparatus according to claim 12, wherein
the vibrator includes a plurality of the vibrators, and
the vibration control section causes the plurality of vibrators to generate different vibration waveforms.

30. The image capturing apparatus according to claim 29, wherein
the vibration control section causes the plurality of vibrators to generate vibration waveforms with the same amplitude at the image capturing timing to notify the user of the image capturing timing.

31. The image capturing apparatus according to claim 29, wherein
the vibration control section causes each of the plurality of vibrators to generate a vibration waveform with a smallest amplitude at the image capturing timing to notify the user of the image capturing timing.

32. The image capturing apparatus according to claim 29, wherein
the vibration control section causes the plurality of vibrators to generate the vibration waveforms with different start timings.

33. A control program for an image capturing apparatus that includes a vibrator, wherein
the control program causes a computer to:
judge a state of an object based on at least a portion of an image of the object;
control the vibrator by changing a vibration waveform generated by the vibrator in accordance with judgment result to notify a user of an image capturing timing.

34. A lens unit comprising:
a group of lenses; and
a plurality of vibrators arranged along an optical axis of the group of lenses with a predetermined space therebetween.

35. The lens unit according to claim 34, wherein
when the lens unit is attached to a camera unit in a lateral attitude, the plurality of vibrators are disposed in a lower region of the lens unit in a vertical direction.

36. A camera unit comprising:
an image capturing element that receives a light beam from an object and converts the light beam into an electric signal;
a plurality of vibrators arranged at least in an incident direction of the light beam from the object with a predetermined space therebetween;
a judging section that judges a depth state of the object with reference to at least a portion of an image of the object; and
a vibration control section that vibrates the plurality of vibrators in coordination with each other according to the judgment of the judging section.

37. The camera unit according to claim 36, wherein
the judging section judges the depth state of the object, and
the vibration control section continuously vibrates the plurality of vibrators.

38. The camera unit according to claim 36, wherein
the judging section judges a defocused state of the object, and
the vibration control section vibrates the plurality of vibrators in coordination with each other in accordance with the defocused state of the object judged by the judging section.

39. The camera unit according to claim 38, wherein
the vibration control section causes the plurality of vibrators to generate vibration waveforms with the same amplitude when the object is in focus.

40. The camera unit according to claim 38, wherein
the vibration control section causes each of the plurality of vibrators to generate a vibration waveform with a smallest amplitude when the object is in focus.

41. The camera unit according to claim 38, wherein
the vibration control section causes each of the plurality of vibrators to generate a vibration waveform with a different amplitude between a front defocused state and a rear defocused state.

42. The camera unit according to claim 40, wherein
the vibration control section causes the plurality of vibrators to generate vibration waveforms with different start timings.

43. The camera unit according to claim 38, wherein
the vibration control section causes each of the plurality of vibrators to generate a vibration waveform with a different frequency between a front defocused state and a rear defocused state.

44. A camera system that includes at least a lens unit and a camera unit, wherein
the lens unit includes a first vibrator;
the camera unit includes a second vibrator;
at least one of the lens unit and the camera unit includes:
a judging section that judges a depth state of an object with reference to at least a portion of an image of the object; and
a vibration control section that vibrates the first vibrator and the second vibrator in coordination with each other according to the judgment of the judging section.

45. The camera system according to claim 44, wherein
the judging section continuously judges the depth state of the object, and
the vibration control section continuously vibrates the first vibrator and the second vibrator.

46. The camera system according to claim 44, wherein
the judging section judges a defocused state of the object, and
the vibration control section vibrates the first vibrator and the second vibrator in coordination with each other in accordance with the defocused state of the object judged by the judging section.

47. The camera system according to claim 46, wherein
the vibration control section causes the first vibrator and the second vibrator to generate vibration waveforms with the same amplitude when a group of lenses in the lens unit is at an in-focus position.

48. The camera system according to claim 46, wherein
the vibration control section causes the first vibrator and the second vibrator each to generate a vibration waveform with a smallest amplitude when a group of lenses in the lens unit is at an in-focus position.

49. The camera system according to claim 46, wherein
the vibration control section causes the first vibrator and the second vibrator each to generate a vibration waveform with a different amplitude between a front defocused state and a rear defocused state.

50. The camera system according to claim 46, wherein
the vibration control section causes the first vibrator and the second vibrator to generate vibration waveforms with different start timings.

51. The camera system according to claim 46, wherein
the vibration control section causes the first vibrator and the second vibrator each to generate a vibration waveform with a different frequency between a front defocused state and a rear defocused state.

52. A control program used for a camera unit including an image capturing element that receives a light beam from an object and converts the light beam into an electric signal, and a plurality of vibrators arranged at least in an incident direction of the light beam from the object with a predetermined space therebetween, wherein
the control program causes a computer to:
judge a state of an object based on at least a portion of an image of the object; and
control vibration by vibrating the plurality of vibrators in coordination with each other in accordance with the judgment.

53. A control program used for a camera system including at least a lens unit that includes a first vibrator and a camera unit that includes a second vibrator, wherein
the control program causes a computer to:
judge a depth state of an object with reference to at least a portion of an image of the object; and
control vibration by vibrating the first vibrator and the second vibrator in coordination with each other in accordance with the judgment.

54. An image capturing apparatus comprising:
an image capturing section that converts an incident light beam from an image capturing target space;
a detecting section that detects a relative relation between the image capturing target space and a direction of the image capturing section;
a generating section that generates a haptic sense with which a user perceives change of state; and
a driving control section that determines a recommended direction to rotate the image capturing section based on the relative relation detected by the detecting section and a predetermined criterion, and that drives the generating section such that the user perceives the change of state that corresponds to a rotational direction identical to the recommended direction.

55. The image capturing apparatus according to claim 54, wherein
the generating section generates the haptic sense around at least one of an x axis that is parallel to a long side of an image capturing plane that receives the incident light beam, a y axis that is parallel to a short side of the image capturing plane, and a z axis that is perpendicular to the image capturing plane.

56. The image capturing apparatus according to claim 55, wherein
the generating section is disposed at a shutter button.

57. The image capturing apparatus according to claim 56, wherein
the generating section generates the haptic sense around the y axis by generating vibration sequentially along a circumferential direction of a pressing surface of the shutter button.

58. The image capturing apparatus according to claim 56, wherein
the generating section generates the haptic sense around the x axis and the z axis by tilting a pressing surface of the shutter button.

59. The image capturing apparatus according to claim 54, wherein
the detecting section detects a direction of a specific object in the image capturing target space as the relative relation from image data that is obtained by the image capturing section,
the driving control section uses, as the predetermined criterion, a fact that the object exists in a predetermined partial region of an effective region of the image capturing section to drive the generating section.

60. The image capturing apparatus according to claim 54, wherein
the detecting section detects a gravitational force direction of the image capturing section,
the driving control section uses, as the predetermined criterion, a fact that a gravitational force direction in an image of an object obtained by the image capturing section is coincident with a long side of the image of the object or a short side of the image of the object to drive the generating section.

61. The image capturing apparatus according to claim 54, wherein
during capture of a motion image, the driving control section changes the predetermined criterion in accordance with temporal progression of image capturing to drive the generating section.

62. The image capturing apparatus according to claim 54, wherein
the driving control section uses, as the predetermined criterion, a fact that a captured image approximates a composition of a prescribed sample image to drive the generating section.

63. The image capturing apparatus according to claim 54, wherein
the driving control section drives the generating section differently between a state where capture of a motion image is being performed and other states.

64. A control program for an image capturing device, wherein
the control program causes a computer to:
detect a relative relation between an image capturing target space and a direction of an image capturing section;
determine a recommended direction to rotate the image capturing section based on the relative relation and a predetermined criterion; and
drive and control a generating section that generates a haptic sense with which a user perceives change of state such that the user perceives a rotational direction identical to the recommended direction.
